(19) United States
(12) Patent Application Publication
(10) Pub. No.: US 2009/0152516 A1
(43) Pub. Date: Jun. 18, 2009

(54) COLOR FILTER INK, COLOR FILTER INK SET, COLOR FILTER, IMAGE DISPLAY, AND ELECTRONIC APPARATUS

(75) Inventors: Masaya SHIBATANI, Matsumoto (JP); Hiroshi TAKIGUCHI, Matsumoto (JP); Mitsuhiro ISOBE, Kofu (JP); Hiroshi KIGUCHI, Suwa (JP); Hidekazu MORIYAMA, Fujimi (JP); Akihiro SHINTANI, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/330,776

(22) Filed: Dec. 9, 2008

(30) Foreign Application Priority Data
Dec. 14, 2007 (JP) 2007-322930

(51) Int. Cl. G02B 5/23

(52) U.S. Cl. 252/586

(57) ABSTRACT

A color filter ink, which is used to produce a color filter by using an inkjet method, includes: C. I. pigment yellow 150; and a sulfonated pigment derivative represented by following chemical formula 1:

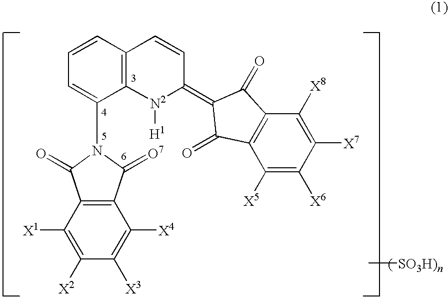

where n represents an integer of 1 to 5, and X¹ to X⁸ each independently represent a hydrogen atom or a halogen atom.

### BACKGROUND

1. Technical Field

The present invention relates to a color filter ink, a color filter ink set, a color filter, an image display, and an electronic apparatus.

2. Related Art

In general, liquid crystal devices such as liquid crystal displays (LCDs) display color images by using a color filter. The color filter usually includes portions colored with three colors corresponding to three primary colors of light, red (R), green (G), and blue (B). A liquid crystal display with the color filter performs color display by adjusting an amount of light transmitted through each of the three colored portions.

Conventionally, color filters are produced by a so-called photolithography process. In the process, on a substrate is formed a coating film made of a material (a colored-portion forming composite) that contains a pigment, a photosensitive resin, a functional monomer, a polymerization initiator, and the like. Then, the coating film is irradiated with light via a photo mask to perform processings such as exposure and development. In this case, usually, the coating film is formed on an almost entire surface of the substrate in a manner corresponding to each color. Then, only a part of the coating film is cured, whereas most of the rest is removed. The processings are repeated in such a manner that colors do not overlap with each other, thereby producing a color filter. Consequently, only the a part of the coating film formed in the production of the color filter remains as each colored portion of the color filter as a final product, and the most part of the film is removed in the production process. Accordingly, a production cost of the color filter is increased, as well as using such a photolithography process is unfavorable in terms of material savings.

Meanwhile, in the recent years, there has been proposed a method for forming colored portions of a color filter by using inkjet heads (liquid droplet discharging heads), as in an example disclosed in JP-A-2002-372613. The method can easily control discharging positions and the like of liquid droplets made of a material used to form the colored portions (the colored-portion forming composite), and thus can reduce a wasteful use of the colored-portion forming composite, thereby reducing load to the environment and suppressing a production cost.

As mentioned above, the color filter generally includes the colored portions having the three colors of R, G, and B corresponding to the primary colors of light. The colored portions are formed with pigments corresponding to the respective three colors. Using the pigments exhibiting color tones corresponding to the three primary colors of light allows a color reproduction range of display images to be relatively widened, whereas a higher image quality of the display images (enlargement of the color reproduction range) is needed. In order to satisfy the need, a yellow pigment is also used in addition to the pigments of the above three colors to enlarge the color reproduction range of the display images. As the yellow pigment, C.I. pigment 150 is widely used from a standpoint of its excellent coloring density, brightness, and contrast. However, the C.I. pigment yellow 150 cannot be stably dispersed in ink. In that case, if liquid droplets (ink) are discharged for long hours or continuously discharged, mist contamination of ink or the like occurs near nozzles and changes a flying route of a discharged droplet (a so-called flight deviation), thereby inhibiting the droplet from landing at a target position, or causes clogging of droplet discharging heads, thereby resulting in problems such as instability of the amounts of droplets discharged. Additionally, due to unstable dispersibility of the C.I. pigment yellow 150, aggregation of ink can easily occur, which can hinder micro-dispersion of the pigment. Thus, a color filter obtained exhibits a low contrast ratio.

Furthermore, liquid droplet discharging apparatuses (for industrial use) used to produce a color filter are completely different from those (for general use) applied to printers. For example, the apparatuses for industrial use are operated in a mass production of color filters or discharging of droplets on a large work sheet (a substrate), and thus are required to discharge a large amount of droplets for long hours. The apparatuses, which are used under such a tough condition, often cause fluctuation of discharging amounts of droplets as compared to those for general use. The fluctuation of discharging amounts of the droplets leads to mixing of a plurality of inks (causes mixing of colors) used to form colored portions of different colors on a substrate or the like where droplets are to be landed, or coloring density varies among the colored portions, although, basically, the colored portions should have an equal coloring density. Those problems result in color unevenness, density unevenness, and the like at portions of a color filter produced, or cause variations of characteristics (particularly, color-related characteristics such as a contrast ratio and a color reproduction range) among multiple color filters produced. Thereby, the produced color filters are less reliable.

### SUMMARY

An advantage of the present invention is to provide a color filter ink discharged by an inkjet method, in which the color filter ink exhibits an excellent long-term stability in pigment dispersion (dispersion stability) and an excellent discharging stability, as well as can be suitably used to produce a high contrast color filter that enables image display in a wide color reproduction range, suppression of unevennesses of color and density at respective portions, and an excellent uniformity in characteristics among individual filters. Another advantage of the invention is to provide a color filter ink set including the color filter ink. Still another advantage of the invention is to provide the color filter that exhibits the above advantageous effects. And yet still another advantage of the invention to provide an image display and an electronic apparatus that include the color filter.

The above advantages are accomplished by aspects and preferred features of the invention described below.

According to a first aspect of the invention, there is provided a color filter ink used to produce a color filter by using an inkjet method. The color filter ink includes: C. I. pigment yellow 150; and a sulfonated pigment derivative represented by following chemical formula 1:

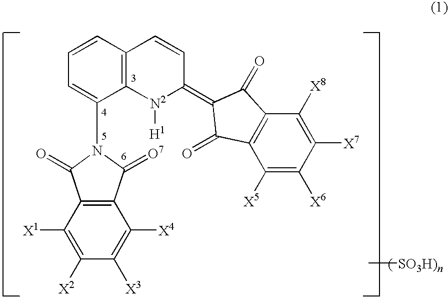

where n represents an integer of 1 to 5, and X¹ to X⁸ each independently represent a hydrogen atom or a halogen atom.

In this manner, there can be obtained a color filter ink that is discharged by an inkjet method and that exhibits an improved long-term stability of pigment dispersion (the dispersion stability) and an improved discharging stability. Additionally, the color filter ink obtained can be suitably used to produce a color filter having a high contrast ratio, achieving display of color images with a wide color reproducibility, having the suppressed unevennesses of color and density at respective portions of the filter, and showing the excellent uniformity of characteristics among individual filters.

Preferably, in the color filter ink according to the first aspect, an inequality expressed by 0.005≦X_{PD}/X_{PY150}≦0.32 is satisfied, where X_{PD} (wt %) represents a content of the pigment derivative in the color filter ink and X_{PY150} (wt %) represents a content of the C. I. pigment yellow 150 in the color filter ink.

In this manner, a long-term dispersion stability of pigment particles in the color filter ink can be especially improved, as well as brightness and contrast of the colored portions formed with the color filter ink can be significantly increased.

Preferably, the color filter ink according to the aspect further includes an acid-value dispersant having a predetermined acid value and an amine-value dispersant having a predetermined amine value.

In this manner, an effect of reducing viscosity of the color filter ink by the acid-value dispersant can be exhibited together with an effect of stabilizing the viscosity of the color filter ink by the amine-value dispersant. This can especially improve the pigment dispersion stability in the color filter ink and the discharging stability of droplets of the color filter ink.

Preferably, in the color filter ink according to the first aspect, an inequality expressed by 0.01≦(AV×X_{A})/(BV×X_{B})≦1.9 is satisfied, where AV (KOH mg/g) represents the acid value of the acid-value dispersant; BV (KOH mg/g) is the amine value of the amine-value dispersant; X_{A} (wt %) represents a content of the acid-value dispersant; and X_{B} (wt %) represents a content of the amine-value dispersant.

In this manner, synergetic effects obtained by a combined use of the acid-value dispersant and the amine-value dispersant are more remarkably exhibited, thereby especially improving the pigment dispersion stability, the droplet discharging stability, and the like.

Preferably, the color filter ink according to the first aspect further includes a curable resin material, the curable resin material including a polymer A that contains at least an epoxy-group-containing vinyl monomer a1 as a monomer component.

Thereby, the pigment dispersion stability in the color filter ink can be especially improved, thereby significantly increasing a long-term preservability and the discharging stability of the color filter ink. Additionally, colored portions formed with the color filter ink can exhibit an excellent solvent resistance.

Preferably, in the above color filter ink, the polymer A is a copolymer that includes, in addition to the epoxy-group-containing vinyl monomer a1, a vinyl monomer a2 as another monomer component, the vinyl monomer a2 having an isocyanate group or an isocyanate group blocked with a protective group.

This can more effectively reduce a content of gas (e.g. a dissolved gas or air bubbles existing as micro-bubbles) in the color filter ink, thereby especially improving the stability of droplet discharging by the inkjet method. As a result, in a color filter produced, the unevennesses of color and density at respective portions and characteristic variations among individual filters can be more effectively prevented.

Preferably, in the above color filter ink, the curable resin material includes a polymer B that includes at least an alkoxyl-group-containing vinyl monomer as a monomer component, the alkoxyl-group-containing vinyl monomer being represented by following chemical formula 2:

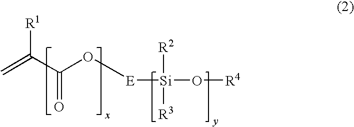

where R¹ represents a hydrogen atom or an alkyl group having a carbon number of 1 to 7; E represents a single bond or a divalent hydrocarbon radical; R² and R³ represent alkyl or alkoxyl groups having a same or different carbon number in a range of 1 to 6; R⁴ represents an alkyl group having a carbon number of 1 to 6; x represents 0 or 1; and y represents an integer of 1 to 10.

In this manner, the color filter ink discharged on a substrate can be suitably wettingly spread thereon, whereby obtained colored portions can have an especially even thickness. Consequently, in a color filter produced, unevennesses of color and density at respective portions can be significantly reduced. In addition, the colored portions of the color filter have a greatly increased adhesion to the substrate.

A color filter ink set according to a second aspect of the invention includes a plurality of different colors of color filter inks, at least one of the color filter inks being the color filter ink according to the first aspect.

In this manner, there can be provided a color filter ink set that includes the color filter ink discharged by an inkjet method and capable of exhibiting an improved long-term stability of pigment dispersion (the dispersion stability) and an improved discharging stability. In addition, the ink included in the color filter ink set can be suitably used to produce a color filter having a high contrast ratio, enabling image display in a wide color reproduction range, having the suppressed unevennesses of color and density at respective portions, and showing an excellent uniformity of characteristics among individual filters.

Preferably, in the color filter ink set according to the second aspect, the different colors of the color filter inks include red, green, and blue inks, in which at least one of the red ink and the green ink is the color filter ink according to the first aspect.

This can further equalize discharging stability and long-term dispersibility among the respective inks included in the color filter ink set, which can more suitably suppress the unevennesses of color and density at respective portions in a color filter produced, thereby improving the uniformity of characteristics among individual color filters.

Preferably, the color filter ink set according to the second aspect further includes a yellow ink that is the color filter ink according to the first aspect.

This can further equalize discharging stability and long-term dispersibility among the respective inks included in the color filter ink set, so that in the color filter obtained, color unevenness and density unevenness at respective portions can be more suitably suppressed, thereby improving the uniformity of properties among individual products.

A color filter according to a third aspect of the invention is a color filter produced with the color filter ink according to the first aspect.

In this manner, the color filter produced can have a high contrast ratio, can provide image display with a wide color reproduction range, can have the suppressed unevennesses of color and density at respective portions, and can achieve an excellent uniformity of characteristics among individual filters.

A color filter according to a fourth aspect of the invention is a color filter produced with the color filter ink set according to the second aspect.

In this manner, the color filter can have a high contrast ratio, can provide image display with a wide color reproduction range, can have the suppressed unevennesses of color and density at respective portions, and can achieve an excellent uniformity of characteristics among individual filters.

An image display according to a fifth aspect of the invention includes the color filter according to the third aspect.

In this manner, there can be produced an image display that can provide high contrast display images with a wide color reproduction range. In addition, in a display section of the image display, the unevennesses of color and density at respective portions are suppressed, as well as the uniformity of characteristics among individual image displays produced can be improved.

Preferably, the image display according to the fifth aspect is a liquid crystal panel.

In this manner, the image display can provide high contrast display images with a wide color reproduction range. Additionally, the unevennesses of color and density at the respective portions in the display section can be suppressed, and the uniformity of characteristics among individual displays can be improved.

An electronic apparatus according to a sixth aspect of the invention includes the image display according to the fifth aspect.

In this manner, the electronic apparatus can provide high contrast display images with a wide color reproduction range, and can have the suppressed unevennesses of color and density at respective portions in a display section thereof, with the improved uniformity of characteristics among individual apparatuses.

### BRIEF DESCRIPTION OF THE DRAWINGS

The invention will be described with reference to the accompanying drawings, wherein like numbers reference like elements.

FIG. 1 is a sectional view of a color filter according to a first embodiment of the invention.

FIG. 2 is sectional views of a method for producing the color filter.

FIG. 3 is a perspective view of a liquid droplet discharging apparatus used to produce the color filter.

FIG. 4 is a plan view of a liquid droplet discharging unit as it appears when viewed from a stage included in the liquid droplet discharging apparatus of FIG. 3.

FIG. 5 is a bottom surface view of a liquid droplet discharging head included in the liquid droplet discharging apparatus of FIG. 3.

FIG. 6A is a sectional perspective view of the liquid droplet discharging head included in the liquid droplet discharging apparatus of FIG. 3.

FIG. 6B is a sectional view of the liquid droplet discharging head.

FIG. 7 is a plan view of a color filter according to a second embodiment of the invention.

FIG. 8 is a sectional view of a liquid crystal display according to an embodiment of the invention.

FIG. 9 is a perspective view showing a structure of a mobile (or a notebook-type) personal computer as an example of an electronic apparatus according to an embodiment of the invention.

FIG. 10 is a perspective view showing a structure of a mobile phone (or a PHS) as another example of the electronic apparatus according to the embodiment.

FIG. 11 is a perspective view showing a structure of a digital still camera as another example of the electronic apparatus according to the embodiment.

### DESCRIPTION OF EXEMPLARY EMBODIMENTS

Hereinafter, embodiments of the invention will be described.

Color Filter Ink

A color filter ink according to an embodiment of the invention is used to produce a color filter (to form colored portions of the color filter), and is particularly used to produce a color filter by using an inkjet method.

The color filter ink includes a pigment, a resin material, and a liquid medium (a solvent) in which the pigment is dispersed.

Pigments

The color filter ink according to the embodiment includes, as pigments, C. I. pigment yellow 150 and a sulfonated pigment derivative as described below.

In general, the color filter has colored portions with three colors of red (R), green (G), and blue (B) as three primary colors of light, where the colored portions are formed with pigments corresponding to the three colors of R, G, and B. Additionally, using a yellow pigment in combination with the pigments corresponding to R, G, and B enables improvement in qualities of display images (an enlargement of a color reproduction range).

The color filter ink of the embodiment includes, as the yellow pigment, C. I. pigment yellow 150 excellent in coloring strength, brightness, and contrast, as well as includes a sulfonated pigment derivative as described below. Then, at least one of the pigments corresponding to R, G, and B may be added to the color filter ink of the embodiment as above, or the color filter ink of the embodiment may be included as an yellow (Y) ink other than inks corresponding to R, G, and B in a color filter ink set as described below, thereby providing high quality display images through the color filter (obtaining a widened color reproduction range).

The C. I. pigment yellow 150 and the sulfonated pigment derivative will be described in detail below.

C. I. Pigment Yellow 150

The C. I. pigment yellow 150 has a sufficiently high color density and thus provides a high coloring strength and a high brightness when used in a color filter. Accordingly, a color filter produced using such a pigment can provide a wide color reproduction range.

A content of the C. I. pigment yellow 150 in the color filter ink of the embodiment is not specifically restricted. A preferable content of the C. I. pigment yellow 150 ranges from 0.3 to 10 wt % and a more preferable content thereof ranges from 0.4 to 8 wt %. Thereby, the C. I. pigment yellow 150 can be more stably dispersed in the color filter ink, so that the color filter ink can obtain an improved discharging stability and an improved long-term dispersion stability of the pigments (dispersion stability). In addition, the colored portions of the color filter produced can have especially high coloring density and transmittance, thereby achieving an especially wide color reproduction range.

As mentioned above, the color density of the C. I. pigment yellow 150 is sufficiently high. However, the pigment yellow 150 cannot be stably dispersed in ink. Due to unstable dispersion of the pigment in ink, discharging liquid droplets (ink) for long hours or continuously causes mist contamination of ink or the like near nozzles. For example, this changes a flying route of a discharged droplet (a so-called flight deviation), thereby inhibiting the droplet from landing at a target position, or causes clogging of a droplet discharging head, resulting in instability of amounts of droplets discharged. Additionally, the unstable dispersion of the C. I. pigment yellow 150 easily causes aggregation in ink, which makes it difficult to allow micro-dispersion of the pigments, thus lowering the contrast ratio of a color filter obtained. Additionally, in the ink, containing the C. I. pigment yellow 150 and other pigments (such as the pigments of R, G, and B), a presence of the C. I. pigment yellow 150 reduces dispersion stability of the other pigments in the ink. Consequently, the contrast and coloring density of a color filter produced tend to vary widely.

Furthermore, liquid droplet discharging apparatuses (for industrial use) used to produce a color filter are completely different from those (for general use) applied to printers, and are used to perform operations such as a mass production or discharging of droplets on a large work sheet (a substrate). Thus, the discharging apparatuses for industrial use are required to discharge a large amount of droplets for long hours, where using the for industrial apparatuses under such tough conditions intrinsically tends to cause fluctuation of discharging amounts of droplets as compared to the apparatuses for general use. The fluctuation of discharging amounts of droplets leads to mixing of a plurality of kinds of inks (mixing of the different colors) used to form the colored portions with the different colors on a substrate or the like where droplets are to be discharged, or leads to coloring density variations among the colored portions where the coloring density of the portions should be basically equal. Those problems result in color unevenness, density unevenness, and the like at respective portions of a color filter produced, or result in variations of characteristics (particularly, color-related characteristics such as a contrast ratio and a color reproduction range) among multiple color filters produced, thereby lowering reliability of the color filters.

As a result of thorough investigation, the inventors of the present invention have found that the above-described problems can be solved by adding a following sulfonated pigment derivative together with the C. I. pigment yellow 150 into the ink and using a liquid medium as described below.

Sulfonated Pigment Derivative

As described above, the color filter ink of the embodiment includes, as pigments, the C. I. pigment yellow 150 and a sulfonated pigment derivative represented by following chemical formula 1:

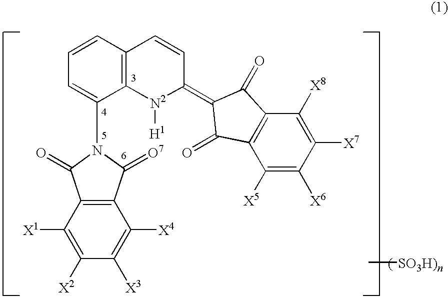

where n represents an integer of 1 to 5; and X¹ to X⁸ each independently represent a hydrogen atom or a halogen atom.

In this manner, including the above sulfonated pigment derivative in addition to the C. I. pigment yellow 150 in the color filter ink allows improvement in dispersibility and dispersion stability of the C. I. pigment yellow 150 (which inherently shows a low dispersibility and a low dispersion stability when used alone) in the ink. Additionally, the combination of the derivative and the C.I. pigment yellow 150 allows improvement in contrast and brightness of a color filter produced by using the color filter ink. Even when the color filter ink includes a pigment other than the C. I. pigment yellow 150, the pigment can be stably dispersed in the color filter ink, so that the color filter produced can exhibit increased contrast and brightness. As examples of such a pigment, there may be mentioned yellow pigments such as C. I. pigments yellow 74, 138, 139, 155, 184, and 185, and pigments corresponding to R, G, and B.

In addition, including the sulfonated pigment derivative as above in the color filter ink allows adjustment of only the colors of the colored portions in the color filter produced, whereby the color filter can provide a wide color reproduction range. Furthermore, in the color filter ink having the improved pigment dispersion stability, aggregation among the pigments hardly occurs, thereby preventing changes in physical properties of the ink over a long period of time. Consequently, discharging stability of ink droplets can be improved, whereby unevennesses of color and density at respective portions in the color filter obtained are suppressed, and the uniformity of characteristics among individual filters can be improved.

The sulfonated pigment derivative can be prepared by sulfonation of a compound represented by following chemical formula 3:

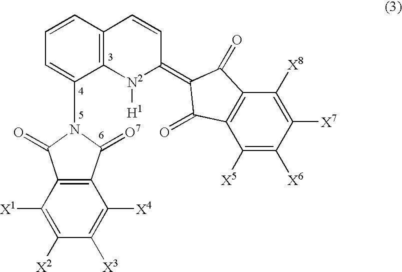

where n represents an integer of 1 to 5, and X¹ to X⁸ each independently represent a hydrogen atom or a halogen atom.

Sulfonation can be performed, for example, by an aromatic substitution reaction using a sulfonating agent such as a fuming sulfuric acid, a concentrated sulfuric acid, a mixture of a fuming sulfuric acid and a concentrated sulfuric acid, a mixture of a sulfuric acid and a phosphorus pentoxide, a chlorosulfuric acid, a sodium hydrogen sulfide, or a mixture of a sulfuric chloride and an aluminum chloride. In the aromatic substitution reaction, a reaction system may be heated if needed.

Additionally, such a sulfonation process may use a catalyst according to need. The catalyst may be a metal sulfate salt such as calcium sulfate, aluminum sulfate, or iron sulfate. Using the catalyst as above can provide advantageous effects such as prevention or suppression of undesired side reactions, mitigation of reaction conditions, and an increase in reaction rate.

An amount of the catalyst to be used is not specifically restricted, but preferably ranges from 0.05 to 10 parts by weight (pts.wt.) per 100 pts.wt of a pigment to be sulfonated.

In the sulfonation process, the reaction rate may be controlled (suppressed) by using a reaction system such as ethylene glycol, propylene glycol, chloroform, ethylene chloride, or carbon tetrachloride, according to need.

After completion of the sulfonation reaction, a reaction mixture is poured into a largely excessive amount of water relative to an amount of a used sulfonating agent to precipitate a sulfonated pigment derivative. The sulfonated pigment derivative is isolated by filtering and washed with a dilute acid such as dilute hydrochloric acid, followed by water-washing and drying to obtain a targeted sulfonated pigment derivative. When using a water-insoluble and volatile solvent such as chloroform, ethylene chloride, or carbon tetrachloride, the solvent is preferably removed before adding the reaction mixture in water.

In the present embodiment, a sulfonic acid obtained in the above manner may be directly used as the sulfonated pigment derivative, or salt of the sulfuric acid may be used as the sulfonated pigment derivative. Examples of compounds or atoms constituting the sulfonic acid and the salt thereof include metal atoms having a valence of 1 to 3, such as lithium, potassium, sodium, calcium, magnesium, strontium, and aluminum; organic amines including monoalkyl amines such as ethylamine and butylamine, dialkyl amines such as dimethylamine and diethylamine, trialkyl amines such as trimethylamine and triethylamine, and alkanol amines such as monoethanol amine, diethanol amine, and triethanolamine; and ammonia.

Particularly, when a salt to be used is an alkali metal salt, the salt is water-soluble, so that an advantageous effect as below can be obtained. Specifically, after dissolving the salt in water, a water-insoluble impurity can be easily isolated by only filtering the mixture, thereby obtaining a sulfonated pigment derivative with a high purity.

Including the sulfonated pigment derivative represented by above chemical formula 1 in the color filter ink enables the long-term dispersion stability of pigment particles in the ink to be especially improved. Additionally, in a method as described below, efficiency of the micro-dispersion process can be especially improved. Accordingly, the color filter ink can be produced in a short time and with a relatively small amount of energy, so that productivity of the color filter ink can also be especially improved, thus contributing to a reduction in production cost. Furthermore, a color filter produced by using the color filter ink can exhibit excellent contrast and brightness.

As described above, the thorough investigation by the present inventors has shown that the above excellent effects can be obtained by using the sulfonated pigment derivative having the specific chemical structure in combination with the C.I. pigment yellow 150. Details of mechanisms of the findings are not clear, but there are considerable mechanisms as follows.

The C.I. pigment yellow 150 is a nickel complex of a compound represented by following chemical formula 4:

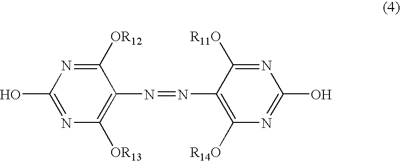

where R₁₁, R₁₂, R₁₃, and R₁₄ each independently represent a hydrogen atom or an alkyl group and may be the same as or different from each other.

As shown in chemical formula 4, the C.I. pigment yellow 150 has four amide bonds in molecules thereof. The amide bonds have hydrogen bonding properties. Additionally, a whole molecular structure of the C.I. pigment yellow 150 forms a conjugated system, where π-electrons can be stably overlapped with each other between a plurality of molecules. Accordingly, when the π-electrons are mutually overlapped and thereby the molecules are overlapped with each other, the amide bonds allow those molecules to strongly fix to each other via hydrogen bonds, thereby facilitating aggregation of the C.I. pigment yellow 150. Thus, inherently, the C.I. pigment yellow 150 cannot be stably dispersed in a liquid medium.

Meanwhile, in the sulfonated pigment derivative as above, a hydrogen atom bonding with a nitrogen atom in chemical formula 1 bonds with an oxygen atom constituting a phthalimide structure to form a hydrogen bond. Thus, the hydrogen atom bonding with the nitrogen atom in chemical formula 1 bonds not only with the nitrogen atom forming a quinoline structure but also substantially strongly bonds with the oxygen atom constituting the phthalimide structure. In the sulfonated pigment derivative shown in chemical formula 1, seven atoms with numbers 1 to 7 form a stable ring structure (a 7-membered ring structure). Forming the 7-membered ring structure allows a plane of the quinoline structure to be non-parallel to a plane of the phthalimide structure, whereby the sulfonated pigment derivative as above has a bulky molecular structure.

Accordingly, a sulfonic group of the sulfonated pigment derivative is coordinated to each of the amide bonds of the C.I. pigment yellow 150. Furthermore, the above bulky structure of the sulfonated pigment derivative can prevent the molecules of the C.I. pigment yellow 150 from approaching each other. Thereby, the C.I. pigment yellow 150, which is inherently likely to aggregate as described above, hardly causes aggregation. Moreover, the sulfonated pigment derivative having the sulfonic groups in the molecules thereof exhibits excellent dispersibility in liquid media as mentioned below. It can be thus considered that those advantages synergistically interact with each other, thereby providing the excellent effects as described above.

In the embodiment, the sulfonated pigment derivative has the chemical structure represented by chemical formula 1′ as above. Particularly, preferably, the sulfonated pigment derivative has a chemical structure represented by following chemical formula 5. In this manner, the above effects can be more remarkably exhibited. The reason for this seems that the sulfonated pigment derivative is highly halogenated and thus has an appropriately bulky structure, thereby especially improving the pigment dispersion stability. Meanwhile, in the bulky molecular structure, the sulfonic groups can be sufficiently coordinated to the amide bonds of the C.I. pigment yellow 150. Additionally, the sulfonated pigment derivative can obtain an appropriate polarity, thus maintaining a high affinity to resin materials and liquid media as mentioned below.

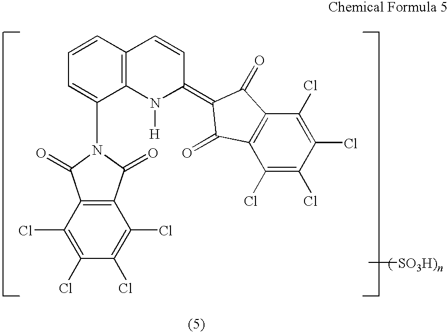

where n represents an integer of 1 to 5.

A content of the sulfonated pigment derivative in the color filter ink is not specifically restricted, but is preferably in a range of 0.07 to 2.7 wt % and more preferably in a range of 0.2 to 2.1 wt %.

In addition, preferably, an inequality expressed by 0.005≦X_{PD}/X_{PY150}≦0.32 is satisfied, and more preferably, an inequality expressed by 0.07≦X_{PD}/X_{PY150}≦0.28 is satisfied, where X_{PD} (wt %) represents the content of the sulfonated pigment derivative in the color filter ink and X_{PY150} (wt %) represents a content of the C.I. pigment yellow 150. This can especially improve the long-term dispersion stability of the pigment particles in the color filter ink and the brightness and contrast of the colored portions formed with the color filter ink. In contrast, if the content of the sulfonated pigment derivative in the ink is too low, the long-term dispersion stability of the pigment particles in the color filter ink cannot be sufficiently improved depending on contents of all pigments in the color filter ink and the kind of a liquid medium. Conversely, if the content of the sulfonated pigment derivative is too high, the content of the C.I. pigment yellow 150 is relatively reduced. Accordingly, a color filter produced cannot provide a sufficiently wide color reproduction range.

The sulfonated pigment derivative may be made of a single compound or a mixture of a plurality of compounds.

Other Pigments

In the embodiment, the color filter ink includes, as the pigments, the C.I. pigment yellow 150 and the sulfonated pigment derivative, but may also include at least one pigment component other than those pigments, (namely, at least another pigment).

The at least another pigment may be selected from various kinds of organic and inorganic pigments. Specifically, there may be mentioned compounds classified as pigments in the Color Index (C.I.: published by the Society of Dyers and Colourists). More specifically, there may be used compounds with color index (C.I.) numbers as follows, such as C.I. pigments red 1, 2, 3, 4, 5, 6, 7, 8, 9, 10, 11, 12, 14, 15, 16, 17, 18, 19, 21, 22, 23, 30, 31, 32, 37, 38, 40, 41, 42, and 48:1, 48:2, 48:3, 48:4, 49:1, 49:2, 50:1, 52:1, 53:1, 57, 57:1, 57:2, 58:4, 60:1, 63:1, 63:2, 64:1, 81, 81:1, 83, 88, 90:1, 97, 101, 102, 104, 105, 106, 108, 108:1, 112, 113, 114, 122, 123, 144, 146, 149, 150, 151, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, 265; C.I. pigments green 7, 36, 15, 17, 18, 19, 26, 50, and 58; C.I. pigments blue 1, 15, 15:1, 15:2, 15:3, 15:4, 15:6, 17:1, 18, 60, 27, 28, 29, 35, 36, and 80; C.I. pigments yellow 1, 3, 12, 13, 14, 15, 16, 17, 20, 24, 31, 34, 35, 35:1, 37, 37:1, 42, 43, 53, 55, 60, 61, 65, 71, 73, 74, 81, 83, 93, 94, 95, 97, 98, 100, 101, 104, 106, 108, 109, 110, 113, 114, 116, 117, 119, 120, 126, 127, 128, 129, 138, 139, 151, 152, 153, 154, 155, 156, 157, 166, 168, 175, 184, and 185; C.I. pigments violet 1, 3, 14, 16, 19, 23, 29, 32, 36, 38, and 50; C.I. pigments orange 1, 5, 13, 14, 16, 17, 20, 20:1, 24, 34, 36, 38, 40, 43, 46, 49, 51, 61, 63, 64, 71, 73, and 104; C.I. pigments brown 7, 11, 23, 25, and 33, and derivatives of the above-mentioned pigments. Among them, a single kind or a combination of two or more kinds of the pigments and the derivatives thereof can be selected for use in the color filter ink.

A total content of the pigments (including the C.I. pigment yellow 150 and the sulfonated pigment derivative) in the color filter ink preferably ranges from 2.0 to 25 wt %, more preferably ranges from 3.5 to 20 wt %, and still more preferably ranges from 4.0 to 9.4 wt %. When the content of the pigments is within the above range, a color filter produced with the color filter ink can ensure a higher color density and thus can be used to display clearer images. Additionally, setting the pigment content within the above range can reduce an amount of the color filter ink required to form each colored portion with a predetermined color density. This is advantageous in terms of material saving. Furthermore, a volatile amount of a solvent in formation of the colored portions of the color filter can be reduced, which can lower a load on the environment. Conventionally, containing pigments with such a relatively high density significantly reduces a discharging stability of droplets. Thus, upon discharging of color filter ink droplets, there tends to occur a problem such as a flight deviation or an instability in the discharging amounts of the droplets. Furthermore, conventionally, in particular, when discharging the droplets on a large-sized substrate (such as a G5 or larger substrate) to form colored portions thereon, there have been variations among the amounts of the droplets discharged on respective portions on a plane. The variations have caused occurrence of defective products, resulting in a significant reduction in productivity of a color filter. On the other hand, in the embodiment of the invention, even in the case of including a pigment with a relatively high density, the above problems can be surely prevented as will be described below. Accordingly, the embodiment can ensure the prevention of the unevennesses of color and density at respective portions of a produced color filter and characteristic variations between individual filters. Thereby, there can be produced a color filter with an excellent productivity. In other words, when the color filter ink includes a pigment having a relatively high density as above, the advantageous effects of the embodiment can be more significantly exhibited. In addition, the embodiment enables the produced color filter to have an especially improved durability.

An average particle diameter of pigment particles in the color filter ink is not specifically restricted, but preferably ranges from 10 to 200 nm and more preferably ranges from 20 to 180 nm. Thereby, the color filter produced using the color filter ink can exhibit a sufficiently high light resistance, whereas pigment dispersion stability in the color filter ink and contrast, brightness, and the like of the color filter can be especially improved.

Liquid Medium

The liquid medium serves as a dispersion medium that disperses the pigments in the color filter ink. Additionally, in a method for producing the color filter ink as described below, the liquid medium is a solvent usually used to dissolve a resin material in a dispersion medium-containing dispersion liquid. Then, a most part of the liquid medium (the dispersion medium) included in the color filter ink is usually removed during color-filter production processes.

The liquid medium may be an ester compound, an ether compound, a hydroxy ketone, a carbonic diester, or a cyclic amide compound, for example. In particular, the liquid medium is preferably any one selected from (1) ethers (polyalcohol ethers) as condensation products of polyalcohols such as ethylene glycol, propylene glycol, butylene glycol, and glycerin, alkyl ethers of polyalcohol or polyalcohol ether, such as methyl ether, ethyl ether, butyl ether, and hexyl ether, and esters such as formate, acetate, and propionate; (2) esters of polycarboxylic acids (e.g. succinic acid and tartaric acid), such as methyl ester; (3) ethers and esters of compounds (hydroxy acids) each having at least one hydroxyl group and at least one carboxyl group in a molecular structure thereof, and (4) carbon diesters having a chemical structure as obtainable by a reaction between polyalcohol and phosgene. Examples of the compounds that can be used as the liquid medium include 2-(2-methoxy-1-methylethoxy)-1-methylethylacetate, triethylene glycol dimethyl ether, ethylene glycol diacetate, diethylene glycol monoethyl ether acetate, 4-methyl-1,3-dioxolane-2-on, bis(2-butoxyethyl)ether, glutaric acid dimethyl, ethylene glycol di-n-butylate, 1,3-butylene glycol diacetate, diethylene glycol monobutyl ether acetate, tetraethylene glycol dimethyl ether, 1,6-diacetoxyhexane, tripropylene glycol monomethyl ether, butoxy propanol, diethylene glycol methyl ethyl ether, diethylene glycol methyl butyl ether, triethylene, glycol methyl ethyl ether, triethylene glycol methyl butyl ether, dipropylene glycol monomethyl ether acetate, diethylene glycol dimethyl ether, ethyl 3-ethoxypropionate, diethylene glycol ethylmethyl ether, 3-methoxybutyl acetate, diethylene glycol diethyl ether, ethyl octanoate, ethylene glycol monobutyl ether acetate, ethylene glycol monobutyl ether, cyclohexyl acetate, diethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, diacetin, dipropylene glycol mono-n-propyl ether, polyethylene glycol monomethyl ether, butyl glycolate, ethylene glycol monohexyl ether, dipropylene glycol mono-n-butyl ether, N-methyl-2-pyrrolidone, triethylene glycol butyl methyl ether, bis(2-propoxyethyl)ether, diethylene glycol diacetate, diethylene glycol butyl ethyl ether, diethylene glycol butyl propyl ether, diethylene glycol ethyl propyl ether, diethylene glycol methyl propyl ether, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl propyl ether, triethylene glycol methyl propyl ether, dipropylene glycol methyl ether acetate, n-Nonyl alcohol, diethylene glycol monobutyl ether, triethylene glycol monomethyl ether, ethylene glycol 2-ethylhexyl ether, triethylene glycol monomethyl ether, diethylene glycol monohexyl ether, triethylene glycol monobutyl ether, diethylene glycol mono-2-ethylhexyl ether, tripropylene glycol mono-n-butyl ether, and butyl cellosolve acetate. Among them, a single kind or a combination of two or more kinds can be selected for use.

Preferably, the liquid medium includes a single kind or two or more kinds selected from a group of 1,3-butyl glycol diacetate, bis(2-butoxyethyl) ether, and diethylene glycol monobutyl ether acetate. Thereby, since the sulfonated pigment derivative exhibits an appropriate affinity to the liquid medium, surfaces of particles of the C.I. pigment yellow 150 can be easily coated with the sulfonated pigment derivative. Thus, the long-term dispersion stability of the pigment particles in the color filter ink can be especially improved. Even when a pigment content in the color filter ink is relatively high, the long-term pigment dispersion stability can be sufficiently improved. Additionally, the droplet discharging stability of the color filter ink can also be especially improved, thereby more effectively suppressing the unevennesses of color and density, and the like at respective portions of a color filter produced, as well as especially improving the uniformity of characteristics among individual color filters produced. Furthermore, when the liquid medium (serving as the dispersion medium in the color filter ink) is made of any of the compounds mentioned above, solubility of the curable resin material can be sufficiently improved due to a chemical structural correlation among the compound, the pigments described above, and a curable resin material described below, and also the curable resin material can be unevenly distributed on the surfaces of pigment particles in the color filter ink. Thereby, the discharging stability of droplets and the dispersion stability of the pigment particles in the color filter ink can be especially improved, thus especially enhancing the long-term preservability of the color filter ink. Furthermore, when the liquid medium serving as the dispersion medium in the color filter ink is composed of any of the compounds above, the color filter ink can be surely wettingly expanded within the whole cell in the method for producing a color filter, as described below. Consequently, without strictly defining conditions for removing the liquid medium, flat colored portions can be easily formed. In other words, it is easy to control an internal configuration of each pixel upon baking.

In addition to at least one of the compounds as mentioned above, preferably, the liquid medium further includes at least one compound among triethylene glycol diacetate, 4-methyl-1, 3-dioxysolane-2-one, diethylene glycol butyl methyl ether, triethylene glycol ethyl methyl ether, and triethylene glycol methyl ether. This can increase viscosity and surface tension of the ink in the cell upon removal of the liquid medium from the color filter ink in the production method of a color filter as described below, thereby especially increasing smoothness of the colored portions formed in the cell. As a result, the unevennesses of color and density at the respective portions in a color filter produced are significantly reduced. Additionally, for example, when an indium tin oxide (ITO) film is provided on the colored portions of the color filter, adhesion to the ITO film can be especially increased.

Particularly, when the liquid medium include at least one of diethylene glycol butyl methyl ether and triethylene glycol ethyl methyl ether among the compounds mentioned as above, the viscosity of the color filter ink can be relatively reduced, thereby especially improving the discharging stability of droplets of the ink. In addition, upon discharging of the droplets, the ink quickly spreads wettingly into every corner of the substrate. Accordingly, a thickness of a color filter obtained can be equalized, so that color reproducibility and depolarizability (a contrast ratio) of the filter can be especially improved.

Alternatively, the liquid medium may include triethylene glycol diacetate selected among the compounds above, which allows the ink to be hardly dried near drying nozzles, thereby enabling suppression of flight deviation during execution of the inkjet method.

Furthermore, alternatively, the liquid medium may include either triethylene glycol diacetate or triethylene glycol methyl ether selected among the compounds above. In this case, the compounds have a solubility parameter (an SP value) close to those of curable resins and dispersants as described below, so that the compounds exhibit an excellent affinity to those materials, thereby increasing the dispersion stability of the ink and ensuring reduction of viscosity change over a long period of time.

Still furthermore, in the liquid medium including at least one of the compounds as described above, a preferable content of the compound in the liquid medium ranges from 5 to 30 wt %. Thereby, dispersibility of the C.I. pigment yellow 150 in the ink can be maintained to be high over a long period of time.

A boiling point of the liquid medium under atmospheric pressure (1 atmospheric pressure) preferably ranges from 160 to 300° C., more preferably from 180 to 290° C., and still more preferably from 200 to 280° C. When the boiling point of the liquid medium under the atmospheric pressure falls in the above range, problems such as clogging of droplet discharging heads that discharge the color filter ink can be more effectively prevented, thereby especially increasing the productivity of a color filter.

A vapor pressure of the liquid medium at 25° C. is preferably equal to or less than 0.7 mmHg, and more preferably equal to or less than 0.1 mmHg. Allowing the vapor pressure of the liquid medium to fall in the above range can more effectively prevent the clogging of the heads discharging the color filter ink or other relevant problems, thereby especially increasing the productivity of a color filter.

A content of the liquid medium in the color filter ink preferably ranges from 50 to 98 wt %, more preferably ranges from 70 to 95 wt %, and still more preferably 80 to 93 wt %. With the content value of the liquid medium set in the above range, dischargeability of the color filter ink from the droplet discharging heads can be especially improved, as well as durability of a color filter produced can be increased. Additionally, the color filter produced can posses a sufficient color density.

Resin Material

In general, color filter inks include a binder resin (a resin material) for purposes such as an improvement in the adhesion of formed colored portions to a substrate. Additionally, the binder resin requires solvent resistance to prevent negative effects of chemical coating and washing in a post-process of an ink applying process using the inkjet method. In the embodiment, preferably, the binder resin is a curable resin material.

Curable Resin Material

The curable resin material is not specifically restricted and, for example, may be selected from various energy-ray curable resins such as thermosetting resins and photo-curable resins. Preferably, the color filter ink includes at least one of curable resins as mentioned below. In general, the viscosity of ink that includes a large amount of a curable resin material is increased, which tends to reduce the discharging stability of droplets. However, using the following curable resins as the above curable resin material enables prevention of the increase in ink viscosity even when the ink includes a relatively large amount of the curable resin material. Accordingly, the droplet discharging stability can be improved, whereby a color filter obtained can have a sufficiently wide color reproduction range and can exhibit an enhanced durability.

Next will be described in detail curable resin materials (curable resin composites) that can be suitably used in the color filter ink of the embodiment.

Polymer A

A polymer A includes at least an epoxy-group-containing vinyl monomer a1 as a monomer component. The polymer A may be composed of substantially a single compound or a mixture of a plurality of compounds. When the polymer A is the mixture of compounds, each of the compounds includes at least the epoxy-group-containing vinyl monomer a1 as a monomer component.

Epoxy-Group-Containing Vinyl Monomer a1

As described above, the polymer A has only to include at least the epoxy-group-containing vinyl monomer a1 as the monomer component. This provides various advantageous effects as follows. First, an epoxy group can be easily and surely introduced into the polymer A. Additionally, dispersion stability of the above-mentioned pigments in the color filter ink can be especially improved, thereby ensuring especially excellent long-term preservability and discharging stability of the color filter ink. Furthermore, the colored portions formed with the color filter ink can exhibit an especially excellent solvent resistance. Still furthermore, when forming the colored portions by using the color filter ink, the curable resin material (the binder resin) can be cured under relatively mild conditions, as well as hardness and the like of the coloring portions can be effectively increased. Moreover, when the polymer A further includes at least one of a vinyl monomer a2, a vinyl monomer a3, and the like as described below, polymer synthesis can be suitably performed to easily and surely obtain the polymer A having desired properties.

For example, the epoxy-group-containing vinyl monomer a1 may have a structure represented by following chemical formula 6. Using the epoxy-group-containing vinyl monomer a1 having the structure of chemical formula 6 provides advantageous effects as follows. The dispersion stability of the above-mentioned pigments in the color filter ink can be especially improved, thereby ensuring especially excellent long-term preservability and discharging stability of the color filter ink. Additionally, the colored portions formed with the color filter ink can exhibit higher solvent-resistance. Furthermore, when forming the colored portions by using the color filter ink, the curable resin material (the binder resin) can be cured under relatively mild conditions, as well as hardness and the like of the colored portions formed can be especially increased. Still furthermore, miscibility between the polymer A and a polymer B as described below can be especially improved, thereby enabling formation of highly transparent colored portions by using the color filter ink.

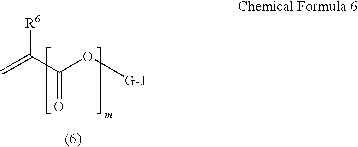

wherein R⁶ represents a hydrogen atom or an alkyl group having a carbon number of 1 to 7; G represents a single bond or a hydrocarbon group that may include a divalent heteroatom; J represents an epoxy group or an alicyclic epoxy group that may have a substituent with a number of ring-constituting carbons of 3 to 10; and m represents 0 or 1.

In chemical formula 6, examples of the alkyl group with the carbon number of 1 to 7 represented by R⁶ include methyl, ethyl, propyl, isopropyl, butyl, isobutyl, s-butyl, pentyl, hexyl, and heptyl groups. Preferably, R⁶ is a hydrogen atom or an alkyl group with the carbon number of 1 or 2, and more preferably, is a hydrogen atom or a methyl group. This can especially improve the dispersion stability of the above pigments in the color filter ink, thereby ensuring especially excellent long-term preservability and discharging stability of the color filter ink. Additionally, a color filter produced can provide high-contrast display images, and also the colored portions formed with the color filter ink can posses increased hardness and the like. Furthermore, the miscibility between the polymer A and the polymer B described below can be especially improved, thereby enabling the colored portions formed with the color filter ink to have an extremely high transparency.

In chemical formula 6, typical examples of the hydrocarbon group that may include a divalent heteroatom, which is represented by G, may be an alkylene group with a straight-chain or branched-chain structure. More specifically, as such alkylene groups, there may be mentioned methylene, ethylene, propylene, tetramethylene, ethylethylene, pentamethylene, hexyamethylene, oxymethylene, oxyethylene, oxypropylene, and the like.

Specific examples of the epoxy-group-containing vinyl monomer a1 include glycidyl(meth)acrylate, methyl glycidyl(meth)acrylate, ethyl glycidyl(meth)acrylate, glycidyl vinyl benzyl ether (trade name: VBGE manufactured by Seimi Chemical Co., Ltd.), and alicyclic epoxy-group-containing unsaturated compounds represented by following chemical formulas 6-1 to 6-31. The epoxy-group-containing vinyl monomer a1 may be one compound or a combination of two or more compounds selected from the above examples. Among them, a particularly preferable compound as the vinyl monomer a1 is (3,4-epoxycyclohexyl)methyl(meth)acrylate. This can especially improve the dispersion stability of the above pigments in the color filter ink, thereby ensuring particularly excellent long-term preservability and discharging stability of the color filter ink, as well as can significantly increase the hardness, the solvent resistance, and the like of the colored portions formed with the color filter ink. Furthermore, the miscibility between the polymer A and the polymer B described below can be especially improved, thereby enabling the colored portions formed with the color filter ink to exhibit an extremely high transparency.

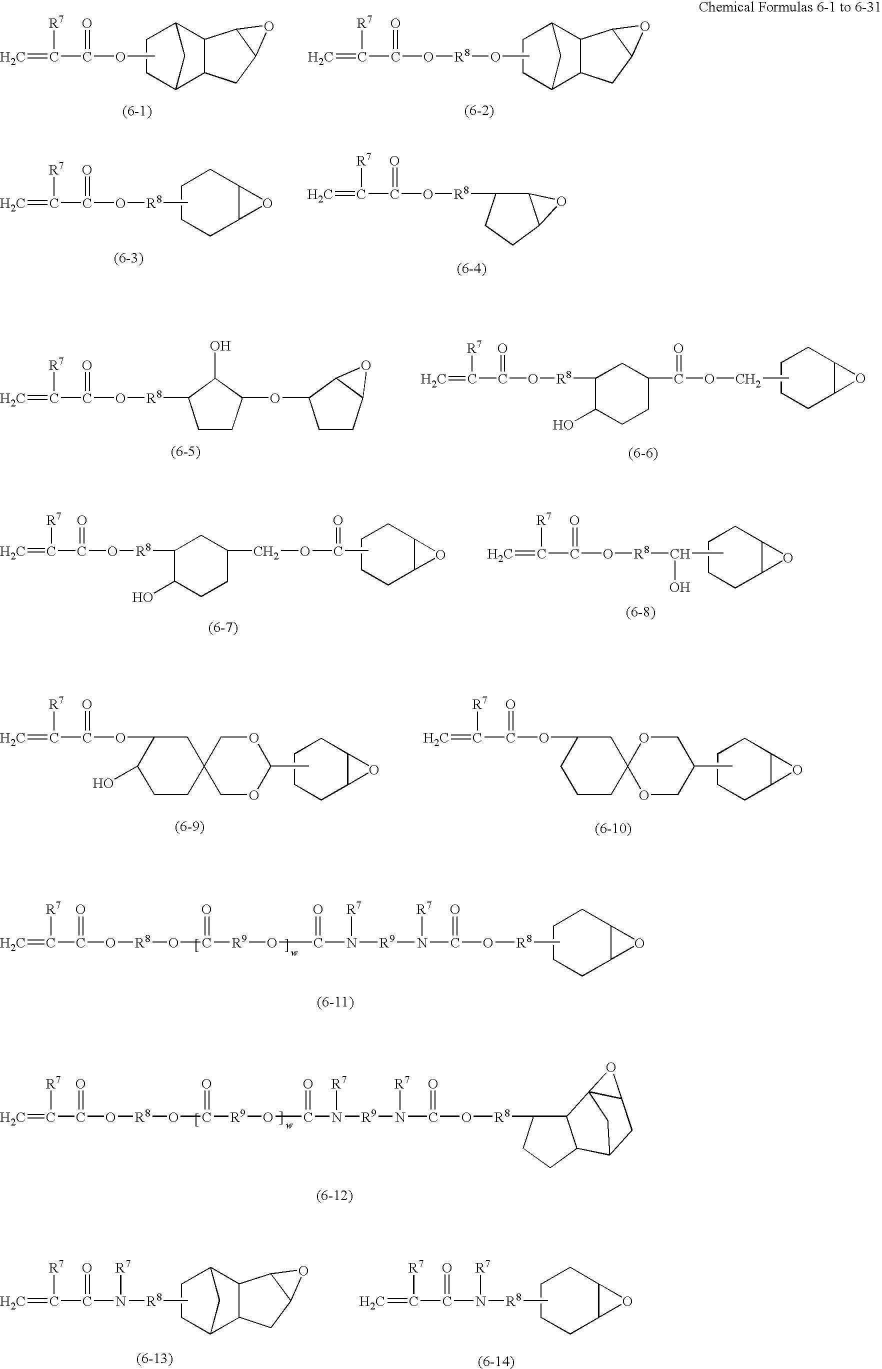

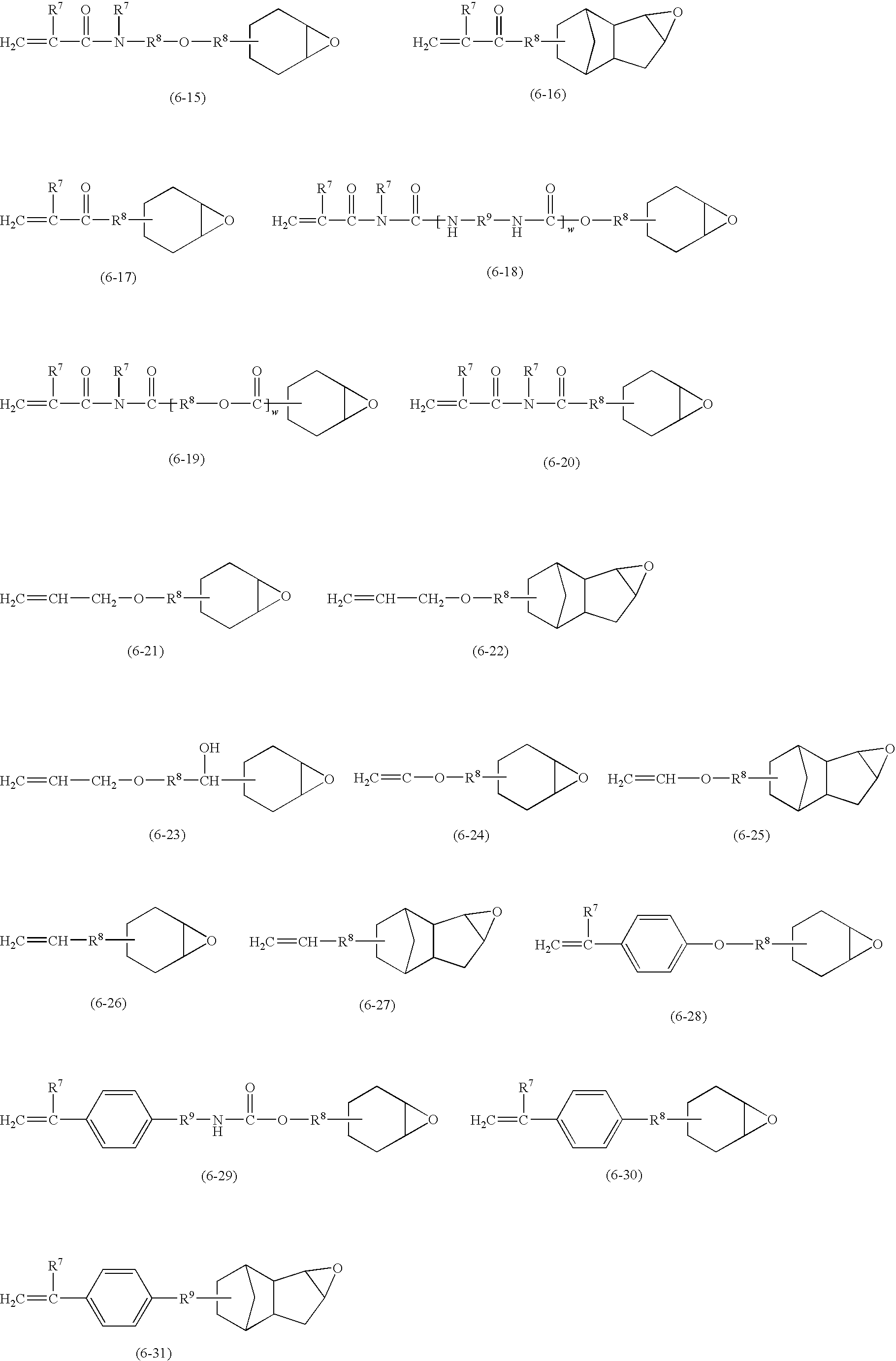

In chemical formulas 6-1 to 6-31, R⁷ represents a hydrogen atom or a methyl group; R⁸ represents a divalent hydrocarbon group having a carbon number of 1 to 8; and R⁹ represents a divalent hydrocarbon group having a carbon number of 1 to 20. Additionally, R⁷, R⁸, and R⁹ may be the same as or different from each other, and w represents an integer of 0 to 10.

A content of the epoxy-group-containing vinyl monomer a1 in the polymer A (a value calculated on a basis of a monomer weight in polymer synthesis) preferably ranges from 50 to 99 wt %, and more preferably ranges from 70 to 94 wt %. When the epoxy-group-containing vinyl monomer a1 in the polymer A has a content in the above range, the dispersion stability of the above pigments in the color filter ink can be especially improved, thereby ensuring especially excellent long-term preservability and discharging stability of the color filter ink. In addition, allowing the content value of the monomer a1 in the polymer A to be set in the above range enables the curable resin material (the binder resin) to be cured under relatively mild conditions upon formation of the colored portions with the color filter ink, as well as enables hardness, solvent resistance, and the like of the formed colored portions to be significantly increased. When the polymer A is the mixture of a plurality of compounds, a weighted average value for the compounds (a weighted average based on a weight ratio) can be used as a content value of the epoxy-group-containing vinyl monomer a1. Then, in the polymer A composed of the mixture of compounds, preferably, the compounds each include the epoxy-group-containing vinyl monomer a1 having the above content.

Vinyl Monomer a2

The polymer A has only to include at least the epoxy-group-containing vinyl monomer a1 as the monomer component. However, preferably, the polymer A is a copolymer that further includes a vinyl monomer a2 as a monomer component, in addition to the monomer a1, where the vinyl monomer a2 has an isocyanate group or a blocked isocyanate group, which is blocked by a protective group. This can more effectively reduce a content of a gas existing in the color filter ink (such as a dissolved gas, bubbles such as micro-bubbles). Thereby, the stability of droplet discharging by the inkjet method can be especially enhanced. As a result, in a color filter produced, the unevennesses of color and density at respective portions and variations of characteristics among individual filters can be more effectively prevented.

For example, the polymeric vinyl monomer a2 may be (meth) acryloylisocyanate in which a (meth)acryloyl group is bonded with an isocyanate group via an alkylene group having a carbon number of 2 to 6, such as 2-acryloyloxyethylisocyanate (trade name: Karenz MOI manufactured by Showa Denko Co., Ltd.) and 2-methacryloyloxyethylisocyanate.

Preferably, the isocyanate group of the (meth)acryloylisocyanate is a blocked isocyanate group. In this case, the blocked isocyanate group means an isocyanate group whose ends are masked with a blocking agent. The monomer having the blocked isocyanate group may be 2-(0-[1′-methylpropylideneamino]carboxyamino)ethyl methacrylate, for example, which is commercially available as a trade name: Karenz MOI-BM (manufactured by Showa Denko Co., Ltd.). Among the above polymeric vinyl monomers, one compound or a combination of two or more compounds can be selected for use.

A content of the vinyl monomer a2 in the polymer A (a value calculated on a basis of a monomer weight in polymer synthesis) ranges preferably from 2 to 20 parts by weight (pts.wt.), and more preferably from 3 to 15 pts.wt., respectively, per 100 pts.wt. of the epoxy-group-containing vinyl monomer a1. When the content of the vinyl monomer a2 in the polymer A is in the above range, the long-term preservability and the like of the color filter ink can be sufficiently improved, as well as the content of a gas (such as a dissolved gas or bubbles existing as micro-bubbles) included in the color filter ink can be more effectively reduced. This can especially improve the stability of droplet discharging by the inkjet method and also enables formation of colored portions having a sufficiently high transparency by using the color filter ink. Meanwhile, when the content of the vinyl monomer a2 in the polymer A is less than a lower limit value of the above range, the advantageous effects obtained by inclusion of the vinyl monomer a2 in the ink cannot be sufficiently exhibited. Conversely, including the vinyl monomer a2 with a content more than an upper limit value of the above range in the polymer A can lead to reduction of the miscibility between the polymer A and the polymer B described below. This makes it difficult to sufficiently increase the transparency of the colored portions formed with the color filter ink. Additionally, in the case of the polymer A composed of the mixture of compounds, a weighted average value for the compounds (a weighted average value based on a weight ratio) can be used as a content value of the vinyl monomer a2. Additionally, in that case, preferably, the compounds included in the polymer A each include the vinyl monomer a2 with the above content.

Vinyl Monomer a3

The polymer A needs only to include at least the epoxy-group-containing vinyl monomer a1 as the monomer component. In addition to the monomer a1, preferably, the polymer A is a copolymer that further includes a vinyl monomer a3 having a hydroxyl group, as another monomer component. This can especially improve adhesion of the colored portions formed with the color filter ink to a substrate, particularly, adhesion of the colored portions to the substrate when a color filter is repeatedly exposed to rapid temperature change due to image display. Consequently, for example, even when the color filter is used for a long period of time, problems such as light leakage (e.g. formation phenomenon of a white spot or a bright spot) can be more surely prevented. That is, durability of the color filter can be significantly improved. Additionally, when the polymer A includes the vinyl monomer a3 as the monomer component, miscibility between the polymer A and the polymer B described below can be especially improved, thereby significantly increasing transparency of the colored portions formed with the color filter ink. In the polymer A including the vinyl monomer a3, a contact angle of ink with a discharging outlet (a nozzle) can be suitably formed, thereby especially enhancing detachment of ink liquid, namely, discharging stability of ink droplets.

Examples of the vinyl monomer a3 include mono-ester compounds of polyalcohols and either acrylic acids or methacrylic acids, such as 2-hydroxyethyl(meth)acrylate, hydroxypropyl(meth)acrylate, 2,3-dihydroxybutyl (meth)acrylate, 4-hydroxybutyl(meth)acrylate, 6-hydroxyhexyl(meth)acrylate, 8-hydroxyoctyl(meth)acrylate, 4-hydroxymethylcyclohexyl(meth)acrylate, and polyalkylene glycol mono-(meth)acrylate; compounds obtained by ring-opening polymerization of ε-caprolacton with the above-mentioned mono-ester compounds of polyalcohols and acrylic or methacrylic acids (e.g Placcel FA series and Placcel FM series manufactured by Daicel Chemical Industries); and compounds obtained by ring-opening polymerization of ethylene oxide or propylene oxide with the above-mentioned mono-ester compounds. Among them, a single compound or a combination of compounds can be selected for use.

A content of the vinyl monomer a3 in the polymer A (a value calculated on a basis of a monomer weight in polymer synthesis) ranges preferably 2 to 20 pts.wt., and more preferably from 3 to 15 pts.wt., respectively, per 100 pts.wt of the epoxy-group-containing vinyl monomer a1. When the content value of the vinyl monomer a3 in the polymer A is in the above range, the long-term preservability and the like of the color filter ink can be sufficiently improved; durability of a color filter produced with the color filter ink can be especially increased; the colored portions formed with the color filter ink can be highly transparent; and discharging stability of ink droplets can be especially improved. In contrast, if the vinyl monomer a3 in the polymer A has a content less than a lower limit value of the above range, the above advantageous effects obtained by inclusion of the vinyl monomer a3 in the ink cannot be sufficiently exhibited. Furthermore, in a case of the polymer A including the vinyl monomer a3 with a content exceeding an upper limit value of the range, a content of gas in the color filter ink cannot be sufficiently reduced. When the polymer A is a mixture of compounds, a weighted average value for the compounds (a weighted average value based on a weight ratio) can be used as a content value of the vinyl monomer a3. Additionally, in the polymer A composed of the mixture of compounds, preferably, the compounds each include the vinyl monomer a3 with the above content.

Another Polymeric Vinyl Monomer a4

The polymer A may further include a polymeric vinyl monomer a4 as a monomer component, other than the epoxy-group-containing vinyl monomer a1, the vinyl monomer a2, and the vinyl monomer a3 described above. As the polymeric vinyl monomer a4, there can be used a vinyl monomer that is copolymerizable with the epoxy-group-containing vinyl monomer a1. Specific examples of the vinyl monomer include alkyl and aralkyl(meth)acrylates having a carbon number of 1 to 12, such as methyl(meth)acrylate, ethyl(meth)acrylate, butyl(meth)acrylate, 2-ethylhexyl(meth)acrylate, phenyl(meth)acrylate, cyclohexyl(meth)acrylate, dicyclopentanyl(meth)acrylate, dicyclopentanyloxyethyl(meth)acrylate, isobonyl(meth)acrylate, benzyl (meth)acrylate, and phenylethyl(meth)acrylate; vinyl aromatic compounds such as styrenes and α-methylstyrenes, and fluoroalkyl-group- or fluoroaryl-group-containing vinyl compounds such as CF₃(CF₂)₃CH₂CH═CH₂, CF₃(CF₂)₃CH═CH₂, CF₃(CF₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)CF(CF₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂OCH₂CH═CH₂, CF₃(CF₂)₇CH₂CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃ (CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃ (CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, and H(CF₂)₄CH₂OCOCH═CH₂. Among them, a single compound or a combination of compounds can be selected for use. Additionally, the polymer A does not include an alkoxy-group-containing vinyl monomer b1 described below as a monomer component.

A content of the vinyl monomer a4 in the polymer A (a value calculated on a basis of a monomer weight in polymer synthesis) is preferably equal to or less than 20 pts.wt., and more preferably equal to or less than 10 pts.wt., respectively, per 100 pts.wt. of the epoxy-group-containing vinyl monomer a1. When the polymer A is composed of a mixture of a plurality of compounds, a weighted average value for the compounds (a weighted average value based on a weight ratio) can be used as a content value of the polymeric vinyl monomer a4. Additionally, in the polymer A composed of the mixture of the compounds, preferably, the content of the polymeric vinyl monomer a4 in each of the compounds satisfies the above condition.

As described above, the polymer A needs only to include at least the epoxy-group-containing vinyl monomer a1 as the monomer component. However, preferably, the polymer A further includes the vinyl monomers a2 and a3 in addition to the epoxy-group-containing vinyl monomer a1. Thereby, the polymer A can exhibit the advantageous effects provided by both the vinyl monomers a2 and a3.

The ratio (the content) of the polymer A in the curable resin material (the binder resin) is, although not specifically restricted, preferably in a range of 25 to 80 wt % and more preferably in a range of 33 to 70 wt %. In the polymer A composed of the mixture of compounds, a sum of contents of the compounds is used as the content of the polymer A in the material.

Polymer B

In the color filter ink, preferably, the curable resin material (the binder resin) includes, as a monomer component, a polymer B that includes an alkoxyl-group-containing vinyl monomer b1 represented by following chemical formula 2:

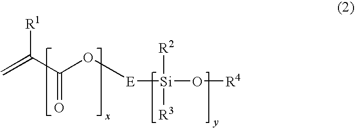

wherein R¹ represents a hydrogen atom or an alkyl group having a carbon number of 1 to 7; E represents a single bond or a divalent hydrocarbon group; R² and R³ represent alkyl or alkoxyl groups having a same or different carbon number of 1 to 6; R⁴ represents an alkyl group having a carbon number of 1 to 6; x represents 0 or 1; and y represents an integer of 1 to 10.

The polymer B may be composed of substantially a single compound or a mixture of a plurality of compounds. When the polymer B is the mixture of compounds, each of the compounds includes at least the alkoxyl-group-containing vinyl monomer b1 as the monomer component.

The polymer B as above includes an alkoxyl group and thus has a high affinity to a substrate (particularly, to a glass substrate) supporting the colored portions of a color filter. Accordingly, the ink, which includes the polymer B as the curable resin material, can be discharged on the substrate so as to suitably spread wettingly, thereby enabling thicknesses of the resultantly formed colored portions to be excellently equalized. This can significantly reduce unevennesses of color and density at respective portions of a color filter obtained. Furthermore, due to the high affinity of the polymer B to the substrate, the colored portions of the color filter obtained can exhibit an excellently high adhesion to the substrate. Additionally, including the polymer B can reinforce curing of the polymer A, so that the colored portions can be formed under relatively mild conditions, as well as hardness, light resistance, heat resistance, and the like of the colored portions formed can all be significantly improved.

Alkoxyl-Group-Containing Vinyl Monomer b1

The polymer B includes at least the alkoxyl-group-containing vinyl monomer b1 represented by chemical formula 2, as the monomer component. Thereby, the alkoxyl group can be easily and surely introduced in the polymer B, and also curing of the polymer A can be reinforced when curing the curable resin material (the curable resin composite) to form the colored portions. Additionally, the colored portions can be formed under relatively mild conditions, as well as hardness, light resistance, heat resistance, and the like of the colored portions formed can all be significantly improved. When the polymer B includes a vinyl monomer b2 or the like described below, polymer synthesis can be suitably performed. This allows the polymer B having desired properties to be easily and surely obtained.

In chemical formula 2, examples of the alkyl group having the carbon number of 1 to 7 represented by R¹ include methyl, ethyl, propyl, isopropyl, butyl, isobutyl, s-butyl, pentyl, hexyl, and heptyl groups. Preferably, R¹ represents a hydrogen atom or an alkyl group with a carbon number of 1 or 2, and more preferably, a hydrogen atom or a methyl group. This can especially improve pigment dispersion stability in the color filter ink and discharging stability of the color filter ink, and also can significantly increase hardness of the colored portions to be formed and adhesion of the colored portions to the substrate. Additionally, light resistance, heat resistance, and the like of the colored portions can be sufficiently increased. Furthermore, miscibility between the polymer A and the polymer B can be especially improved, thereby greatly increasing the transparency of the colored portions formed with the color filter ink.

In chemical formula 2, typical examples of the divalent hydrocarbon group represented by E include alkylene groups with a straight-chain or branched-chain structure. More specifically, there may be mentioned methylene, ethylene, propylene, tetramethylene, ethylethylene, pentamethylene, hexamethylene, and the like. Among them, particularly, preferable compounds are direct-chain alkylene groups having a carbon number of 1 to 3, such as methylene, ethylene, and propylene groups.

In chemical formula 2, examples of the alkyl groups having the carbon number of 1 to 6, which are represented by R², R³, and R⁴, include alkyl groups with a straight-chain or branched-chain structure. More specifically, there may be mentioned methyl, ethyl, propyl, isopropyl, butyl, isobutyl, s-butyl, t-butyl, pentyl, and hexyl groups, for example. The alkoxyl groups with the carbon number of 1 to 6, which are represented by R² and R³, may be alkoxyl groups with a straight-chain or branched-chain structure, such as methoxy, ethoxy, propoxy, isopropoxy, butoxy, isobutoxy, s-butoxy, t-butoxy, pentoxy, and hexyloxy groups.

Specific examples of the monomer represented by chemical formula 2 include alkoxyl-group containing polymeric unsaturated compounds such as vinyltrimethoxysilane, vinyltriethoxysilane, vinylmethyldimethoxysilane, vinylmethyldiethoxysilane, γ-(meth)acryloyl oxypropyl trimethoxysilane, γ-(meth)acryloyl oxypropyl methyl dimethoxysilane, γ-(meth)acryloyl oxypropyl methyl diethoxysilane, γ-(meth)acryloyl oxypropyl triethoxysilane, β-(meth)acryloyl oxyethyl trimethoxysilane, and γ-(meth)acryloyl oxybutylphenyl dimethoxysilane. Among them, a single compound or a combination of compounds can be selected for use.

A content of the alkoxyl-group-containing vinyl monomer b1 in the polymer B (a value calculated on a basis of a monomer weight in polymer synthesis) ranges preferably 70 to 100 wt %, and more preferably 80 to 100 wt %. Setting the content of the alkoxyl-group-containing vinyl monomer b1 in the polymer B in the above range can especially improve the pigment dispersion stability in the color filter ink and the discharging stability of the color filter ink. Additionally, curing of the polymer A can be effectively reinforced when the curable resin material (the curable resin composite) is cured to form the colored portions, thus enabling the colored portions to be formed under milder conditions. Furthermore, shape uniformity, hardness, adhesion to a substrate, light resistance, heat resistance, and the like in the colored portions formed can be greatly improved. When the polymer B is a mixture of a plurality of compounds, a weighted average value for the compounds (a weighted average value based on a weight ratio) can be used as a content value of the alkoxyl-group-containing vinyl monomer b1. In the polymer B as the mixture of compounds, preferably, the compounds each include the alkoxyl-group-containing vinyl monomer b1 with the above content.

Another Polymeric Vinyl Monomer b2

The polymer B may include at least the alkoxyl-group-containing vinyl monomer b1 as the monomer component. In addition to the alkoxyl-group-containing vinyl monomer b1, the polymer B may further include a polymeric vinyl monomer b2 as another monomer component. As such a polymeric vinyl monomer b2, a vinyl monomer can be used that is copolymerizable with the alkoxyl-group-containing vinyl monomer b1. More specifically, for example, there may be mentioned polymeric vinyl monomers such as monoester compounds of polyalcohols and acryl or methacryl acids, such as 2-hydroxyethyl (meth)acrylate, hydroxypropyl(meth)acrylate, 2,3-dihydroxybutyl (meth)acrylate, 4-hydroxybutyl(meth)acrylate, 6-hydroxyhexyl(meth)acrylate, 8-dydroxyoctyl(meth)acrylate, 4-hydroxymethyl cyclohexyl(meth)acrylate, and polyalkylene glycol mono-(meth)acrylate, compounds obtained by ring-opening polymerization of ε-caprolacton with the above-mentioned mono-ester compounds (e.g Placcel FA series and Placcel FM series manufactured by Daicel Chemical Industries, Co., Ltd.), and compounds obtained by ring-opening polymerization of ethylene oxide or propylene oxide with the above-mentioned mono-ester compounds; alkyl and aralkyl(meth)acrylates having a carbon number of 1 to 12, such as methyl(meth)acrylate, ethyl(meth)acrylate, butyl(meth)acrylate, 2-ethylhexyl(meth)acrylate, phenyl(meth)acrylate, cyclohexyl(meth)acrylate, dicyclopentanyl(meth)acrylate, dicyclopentanyloxyethyl(meth)acrylate, isobonyl (meth)acrylate, benzyl(meth)acrylate, and phenylethyl(meth)acrylate; vinyl aromatic compounds such as styrenes and α-methylstyrenes; and fluoroalkyl-group- or fluoroaryl-group-containing vinyl monomers such as CF₃(CF₂)₃CH₂CH═CH₂, CF₃(CF₂)₃CH═CH₂, CF₃(CH₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)4CH2CH═CH2, (CF3)2CF(CF2)4CH═CH2, (CF3)2CF(CF2)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CH₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂2CH₂OCOC(CH₃)═CH₂, CF₃(CF₂)₇CH₂CH₂OCOCH═CH₂, CF₂(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, and H(CF₂)₄CH₂OCOCH═CH₂. Among them, a single compound or a combination of compounds can be selected for use. In that case, the polymer B does not include the above epoxy-group-containing vinyl monomer a1 as the monomer component. Additionally, preferably, the polymer B does not include any of the above fluoroalkyl-group- or fluoroaryl-group-containing vinyl monomers, as the monomer component.

A content of the polymeric vinyl monomer b2 in the polymer B (a value calculated on a basis of a monomer weight in polymer synthesis) is preferably equal to or less than 30 wt % and more preferably equal to or less than 20 wt %. When the polymer B is a mixture of a plurality of compounds, a weighted average value for the compounds (a weighted average value based on a weight ratio) can be used as a content value of the polymeric vinyl monomer b2. Additionally, in the polymer B as the mixture of compounds, the content of the polymeric vinyl monomer b2 in each of the compounds preferably satisfies the above condition.

As described above, the polymer B has only to include at least the alkoxyl-group-containing vinyl monomer b1 as the monomer component, and may further include a monomer component other than the alkoxyl-group-containing vinyl monomer b1. However, preferably, the polymer B is a single polymer composed of the alkoxyl group-containing vinyl monomer b1. That is, preferably, the polymer B includes only the alkoxyl-group-containing vinyl monomer b1 as the monomer component. This can especially improve the pigment dispersion stability in the color filter ink, the discharging stability of the color filter ink, and the durability of a color filter produced by using the color filter ink.

A ratio (a cotent) of the polymer B in the curable resin material (the binder resin) is not specifically restricted, but preferably ranges from 20 to 60 wt %, and more preferably ranges from 25 to 55 wt %. When the polymer B is a mixture of a plurality of compounds, a sum of contents of the compounds is used as the content of the polymer B in the curable resin material.

In a case of the curable resin material including the polymers A and B, a content ratio between the polymer A and the polymer B ranges preferably from 25:75 to 75:25 by weight ratio, and more preferably from 45:55 to 55:45 by weight ratio. Satisfying the above condition can especially improve the pigment dispersion stability in the color filter ink and the discharging stability of the color filter ink, as well as can more surely prevent the unevennesses of color and density at respective portions of the color filter produced by using the color filter ink, thereby significantly improving uniformity of characteristics between individual filters. Additionally, the color filter produced can provide especially high durability.

Polymer C

The curable resin material (the curable resin composite) may further include, as a monomer component, a polymer C that includes a fluoroalkyl-group- or fluoroaryl-group-containing vinyl monomer c1 represented by following chemical formula 7:

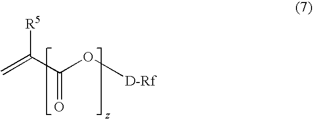

wherein R⁵ represents a hydrogen atom or an alkyl group having a carbon number of 1 to 7; D represents a single bond or a hydrocarbon group that may include a divalent heteroatom; Rf represents a fluoroalkyl or fluoroaryl group having a carbon number of 1 to 20; and z represents an integer of 0 or 1.

Including the above polymer C in the curable resin material can especially improve the discharging stability of the color filter ink. Particularly, the inclusion of the polymer C can facilitate detachment of ink liquid from nozzles of a droplet discharging head, and also can effectively prevent problems such as sticking of a solid component in the ink to the nozzles. Furthermore, the colored portions produced by using the color filter ink can exhibit greatly improved heat resistance.

The polymer C may be substantially a single compound or a mixture of plurality of compounds. When the polymer C is composed of the mixture of compounds, each of the compounds includes at least the fluoroalkyl-group- or fluoroaryl-group-containing vinyl monomer c1 as the monomer component.

Fluoroalkyl-Group- or Fluoroaryl-Group-Containing Vinyl Monomer c1

The polymer C includes at least the fluoroalkyl-group- or fluoroaryl-group-containing vinyl monomer c1 represented by chemical formula 7, as a monomer component. Including the fluoroalkyl-group- or fluoroaryl-group-containing vinyl monomer c1 as the monomer component enables a fluoroalkyl group or a fluoroaryl group to be easily and surely introduced in the polymer C, as well as enables the discharging stability of the color filter ink to be especially improved. Additionally, the colored portions formed with the color filter ink can exhibit greatly increased heat resistance. In a case of the polymer C including a vinyl monomer c2 as below or the like, polymer synthesis can be suitably performed, so that the polymer C exhibiting desired characteristics can be easily and surely obtained.

In chemical formula 7, examples of the alkyl group having the carbon number of 1 to 7 represented by R⁵ include methyl, ethyl, propyl, isopropyl, butyl, isobutyl, s-butyl, pentyl, hexyl, and heptyl groups. Preferably, R⁵ represents a hydrogen atom or an alkyl group with a carbon number of 1 or 2, and more preferably represents a hydrogen atom or a methyl group. This can especially improve the discharging stability of the color filter ink and the heat resistance of the colored portions formed with the color filter ink.

Additionally, in chemical formula 7, typical examples of the divalent hydrocarbon group (that may include a heteroatom) represented by D include alkylene groups with a straight-chain or branched-chain structure. More specifically, for example, there may be mentioned methylene, ethylene, propylene, tetramethylene, ethylethylene, pentamethylene, hexamethylene, oxymethylene, oxyethylene, and oxypropylene.

Specific examples of the monomer represented by chemical formula 7 include CF₃(CF₂)₃CH₂CH═CH₂, CF₃(CF₂)₃CH═CH₂, CF₃(CF₂)₅CH₂CH═CH₂, CF₃(CF₂)₅CH═CH₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)₂CF(CF₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅CH₂CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₃)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, and H(CF₂)₄CH₂OCOCH═CH₂. Among them, a single compound or a combination of compounds can be selected for use.

A content of the fluoroalkyl-group- or fluoroaryl-group-containing vinyl monomer c1 in the polymer C (a value calculated on a basis of a monomer weight in polymer synthesis) ranges preferably from 15 to 100 wt %, and more preferably from 18 to 100 wt %. Setting the content of the fluoroalkyl-group- or fluoroaryl-group-containing vinyl monomer c1 in the polymer C in the above range can especially improve the pigment dispersion stability in the color filter ink, the discharging stability of the color filter ink, and the heat resistance of the colored portions formed with the color filter ink. In addition, miscibility of the polymer C with the polymers A and B can be greatly improved, which can excellently increasing the transparency of the colored portions formed with the color filter ink. On the other hand, when the content of the fluoroalkyl-group- or fluoroaryl-group-containing vinyl monomer c1 in the polymer C is less than a lower limit value of the above range, the advantageous effects obtained by inclusion of the above vinyl monomer c1 cannot be sufficiently exhibited. In a case of the polymer C composed of a mixture of a plurality of compounds, a weighted average value for the compounds (a weighted average value based on a weight ratio) can be used as a content value of the fluoroalkyl-group- or fluoroaryl-group-containing vinyl monomer c1. Furthermore, in the polymer C as the mixture of compounds, preferably, each of the compounds includes the fluoroalkyl-group- or fluoroaryl-group-containing vinyl monomer c1 with the above content.

Another Polymeric Vinyl Monomer c2

The polymer C may further include a polymeric vinyl monomer c2 as a monomer component, other than the above-described fluoroalkyl-group- or fluoroaryl-group-containing vinyl monomer c1. In this case, as the polymeric vinyl monomer c2, there can be used a vinyl monomer that is copolymerizable with the fluoroalkyl-group- or fluoroaryl-group-containing vinyl monomer c1. Specifically, for example, there may be mentioned (1) polymeric vinyl monomers having an isocyanate or a blocked isocyanate group in which an isocyanate is blocked with a protective group, examples of the monomers including (meth)acryloylisocyanate in which a (meth)acryloyl group is bonded with an isocyanate group via an alkylene group having a carbon number of 2 to 6, such as 2-acryloyloxyethylisocyanate (trade name: Karenz MOI manufactured by Showa Denko Co., Ltd.) and 2-metacryloyloxyethylisocyanate, as well as 2-(0-[1′-methylpropylideneamino]carboxyamino)ethyl methacrylate (trade name: Karenz MOI-BM manufactured by Showa Denko Co., Ltd.); (2) polymeric vinyl monomers having a hydroxy group, examples of the monomers including monoester compounds of polyalcohols and acryl or methacryl acids, such as 2-hydroxyethyl(meth)acrylate, hydroxypropyl(meth)acrylate, 2,3-dihydroxybutyl (meth)acrylate, 4-hydroxybutyl(meth)acrylate, 6-hydroxyhexyl(meth)acrylate, 8-hydroxyoctyl(meth)acrylate, 4-hydroxymethyl cyclohexyl(meth)acrylate, and polyalkylene glycol mono-(meth)acrylate, compounds obtained by ring-opening polymerization of ε-caprolacton with the above-mentioned mono-ester compounds of polyalcohols and acryl or methacryl acids (e.g Placcel FA series and Placcel FM series manufactured by Daicel Chemical Industries, Ltd.), and compounds obtained by ring-opening polymerization of ethylene oxide or propylene oxide with the above-mentioned mono-ester compounds; (3) alkyl and aralkyl (meth)acrylates having a carbon number of 1 to 12, such as methyl (meth)acrylate, ethyl(meth)acrylate, butyl(meth)acrylate, 2-ethylhexyl (meth)acrylate, phenyl(meth)acrylate, cyclohexyl(meth)acrylate, dicyclopentanyl(meth)acrylate, dicyclopentanyloxyethyl(meth)acrylate, isobonyl(meth)acrylate, benzyl(meth)acrylate, and phenylethyl(meth)acrylate; and (4) vinyl aromatic compounds such as styrenes and α-methylstyrenes. Among them, a single compound or a combination of compounds can be selected for use. Additionally, the polymer C includes neither the epoxy-group-containing vinyl monomer a1 nor the alkoxyl-group-containing vinyl monomer b1 described above, as the monomer component.

A content of the polymeric vinyl monomer c2 in the polymer C (a value calculated on a basis of a monomer weight in polymer synthesis) is preferably equal to or less than 85 wt %, and more preferably equal to or less than 82 wt %. When the polymer C is a mixture of a plurality of compounds, a weighted average value for the compounds (a weighted average value based on a weight ratio) can be used as a content value of the polymeric vinyl monomer c2. Regarding each of the compounds included in the polymer C, preferably, the content of the polymeric vinyl monomer c2 satisfies the above condition.

When the curable resin material (the binder resin) includes the polymer C, a ratio (a content) of the polymer C in the curable resin material (the binder resin) is not specifically restricted. A preferable ratio of the polymer C in the material ranges from 1 to 20 wt % and a more preferable ratio thereof ranges from 2 to 15 wt %. In the polymer C composed of the mixture of compounds, the content of the polymer C in the curable resin material is equivalent to a sum of contents of the compounds.

Additionally, in the curable resin material (the binder resin) including the polymers A and C, a content ratio between the polymers A and C ranges preferably from 50:50 to 99:1 by weight ratio, and more preferably from 60:40 to 98:2 by weight ratio. Satisfying the above condition can especially improve pigment dispersion stability in the color filter ink and discharging stability of the ink, as well as can more effectively prevent the unevennesses of color and density at respective portions in the color filter produced by using the color filter ink, thereby significantly improving the uniformity of characteristics between individual filters. Additionally, the color filter produced can provide especially excellent durability.

A weight-average molecular weight of each of the above polymers A, B, and C ranges preferably from 1000 to 50000, more preferably from 1200 to 100000, and still more preferably from 1500 to 5000. Additionally, a dispersion ratio (weight-average molecular weight Mw/number-average molecular weight Mn) of each of the polymers A, B, and C is approximately 1 to 3.

A content of the curable resin material in the color filter ink ranges preferably from 0.5 to 10 wt % and more preferably from 1 to 5 wt %. When the content of the curable resin material is in the above range, dischargeability of the color filter ink from the droplet discharging head can be especially improved, as well as a color filter produced can provide greatly enhanced durability. Additionally, the color filter produced can exhibit sufficient color density.

A content of the curable resin material per 100 pts. wt. of a predetermined pigment ranges preferably from 15 to 50 pts. wt., and more preferably from 19 to 42 pts.wt. Satisfying the above condition can especially improve pigment dispersion stability in the color filter ink and discharging stability of the ink, thereby significantly improving color development and contrast of the colored portions in the color filter formed with the color filter ink. Additionally, adhesion of the colored portions to the substrate can be especially increased.

The curable resin material (the binder resin) included in the color filter ink may include a polymer other than the above polymers A, B, and C.

Additionally, the color filter ink may include a component other than the components described above. As a component other than the pigment, the liquid medium, and the curable resin material included in the color filter ink, there may be mentioned a dispersant, for example.

Dispersant

The dispersant is a component serving to improve dispersibility of pigment particles in the color filter ink. Including the dispersant in the color filter ink can especially improve dispersibility and dispersion stability of the pigment. Additionally, when the dispersant is included in the ink, the dispersant adheres (adsorbs) to surfaces of the pigment particles (pigment particles that have a relatively large particle diameter and are not micro-dispersed) added into a dispersant dispersion liquid in a micro-dispersion process of a method for producing a color filter described below. This can improve the dispersibility of the pigment particles in the dispersant dispersion liquid. Thereby, a micro-dispersion processing in the micro-dispersion process can be efficiently performed, thus especially increasing productivity of the color filter ink. In addition, a long-term dispersion stability of the pigment particles (micro-dispersed pigment particles) in the color filter ink as a final product can be significantly improved, as well as color lightness and contrast of a color filter produced by using the color filter ink can be especially increased.

The dispersant is not specifically restricted and, for example, may be a high-polymer dispersant such as a basic high-polymer dispersant, a neutral high-polymer dispersant, or an acidic high-polymer dispersant. Examples of the high-polymer dispersant include a dispersant made of an acryl or denatured acryl copolymer, a urethane dispersant, and a dispersant made of polyaminoamide salt, polyether ester, phosphate ester, aliphatic polycarboxylic acid, or the like.

More specific examples of the dispersant include Disperbyk 101, Disperbyk 102, Disperbyk 103, Disperbyk P104, Disperbyk P104S, Disperbyk 220S, Disperbyk 106, Disperbyk 108, Disperbyk 109, Disperbyk 110, Disperbyk 111, Disperbyk 112, Disperbyk 116, Disperbyk 140, Disperbyk 142, Disperbyk 160, Disperbyk 161, Disperbyk 162, Disperbyk 163, Disperbyk 164, Disperbyk 166, Disperbyk 167, Disperbyk 168, Disperbyk 170, Disperbyk 171, Disperbyk 174, Disperbyk 180, Disperbyk 182, Disperbyk 183, Disperbyk 184, Disperbyk 185, Disperbyk 2000, Disperbyk 2001, Disperbyk 2050, Disperbyk 2070, Disperbyk 2095, Disperbyk 2150, Disperbyk LPN6919, Disperbyk 9075, Disperbyk 9077, and Anti-Terra-205 (manufactured by BYK-Chemie. Co., Ltd.); EFKA 4008, EFKA 4009, EFKA 4010, EFKA 4015, EFKA 4020, EFKA 4046, EFKA 4047, EFKA 4050, EFKA 4055, EFKA 4060, EFKA 4080, EFKA 4400, EFKA 4401, EFKA 4402, EFKA 4403, EFKA 4406, EFKA 4408, EFKA 4300, EFKA 4330, EFKA 4340, EFKA 4015, EFKA 4800, EFKA 5010, EFKA 5065, EFKA 5066, EFKA 5070, EFKA 7500, and EFKA 7554 (manufactured by Chiba Speciality Chemicals Co., Ltd.); Solspers 3000, Solspers 9000, Solspers 13000, Solspers 16000, Solspers 17000, Solspers 18000, Solspers 20000, Solspers 21000, Solspers 24000, Solspers 26000, Solspers 27000, Solspers 28000, Solspers 32000, Solspers 32500, Solspers 32550, Solspers 33500, Solspers 35100, Solspers 35200, Solspers 36000, Solspers 36600, Solspers 38500, Solspers 41000, Solspers 41090, and Solspers 20000 (manufactured by Lubrizol Co., Ltd.); Ajisper PA111, Ajisper PB711, Ajisper PB821, Ajisper PB822, and Ajisper PB824 (manufactured by Ajinomoto Fine Techno Co., Ltd.); Disperon 1850, Disperon 1860, Disperon 2150, Disperon 7004, Disperon DA-100, Disperon DA-234, Disperon DA-325, Disperon DA-375, Disperon DA-705, Disperon DA-725, and Disperon PW-36 (manufactured by Kusumoto Chemicals Co. Ltd.); and Floren DOPA-14, Floren DOPA-15B, Floren DOPA-17, Floren DOPA-22, Floren DOPA-44, Floren TG-710, and Floren D-90 (manufactured by Kyoeisha Chemical Co., Ltd.). Among them, a single compound or a combination of compounds can be selected for use.

Particularly, the color filter ink preferably includes both a dispersant having a predetermined acid value (hereinafter referred to as “acid-value dispersant”) and a dispersant having a predetermined amine value (hereinafter referred to as “amine-value dispersant”), as dispersants. Thereby, the color filter ink can obtain both of effects provided by the acid-value dispersant exhibiting a viscosity-reduction effect that reduces a viscosity of the color filter ink and effects provided by the amine-value dispersant stabilizing the viscosity of the color filter ink. This can especially improve pigment dispersion stability in the color filter ink and discharging stability of droplets of the color filter ink. In particular, the method described below includes a preliminary dispersion process in which a mixture of a dispersant, a thermoplastic resin, and a liquid medium is stirred to disperse the dispersant in the liquid medium to obtain a dispersant dispersion liquid, before pigment micro-dispersion processing. In the method, using both the acid-value dispersant and the amine-value dispersant can surely prevent an association of the dispersants (namely, an association of the acid-value dispersant and the amine-value dispersant), thereby especially improving the above pigment dispersion stability. Meanwhile, when a method without the preliminary dispersion process uses both of the above dispersants, the above-described excellent effects cannot be obtained. The reason for this seems as follows. That is, when the preliminary dispersion process is omitted although both the dispersants are used, the dispersants associate with each other and then contact with pigment particles, thereby causing aggregation between the pigment particles.

Specific examples of the acid-value dispersant include Disperbyk P104, Disperbyk P104S, Disperbyk 220S, Disperbyk 110, Disperbyk 111, Disperbyk 170, Disperbyk 171, Disperbyk 174, and Disperbyk 2095 (manufactured by BYK-Chemie. Co. Ltd.); EFKA 5010, EFKA 5065, EFKA 5066, EFKA 5070, EFKA 7500, and EFKA 7554 (manufactured by Chiba Speciality Chemicals Co., Ltd.); Solspers 3000, Solspers 16000, Solspers 17000, Solspers 18000, Solspers 36000, Solspers 36600, and Solspers 41000 (manufactured by Lubrizol Co., Ltd).

Additionally, specific examples of the amine-value dispersant include Disperbyk 102, Disperbyk 160, Disperbyk 161, Disperbyk 162, Disperbyk 163, Disperbyk 164, Disperbyk 166, Disperbyk 167, Disperbyk 168, Disperbyk 2150m Disperbyk LPN6919, Disperbyk 9075, Disperbyk 9077, and Anti-Terra-205 (manufactured by BYK-Chemie. Co. Ltd.); EFKA 4015, EFKA 4020, EFKA 4046, EFKA 4047, EFKA 4050, EFKA 4055, EFKA 4060, EFKA 4080, EFKA 4300, EFKA 4330, EFKA 4340, EFKA 4400, EFKA 4401, EFKA 4402, EFKA 4403, and EFKA 4800 (manufactured by Chiba Speciality Chemicals Co., Ltd.); and Ajisper PB711 (manufactured by Ajinomoto Fine Techno Co., Ltd).

When using both the acid-value dispersant and the amine-value dispersant, an acid value of the acid-value dispersant (an acid value calculated on a basis of a solid component) is not specifically restricted, but ranges preferably from 5 to 370 KOH mg/g, and more preferably from 20 to 270 KOH mg/g, and still more preferably from 30 to 135 KOH mg/g. Setting the acid value of the acid-value dispersant in the above range can especially improve pigment dispersion stability in use in combination with the amine-value dispersion. For example, acid values of dispersants can be obtained by a method in accordance with DIN EN ISO 2114.

Additionally, preferably, the acid-value dispersant is a dispersant that has no predetermined amine value, namely a dispersant with an amine value of zero.

When using both the acid-value dispersant and the amine-value dispersant, an amine value of the amine-value dispersant (an amine value calculated on a basis of a solid component) is not specifically restricted, but ranges preferably from 5 to 200 KOH mg/g, and more preferably from 25 to 170 KOH mg/g, and still more preferably from 30 to 130 KOH mg/g. Setting the amine value of the amine-value dispersant in the above range can especially improve pigment dispersion stability in use in combination with the acid-value dispersion. For example, amine values of dispersants can be obtained by a method in accordance with DIN 16945.

Additionally, preferably, the amine-value dispersant is a dispersant that has no predetermined acid value, namely a dispersant with an acid value of zero.

Additionally, when using both the acid-value dispersant and the amine-value dispersant, preferably, an inequality expressed by 0.1≦X_{A}/X_{B}≦1 is satisfied, and more preferably, an inequality expressed by 0.15≦X_{A}/X_{B}≦0.5 is satisfied, where X_{A} (wt %) represents a content of the acid-value dispersant in the color filter ink and X_{B} (wt %) represents a content of the amine-value dispersant in the color filter ink. Satisfying one of the above relations allows synergetic effects obtained by using both of the dispersants to be more remarkably exhibited, thereby especially improving pigment dispersion stability, droplet discharging stability, and the like.

Additionally, preferably, an inequality expressed by 0.01≦(AV×X_{A})/(BV×X_{B})≦1.9 is satisfied, and more preferably, an inequality expressed by 0.10≦(AV×X_{A})/(BV×X_{B})≦1.5 is satisfied, where AV (KOH mg/g) represents an acid value of the acid-value dispersant; BV (KOH mg/g) represents an amine value of the amine-value dispersant; X_{A} (wt %) represents a content of the acid-value dispersant; and X_{B} (wt %) represents a content of the amine-value dispersant. Satisfying one of the above relations allows synergetic effects obtained by using both of the dispersants to be more remarkably exhibited, thereby especially improving pigment dispersion stability, droplet discharging stability, and the like.

A content of the dispersant in the color filter ink is not specifically restricted, but preferably ranges from 2.5 to 10.2 wt % and more preferably ranges from 3.2 to 9.2 wt %.

Thermoplastic Resin

The color filter ink may include a thermoplastic resin. This can especially increase dispersibility of pigment particles in the color filter ink. In particular, in the production method as described below, using a thermoplastic resin in the preliminary dispersion process enables dispersion stability of the pigment particles in the color filter ink to be significantly improved.

For example, the thermoplastic resin may be alginic acid, polyvinyl alcohol, hydroxypropyl cellulose, carboxymethyl cellulose, hydroxyethyl cellulose, methyl cellulose, styrene-acrylate resin, styrene-acrylic acid-acrylate ester resin, styrene-maleate resin, styrene-maleate half ester resin, methacryalte-methacrylate ester resin, acrylate-acrylic ester resin, isobutylene-maleate resin, rosin-modified maleate resin, polyvinyl pyrrolidone, gum arabic starch, polyarylamine, polyvinylamine, or polyethyleneimine. Among them, a single compound or a combination of compounds can be selected for use.

A content of the thermoplastic resin in the color filter ink is, although not specifically restricted, preferably from 1.5 to 7.7 wt %, and more preferably from 2.1 to 7.2 wt %.

Other Components

The color filter ink according to the embodiment may include at least one component other than the above components. As such a component, there may be mentioned various dyes; various cross-linking agents; thermal acid generators such as onium salts including diazonium salts, iodonium salts, sulfonium salts, phosphonium salts, selenium salts, oxonium salts, ammonium salts, and benzothiazolium salts; photo-acid generators such as diazonium salts, iodonium salts, sulfonium salts, phosphonium salts, selenium salts, oxonium salts, and ammonium salts; various polymerization initiators; acid cross-linking agents; sensitizers; various photo-stabilizers; adhesive modifiers; various polymerization accelerators; fillers such as glass and alumina; adhesion accelerators such as vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxy propyl trimethoxysilane, 3-glycidoxy propylmethyl dimethoxysilane, 2-(3,4-epoxycyclohexyl)ethyltrimethoxysilane, 3-chloropropyl methyldimethoxysilane, 3-chloropropyl trimethoxysilane, 3-methacryloxy propyltrimethoxysilane, and 3-mercapto propyltrimethoxysilane; oxidation inhibitors such as 2,2-chiobis(4-methyl-6-t-butylphenol) and 2,6-di-t-butylphenol; UV absorbers such as 2-(3-t-butyl-5-methyl-2-hydroxyphenyl)-5-chlorobenzotriazole and alkoxybenzophenone; aggregation inhibitors such as sodium polyacrylate, and the like.

Examples of the dyes include azo dyes, anthraquinone dyes, condensated polycyclic aromatic carbonyl dyes, indigoid dyes, carbonium dyes, phthalocyanine dyes, methine dyes, and polymethine dyes. Specifically, for example, there may be mentioned C.I. Direct Reds 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Acid Reds 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C.I. Reactive Reds 3, 13, 17, 19, 21, 22, 23, 24, 29, 35, 37, 40, 41, 43, 45, 49, and 55; C.I. Basic Reds 12, 13, 14, 15, 18, 22, 23, 24, 25, 27, 29, 35, 36, 38, 39, 45, and 46; C.I. Direct Violets 7, 9, 47, 48, 51, 66, 90, 93, 94, 95, 98, 100, and 101; C.I. Acid Violets 5, 9, 11, 34, 43, 47, 48, 51, 75, 90, 103, and 126; C.I. Reactive Violets 1, 3, 4, 5, 6, 7, 8, 9, 16, 17, 22, 23, 24, 26, 27, 33, and 34; C.I. Basic Violets 1, 2, 3, 7, 10, 15, 16, 20, 21, 25, 27, 28, 35, 37, 39, 40, and 48; C.I. Direct Yellows 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C.I. Acid Yellows 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C.I. Reactive Yellows 2, 3, 13, 14, 15, 17, 18, 23, 24, 25, 26, 27, 29, 35, 37, 41, and 42; C.I. Basic Yellows 1, 2, 4, 11, 13, 14, 15, 19, 21, 23, 24, 25, 28, 29, 32, 36, 39, and 40; C.I. Acid Green 16; C.I. Acid Blues 9, 45, 80, 83, 90, and 185; C.I. Basic Oranges 21 and 23, and the like.

As the cross-linking agents, there may be mentioned polycarboxylic anhydrides, polycarboxylic acids, polyfunctional epoxy monomers, polyfunctional acryl monomers, polyfunctional vinyl ether monomers, polyfunctional oxetane monomers, and the like. Specific examples of the polycarboxylic anhydrides include aliphatic or alicyclic dicarboxylic anhydrides such as phthalic anhydride, itaconic anhydride, succinic anhydride, citraconic anhydride, dodecenyl succinic anhydride, tricarballylic anhydride, maleic anhydride, hexahydrophthalic anhydride, dimethyl tetrahydrophthalic anhydride, himic anhydride, and nadic anhydride; aliphatic polycarbonic dianhydrides such as 1,2,3,4-butane tetra carboxylic dianhydride and pentane tetra carboxylic dianhydride; aromatic polycarboxylic anhydrides such as pyromellitic anhydride, trimellitic anhydride, and benzophenone tetracarboxylic acid anhydride; and ester-group-containing acid anhydrides such as ethylene glycol bistrimellitate and glycerin tristrimellitate. Among them, the aromatic polycarboxylic anhydrides are preferably used, as well as epoxy resin curing agents made of commercially-available carboxylic anhydrates can also be suitably used. Furthermore, specific examples of polycarboxylic acids include aliphatic polycarboxylic acids such as succinic acid, glutaric acid, adipic acid, butane tetracarboxylic acid, maleic acid, and itaconic acid; alicyclic polycarboxylic acids such as hexahydrophthal acid, 1,2-cyclohexane dicarboxylic acid, 1,2,4-cyclohexane tricarboxylic acid, and cyclopentane tetracarboxylic acid; and aromatic polycarboxylic acids such as phthalic acid, isophthalic acid, terephthalic acid, pyromellitic acid, trimellitic acid, 1,4,5,8-naphthalene tetracarboxylic acid, and benzophenone tetracarboxylic acid. Particularly, aromatic polycarboxylic acids are preferably used. In addition, specific examples (trade names) of the polyfunctional epoxy monomers include Celloxide 2021, Epolead GT401, Epolead PB3600 (manufactured by Daicel Chemical Industries, Ltd.), bisphenol A, hydrogenated bisphenol A, or triglycidyl isocyanurate. Specific examples of the polyfunctional acryl monomers include pentaerythritol ethoxy tetra acrylate, pentaerythritol tetra acrylate, pentaerythritol triacrylate, ditrimethylolpropane tetra acrylate, trimethylolpropane triacrylate, trimethylolpropane ethoxy triacrylate, dipentaerythritol hexaacrylate trimethallyl isocyanurate, and triallyl isocyanurate. Furthermore, as specific examples of the polyfunctional vinyl ether monomers, there may be mentioned 1,4-butanediol divinyl ether, 1,6-hexanediol divinyl ether, nonanediol divinyl ether, cyclohexanediol divinyl ether, cyclohexanedimethanol divinyl ether, triethylene glycol divinyl ether, trimethylol propane trivinyl ether, and pentaerythritol tetravinyl ether. Still furthermore, specific examples of the polyfunctional oxetane monomers include xylylene dioxetane, biphenyl-type oxetane, and novolac-type oxetane.

The thermal acid generators serve as a component that generates an acid by heating. Among the compounds mentioned as the generators, particularly, sulfonium salts and benzothiazolium salts are preferable. More specific examples (trade names) of the thermal acid generator include San-Aid SI-45, SI-47, SI-60, SI-60L, SI-80, SI-80L, SI-100, SI-100L, SI-145, SI-150, SI-160, SI-110L, and SI-180L (manufactured by Sanshin Chemical Industries Ltd.); CI-2921, CI-2920, CI-2946, CI-3128, CI-2624, CI-2639, and CI-2064 (manufactured by Nippon Soda Co., Ltd.); CP-66 and CP-77 (manufactured by Asahi Denka Co, Ltd.), and FC-520 (manufactured by 3M Co., Ltd.).

The photo-acid generators serve as a component that generates an acid by light. Specifically, exemplary trade names of the photo-acid generators may be Cyracure UVI-6970, Cyracure-UVI-6974, Cyracure UVI-6990, and Cyracure UVI-950 (manufactured by Union Carbide Co., Ltd. USA); Irgacure 261 and CG-24-61 (manufactured by Chiba Specialty Chemicals Co., Ltd.); SP-150, SP-151, SP-170, and Optomer SP-171 (manufactured by Asahi Denka Industries Co., Ltd.); DAICAT II (manufactured by Daicel Chemical Industries Co., Ltd.); UVAC 1591′ (manufactured by Daicel UCB Co., Ltd.); CI-2064, CI-2639, CI-2624, CI-2481, CI-2734, CI-2855, CI-2823, and CI-2758 (manufactured by Nippon Soda Co., Ltd.); PI-2074 (trade name: pentafluorophenyl borate tolylcumyliodonium salt manufactured by Rhone-Poulenc Inc.); FFC 509 (manufactured by 3M Co., Ltd.); BBI-102, BBI-101, BBI-103, MPI-103, TPS-103, MDS-103, DTS-103, NAT-103, and NDS-103 (manufactured by Midori Chemical Co., Ltd.); and CD-1012 (manufactured by Sartomer Co., Ltd. USA).

A viscosity of the color filter ink at 25° C. (a viscosity measured by an E-type viscometer: kinematic viscosity) is preferably equal to or less than 13 mPa·s, more preferably equal to or less than 12 mPa·s, and still more preferably ranges from 5 to 11 mPa·s. For example, allowing the viscosity (the kinematic viscosity) of the color filter ink to be made sufficiently low as in the above range can especially increase production efficiency of a color filter (formation efficiency of the colored portions), and also can effectively prevent the occurrence of undesired thickness variation in the colored portions, or the like. In this case, the kinematic viscosity of the color filter ink can be measured, for example, using the E-type viscometer (e.g. RE-01 manufactured by Toki Sangyo Co., Ltd.) and particularly based on Japanese Industrial Standards (JIS) Z8809.

In addition, an amount of viscosity change in the color filter ink at 25° C. after allowing the ink to stand at 60° C. for 10 days is preferably equal to or less than 0.5 mPa·s, more preferably equal to or less than 0.3 mPa·s, and still more preferably equal to or less than 0.2 mPa·s. This can especially improve discharging stability of the color filter ink. Then, the color filter ink can be suitably used for a longer period of time to produce a color filter capable of surely preventing the unevennesses of color and density, and the like.

Method for Producing the Color Filter Ink

Next will be described a method for producing the above-described color filter ink according to a preferable embodiment of the invention.

The method includes a preliminary dispersion process, a micro-dispersion process, and a curable-resin mixing process. In the preliminary dispersion process, a mixture of the dispersant, the thermoplastic resin, and a liquid medium is stirred to disperse the dispersant in the liquid medium so as to obtain a dispersant dispersion liquid. Next, in the micro-dispersion process, the pigments are added to the dispersant dispersion liquid, and then, inorganic beads are added at multiple stages to perform micro-dispersion processing, thereby obtaining a pigment dispersion. Then, the pigment dispersion is mixed with the curable resin material. As will be described below, in the method for producing the color filter ink according to the present embodiment, in the micro-dispersion process, the sulfonate pigment derivative described above is added to the C.I. Pigment Yellow 150 that is hardly dispersed in the color filter ink, so as to enable the micro-dispersion processing. This can especially improve dispersibility of the C.I. Pigment Yellow 150 in the color filter ink obtained. As a result, a color filter produced can provide image display with a wide color reproduction range and can surely prevent the unevennesses of color and density at respective portions in the color filter.

Preliminary Dispersion Process

In the above preliminary dispersion process, the dispersants are dispersed in the liquid medium by stirring the mixture of the dispersants, the thermoplastic resin, and the liquid medium to prepare the dispersant dispersion liquid. This can eliminate (untie) a state of dispersant association.

Accordingly, in the present embodiment, before the micro-dispersion processing of the pigment described in detail as below, the mixture excluding the pigment is preliminarily dispersed, which allows pigment particles to be finally dispersed in an even and stable manner. Thus, discharging stability of the color filter ink obtained can be especially improved.

In the preliminary dispersion process, the thermoplastic resin, the dispersant, and the liquid medium are mixed together in advance. Thereby, in the micro-dispersion process described below, the dispersant and the thermoplastic resin are adhered to surfaces of the pigment particles (pigment particles that have a relatively large particle diameter and are not micro-dispersed) added in the dispersant dispersion liquid, thereby improving dispersibility of the pigment particles in the dispersant dispersion liquid. In this manner, the micro-dispersion processing in the micro-dispersion process can be efficiently performed, which can especially improve productivity of the color filter ink. Additionally, a long-term dispersion stability of the pigment particles (the micro-dispersed pigment particles) in the color filter ink finally obtained and discharging stability of droplets of the ink can be significantly improved.

A content of the dispersant (or a sum of contents of a plurality of dispersants used in combination) in the dispersant dispersion liquid prepared by the above preliminary dispersion process is not specifically restricted, but preferably ranges from 10 to 40 wt % and more preferably ranges from 12 to 32 wt %. When the content of the dispersant is in the above range, the above-described advantageous effects are more remarkably exhibited.

In addition, a content of the thermoplastic resin in the dispersant dispersion liquid prepared by the preliminary dispersion process is also not specifically restricted, but preferably ranges from 6 to 30 wt % and more preferably ranges from 8 to 26 wt %. Setting the content of the thermoplastic resin in the above range allows the above-described advantageous effects to be more remarkably exhibited.

Furthermore, a content of the liquid medium in the dispersant dispersion liquid prepared by the preliminary dispersion process is, although not specifically restricted, preferably from 40 to 80 wt % and more preferably from 53 to 75 wt %. With the content of the liquid medium set in the above range, the above-described advantageous effects are more remarkably exhibited.

In the preliminary dispersion process, a stirrer is used to stir the mixture of the components described above to prepare the dispersant dispersion liquid.

As the stirrer, for example, there may be mentioned a single-shaft or double-shaft mixer such as Disper Mill.

A time for stirring using the stirrer is not specifically restricted, but is preferably from 1 to 30 minutes and more preferably from 3 to 20 minutes. Thereby, productivity of the color filter ink can be sufficiently improved, as well as dispersant association can be more effectively eliminated. This can especially increase dispersion stability of the pigment particles in the color filter ink finally obtained and discharging stability of the color filter ink.

Furthermore, a rotation rate of a stirring wing in the stirrer used in the present process is not specifically restricted. However, a preferable rotation rate of the stirring wing ranges from 500 to 4000 rpm, and a more preferable rotation rate thereof ranges from 800 to 3000 rpm. This can sufficiently improve productivity of the color filter ink, as well as can more effectively eliminate the dispersant association, thereby especially increasing dispersion stability of the pigment particles in the color filter ink finally obtained and discharging stability of the color filter ink. Furthermore, deterioration, degeneration, or the like of the thermoplastic resin or the like due to heat or the like can be surely prevented.

Micro-Dispersion Process

Next, the above-mentioned pigment are added to the dispersant dispersion liquid obtained in the above process, and then, inorganic beads are added at multiple stages to perform the micro-dispersion processing (the micro-dispersion process).

In this manner, in the present embodiment, the preliminary dispersion process as above is performed before adding the pigments, and the inorganic beads are added at multiple stages in the process of micro-dispersing the pigments (the micro-dispersion process). In the micro-dispersion process, adding the inorganic beads at multiple stages can improve efficiency of micro-particle processing of the pigments, thereby allowing pigment particles in the color filter ink finally obtained to be sufficiently made small. Particularly, the effects obtained by a combined use of the C.I. Pigment Yellow 150 and the sulfonated pigment derivative synergistically interact with the effects obtained by using the method including the preliminary dispersion process and the micro-dispersion process at multiple stages. This can significantly improve pigment dispersion stability of the color filter ink finally obtained and discharging stability of droplets of the ink. As a result, the obtained color filter ink can be used to produce a color filter with greatly excellent brightness and contrast.

Meanwhile, when the micro-dispersion process is not performed at multiple stages, it is difficult to provide sufficiently small pigment particles in the color filter ink finally produced, or the productivity of the color filter ink is likely to be extremely reduced. Even when the micro-dispersion process is performed at multiple stages, if the preliminary dispersion process is omitted, the dispersant association is not sufficiently eliminated (untied) upon addition of the pigments. Accordingly, in the micro-dispersion process, the dispersant and the thermoplastic resin cannot be evenly adhered to the surfaces of the pigment particles. Furthermore, it is also difficult to sufficiently improve dispersibility of the pigment particles (the pigment particles that are not micro-dispersed and have a relatively large particle diameter) in the liquid medium in the micro-dispersion process.

The micro-dispersion process needs only to be performed by adding the inorganic beads at multiple stages. In the process, the inorganic beads may be added separately at three or more stages, although it is preferable to add the inorganic beads at two stages. This can sufficiently improve long-term dispersion stability of the pigment particles in the color filter ink finally obtained, and also can greatly increase the productivity of the color filter ink.

Next will be described a typical example of a method for performing a first processing using a first inorganic bead and a second processing using a second inorganic bead, in a method of adding the inorganic beads at two stages, namely, in the micro-dispersion process.

A material of the inorganic beads (the first and the second inorganic beads) used in the present process is not specifically restricted as long as the beads are made of an inorganic material. An example of a suitable inorganic bead may be zirconium beads (e.g. trade name: Toray Ceram manufactured by Toray Co., Ltd. (grinding balls)).

First Processing

In the micro-dispersion process, first, the pigments (the C.I. Pigment Yellow 150 and the sulfonated pigment derivative, or the C.I. Pigment Yellow 150, the sulfonated pigment derivative, and at least one other pigment) are added to the dispersant dispersion liquid prepared in the above-described preliminary dispersion process to perform the first processing for a first micro-dispersion using the first inorganic bead having a predetermined particle diameter. As described above, performing the micro-dispersion processing by adding the sulfonated pigment derivative to the C.I. Pigment Yellow 150 especially improves the dispersibility of the C.I. Pigment Yellow 150 in the color filter ink obtained.

Preferably, the first inorganic beads used in the first processing have a particle diameter larger than that of the second inorganic beads used in the second processing, thereby especially improving efficiency of micronization (micro-dispersion) of the pigments in the whole micro-dispersion process.

An average particle diameter of the first inorganic beads is not specifically restricted, but ranges preferably from 0.5 to 3.0 mm and more preferably from 0.5 to 1.2 mm. Setting the average particle diameter of the first inorganic beads in the above range can especially improve efficiency of the micronization (micro-dispersion) of the pigments in the whole micro-dispersion process. Conversely, setting the average particle diameter of the first inorganic beads to be smaller than a lower limit value of the range tends to greatly reduce the efficiency of micronization of the pigment particles (fragmentation into smaller particles), depending on kinds of the pigments or the like. Additionally, using the first inorganic beads having an average particle diameter larger than an upper limit value of the range can relatively increase micronization efficiency of the pigment particles in the first processing, but reduces the micronization efficiency of the pigment particles in the second processing, thereby reducing the efficiency of micronization (micro-dispersion) of the pigment particles in the whole micro-dispersion process.

An amount of the first inorganic beads to be used is not specifically restricted, but is preferably from 100 to 600 pts.wt., and more preferably from 200 to 500 pts.wt., respectively, per 100 pts.wt. of the dispersant dispersion liquid.

Additionally, an amount of the pigments to be used is not specifically restricted, but is preferably equal to or more than 12 pts. wt., and more preferably from 18 to 35 pts.wt., respectively, per 100 pts.wt. of the dispersant dispersion liquid.

In the first processing, the pigments and the first inorganic beads are added to the dispersant dispersion liquid, and then, the mixture is stirred by any of various stirrers.

A stirrer usable in the first processing may be, for example, a media-type disperser such as Pearl Mill, and a single-shaft or double-shaft mixer such as Disper Mill.

A time required for stirring (a stirring time in the first processing) using the stirrer as above is not specifically restricted, but preferably from 10 to 120 minutes and more preferably from 15 to 40 minutes. This can efficiently progress the micronization (micro-dispersion) of the pigments, without reducing the productivity of the color filter ink.

A rotation rate of a stirring wing in the stirrer used in the first processing is, although not specifically restricted, preferably from 1000 to 5000 rpm and more preferably from 1200 to 3800 rpm. This can more efficiently progress the micronization (micro-dispersion) of the pigments, without reducing the productivity of the color filter ink, as well as can surely prevent undesirable changes such as deterioration and degeneration occurring in the thermoplastic resin or other components due to heat or the like.

Second Processing

After the first processing, the second processing using the second inorganic beads is performed. Thereby, there can be obtained a pigment dispersion in which pigment particles are sufficiently micro-dispersed.

The second processing may be performed in the state where the dispersant dispersion liquid includes the first inorganic beads, but preferably, the first inorganic beads are removed before the second processing. This can especially increase the micronization (micro-dispersion) efficiency of the pigments in the second processing. The first inorganic beads can be easily and surely removed by filtering or the like.

Preferably, the second inorganic beads used in the second processing have a particle diameter smaller than that of the first inorganic beads used in the first processing. Thereby, variations among the diameters of pigment particles in the finally obtained color filter ink are sufficiently reduced, as well as the pigment particles can be sufficiently micronized (micro-dispersed). Thus, long-term dispersion stability of the pigment particles in the color filter ink and the discharging stability of droplets of the ink can be especially improved.

An average particle diameter of the second inorganic beads is not specifically restricted, but ranges preferably from 0.03 to 0.3 mm and ranges more preferably from 0.05 to 0.2 mm. Setting the average particle diameter of the second inorganic beads in the above range can especially improve the micronization (micro-dispersion) efficiency of the pigments (the pigment dispersion) in the whole micro-dispersion process. In contrast, when the second inorganic beads have an average particle diameter smaller than a lower limit value of the range, the micronization efficiency of the pigment particles (fragmentation into smaller particles) in the second processing is greatly reduced depending on kinds or the like of the pigments. Additionally, using the second inorganic beads with an average particle diameter larger than the above range can make it difficult to sufficiently progress the micronization (micro-dispersion) of the pigment particles.

An amount of the second inorganic beads to be used is not specifically restricted, but preferably from 100 to 600 pts.wt., and more preferably from 200 to 500 pts.wt., respectively, per 100 pts.wt. of the dispersant dispersion liquid.

The second processing can use any of various stirrers.

For example, a stirrer usable in the second processing may be a media-type disperser such as Pearl Mill and a single-shaft or double-shaft mixer such as Disper Mill.

A time required for stirring (a stirring time in the second processing) using the stirrer as above is not specifically restricted, but is preferably from 10 to 120 minutes and more preferably from 15 to 40 minutes. This can efficiently progress the micronization (micro-dispersion) of the pigments, without reducing the productivity of the color filter ink.

A rotation rate of a stirring wing in the stirrer used in the second processing is, although not specifically restricted, preferably from 1000 to 5000 rpm and more preferably from 1200 to 3800 rpm. This can more efficiently progress the micronization (micro-dispersion) of the pigments, without reducing the productivity of the color filter ink, as well as can surely prevent undesirable changes such as deterioration and degeneration occurring in the thermoplastic resin or other components due to heat or the like

Although the above description has mainly explained the micro-dispersion process performed at two stages. However, the micro-dispersion process may include three or more stages. In that case, preferably, inorganic beads used in a later (following) stage processing have a particle diameter smaller than that of inorganic beads used in an earlier (preceding) stage processing. In other words, an average particle diameter of inorganic beads used in an n-th stage processing (n-th inorganic beads) is preferably smaller than an average particle diameter of inorganic beads used in an (n−1)-th stage processing ((n−1)-th inorganic beads). Satisfying the above relation can especially improve the micronization (micro-dispersion) efficiency of the pigment particles, as well as can further reduce the particle diameter of the pigment particles in the finally obtained color filter ink.

In the micro-dispersion process (for example, in the first processing and/or the second processing), a processing such as dilution with a liquid medium may be performed if necessary, for example.

Curable-Resin Mixing Process

The pigment dispersion obtained in the above-described micro-dispersion process is mixed with the curable resin material (the curable-resin mixing process) to produce the color filter ink.

Preferably, the curable-resin mixing process is performed after removing the second inorganic beads used in the second processing. The second inorganic beads can be easily and surely removed by filtering or the like.

The curable-resin mixing process can use any of various stirrers.

A stirrer usable in the present process may be a single-shaft or double-shaft mixer such as Disper Mill, for example.

A time required for stirring (a processing time in the present process) using the stirrer as above is not specifically restricted, but is preferably from 1 to 60 minutes and more preferably from 15 to 40 minutes.

A rotation rate of a stirring wing in the stirrer used in the present mixing process is preferably from 1000 to 5000 rpm and more preferably from 1200 to 3800 rpm, although not specifically restricted.

The curable-resin mixing process may use a liquid having a composition different from the liquid medium used in the above micro-dispersion process. This enables suitable dispersion of the dispersant in the preliminary dispersion process and suitable micronization of the pigment particles in the micro-dispersion process, as well as enables production of the color filter ink having desired characteristics.

Additionally, in the present process, before or after mixing of the pigment dispersion and the curable resin material, at least a part of the liquid medium used in the previous process may be removed. This can make a difference between a composition of the liquid medium used in the preliminary dispersion process and the micro-dispersion process and a composition of the liquid medium in the color filter ink finally obtained. As a result, both the dispersion of the dispersant in the preliminary dispersion process and the micro-dispersion of the pigment particles in the micro-dispersion process can be suitably performed, as well as the color filter ink obtained can surely exhibit desired characteristics. For example, in order to remove the liquid medium, a liquid as an object for use is placed in a pressure-reduced atmosphere or heated.

Ink Set

The above-described color filter ink is used to produce a color filter by using an inkjet method. The color filter usually has colored portions formed with a plurality of colors (usually, three colors of red (R), green (G), and blue (B) corresponding to the three primary colors of light) to realize full-color display. The colored portions with the three colors are formed by using a plurality of color filter inks corresponding to the respective colored portions. That is, a color filter is produced by using an ink set that includes a plurality of colors of color filter inks. An ink set according to an embodiment of the invention includes a plurality of colors of color filter inks in which at least one color of a color filter ink among the color filter inks is the above-described color filter ink of the embodiment (the color filter ink that includes at least the C.I. Pigment Yellow 150 and the sulfonated pigment derivative described above). In the ink set, at least one color of a color filter ink among R, G, and B color filter inks may be the color filter ink of the embodiment, or at least one other color (at least one color other than R, G, and B) of a color filter ink may be the color filter ink of the embodiment. Consequently, a color filter obtained by using the ink set of the embodiment as above can provide image display with a high contrast ratio and a wide color reproduction range.

Furthermore, the color filter ink having each color included in the ink set of the embodiment may be discharged in a different cell for each color or in a same cell. For example, a red ink and a described-below yellow ink are discharged in the same cell to form colored portions of a color filter. Thereby, the color filter can suitably exhibit subtle changes or the like in color tone, which cannot be achieved by colored portions formed by discharging the red ink and the yellow ink, respectively, in different cells.

In addition, when the ink set includes an ink other than the color filter ink of the embodiment, a method for producing the ink is not specifically restricted. However, preferably, the ink is produced by the same method as the above-described method for producing the color filter ink of the embodiment, excepting that the kinds of pigments are changed. This can more appropriately suppress variations in discharging stability of ink droplets among the respective colors, thus resulting in production of a more reliable color filter. Preferably, the ink includes the above-mentioned curable resin material, although not specifically restricted. This can more greatly suppress variations in the droplet discharging stability and the like among the colors, thereby enabling production of a more reliable color filter. Furthermore, variations in characteristics (such as light resistance and adhesion to a substrate) among the colored portions with the respective colors can also be suppressed, thereby especially increasing reliability, durability, and the like of the color filter produced.

When the ink set of the embodiment includes a green color filter ink (a G ink), the G ink is preferably the color filter ink of the embodiment that includes C.I. Pigment Green 58 as a pigment, in addition to the C.I. Pigment Yellow 150 and the sulfonated pigment derivative. This can especially increase color development of the G ink, as well as can greatly improve a long-term dispersion stability of pigment particles in the color filter ink and discharging stability of the color filter ink. Additionally, contrast, lightness, and coloring density of a green colored portion can be significantly increased, and the color reproduction range of the color filter can be greatly widened.

When the ink set includes a red color filter ink (an R ink), the R ink preferably includes C.I. Pigment Red 177 and a derivative thereof and/or C.I. Pigment Red 254 and a derivative thereof, as pigments. This can especially increase color development of the R ink, as well as can greatly improve a long-term dispersion stability of pigment particles in the color filter ink and discharging stability of the color filter ink.

The above advantageous effects can be more remarkably exhibited when the derivative of the C.I. Pigment Red 177 and/or the derivative of the C.I. Pigment Red 254 included in the R ink is a compound (a derivative) represented by following chemical formula 8 or 9.

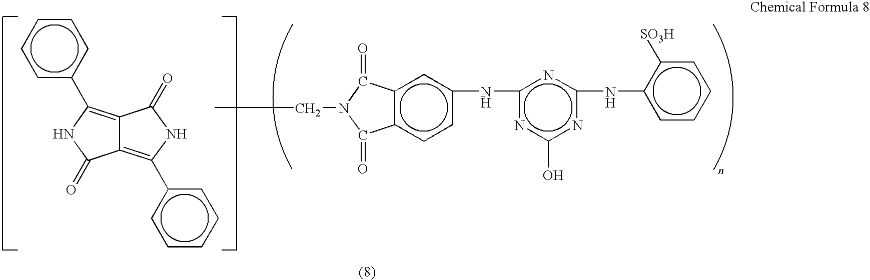

wherein n represents an integer of 1 to 4.

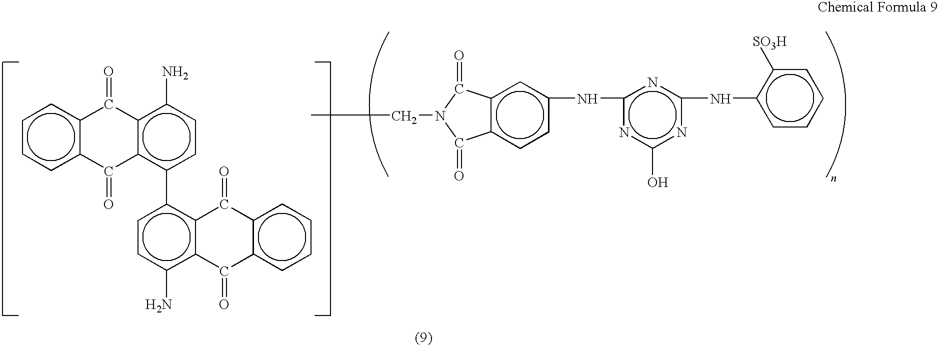

wherein n represents an integer of 1 to 4.

In addition, the R ink as above may be the color filter ink of the embodiment that includes the C.I. Pigment Red 177 and/or the C.I. Pigment Red 254 in addition to the C.I. Pigment Yellow 150 and the sulfonated pigment derivative. In this manner, color development of the R ink can be excellently improved, as well as there can be significant improvements in the long-term dispersion stability of pigment particles in the color filter ink and the discharging stability of the color filter ink. Additionally, contrast, lightness, and coloring density of the red colored portion can be significantly improved, and the color reproduction range of the color filter can be especially widened.

When the ink set includes a blue color filter ink (a B ink), the B ink preferably includes C.I. Pigment Blue 15:6 and C.I. Pigment Violet 23 as pigments. This can especially improve color development of the B ink, thus significantly improving contrast, lightness, and coloring density of a blue colored portion formed. Additionally, the color reproduction range of the color filter can be greatly widened. Preferably, the B ink as thus obtained is an ink that dose not include the C.I. Pigment Yellow 150 and the sulfonated pigment derivative as described above. In short, preferably, the B ink is an ink other than the color filter ink of the embodiment.

In addition to the above R, G, and B inks, the ink set of the embodiment may include a yellow ink (a Y ink) as the color filter ink of the embodiment. Thereby, the color filter obtained can exhibit a high contrast and can provide image display with a wide reproduction range.

When the ink set of the embodiment includes the Y ink in addition to the R, G, and B inks, the ink set preferably further includes a cyan (C) ink and a magenta (M) ink in addition to the R, G, B, and Y inks. Thereby, a color filter obtained by using the ink set of the embodiment can exhibit a high contrast and can provide image display with a wide color reproduction range.

When the ink set of the embodiment includes a cyan color filter ink (the C ink), the C ink preferably includes C.I. Pigment Blue 15:3 as a pigment. Thereby, contrast, lightness, and coloring density of a cyan colored portion can be significantly improved, and the color reproduction range of a color filter obtained can be especially widened.

In addition, when the ink set of the embodiment includes a magenta color filter ink (the M ink), the M ink preferably includes C.I. Pigment Red 122 as a pigment. Thereby, contrast, lightness, and coloring density of a magenta colored portion can be significantly improved, and the color reproduction range of a color filter obtained can be especially widened.

Color Filter

Next will be described a color filter according to an embodiment of the invention, produced by using the above-described color filter ink (the ink set).

### First Embodiment

A color filter according to a first embodiment will be described below

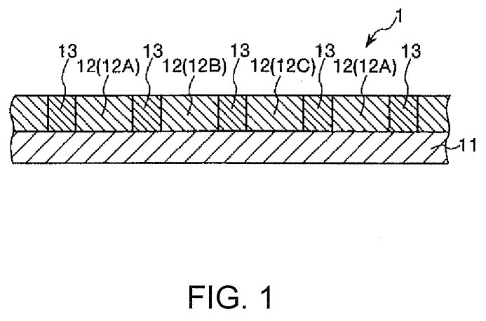

FIG. 1 is a sectional view showing the color filter according to the first embodiment.

As shown in FIG. 1, a color filter 1 includes a substrate 11 and colored portions 12 formed with the above-described color filter ink (the ink set). The colored portions 12 include a red colored portion (a first colored portion) 12A formed with the color filter ink of the embodiment (the red ink) including the C.I. Pigment Yellow 150, the above-described sulfonated pigment derivative, and at least one red pigment; a green colored portion (a second colored portion) 12B formed with the color filter ink of the embodiment (the green ink) including the C.I. Pigment Yellow 150, the sulfonated pigment derivative, and at least one green pigment; and a blue colored portion (a third colored portion) 12C formed with the blue ink including at least one blue pigment. Between adjacent ones of the colored portions 12 (12A, 12B, and 12C) is provided a partition wall 13.

Substrate

The substrate 11 is a plate-shaped member having optical transparency and has the colored portions 12 and the partition wall 13 thereon.

Preferably, the substrate 11 is made of a substantially transparent material. Thereby, images can be more clearly formed by light transmitted through the color filter 1.

In addition, preferably, the substrate 11 has an excellent heat resistance and an excellent mechanical strength. This can, for example, surely prevent deformation or the like of the substrate 11 due to heat applied in production of the color filter 1. The substrate 11 satisfying the above condition may be made of glass, silicon, polycarbonate, polyester, aromatic polyamide, polyamide imide, polyimide, a norbornene ring-opening polymer, a hydrogen additive thereof, or the like.

Colored Portions

Each of the colored portions 12 is formed by using the above-described color filter ink (the ink set).

Accordingly, forming each colored portion 12 by using the color filter ink reduces variations in characteristics between respective pixels and surely prevents undesired color mixing (mixing of multiple color filter inks), and the like. Thus, in the color filter 1, the unevennesses of color and density, and the like can be suppressed, thereby providing a high reliable color filter. In addition, the color filter 1 can exhibit excellent color development, high contrast, and especially wide color reproduction range in the colored portions 12.

The each colored portion 12 is provided in a cell 14 as a region surrounded by the partition wall 13 as described below.

As described below, the first colored portion 12A, the second colored portion 12B, and the third colored portion 12C have mutually different colors. A single group of the colored portions 12A, 12B, and 12C having the different colors constitutes a single pixel. In the color filter 1, a predetermined number of the colored portions 12 are arranged in lateral and vertical directions. For example, when the color filter 1 is a high-vision color filter, there are arranged 1366×768 pixels in the filter. The color filter 1 formed as a full high-vision color filter has 1920×1080 pixels, and the color filter 1 as a super high-vision color filter has 7680×4320 pixels. In addition, the color filter 1 may include at least one spare pixel outside a valid region, for example.

Partition Wall

Between adjacent ones of the colored portions 12 is provided the partition wall (a bank) 13. This can surely prevent a color mixing between the adjacent colored portions 12, whereby clear images can be surely displayed.

The partition wall 13 may be made of a transparent material, but is preferably made of a light-shielding material, thereby achieving high-contrast image display. A color of the partition wall (a light-shielding portion) 13 is not specifically restricted, but is preferably black, which enables contrast of displayed images to be especially improved.

Preferably, a height of the partition wall 13 is larger than a film thickness of the colored portions 12, although not specifically restricted. Thereby, a color mixing between the adjacent colored portions 12 can be surely prevented. A specific thickness of the partition wall 13 is preferably from 0.1 to 10 μm and more preferably from 0.5 to 3.5 μm. This can surely prevent color mixing between the adjacent colored portions 12, and image displays and electronic apparatuses incorporating the color filter 1 can exhibit excellent viewing-angle characteristics.

The partition wall 13 can be made of any material, but is preferably made mainly of a curable resin material. This enables the partition wall 13 having a desired shape to be easily formed by a method described below. In addition, when the partition wall 13 serves as the light-shielding portion, the partition wall 13 may be made of a material including a light absorber such as carbon black.

Next will be described a method for producing the color filter according to a preferred embodiment of the invention.

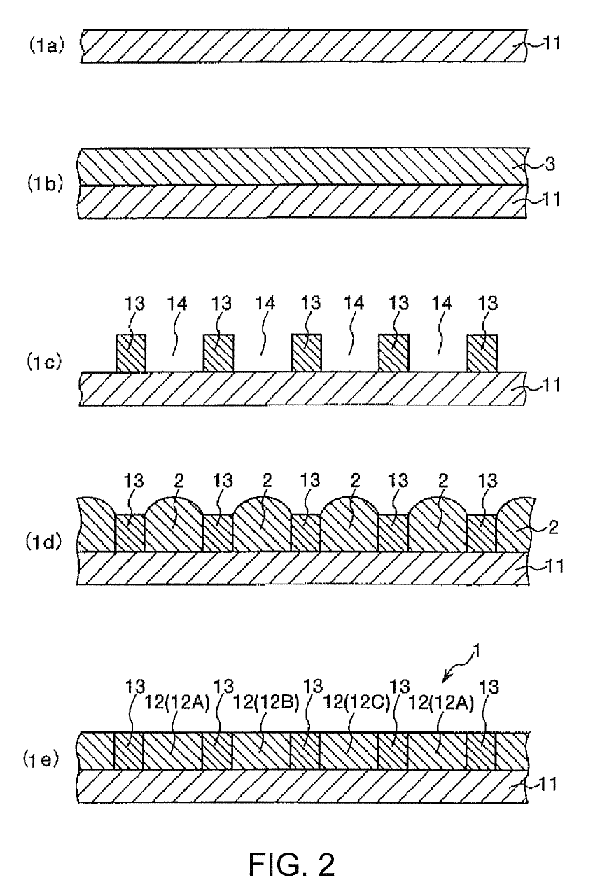

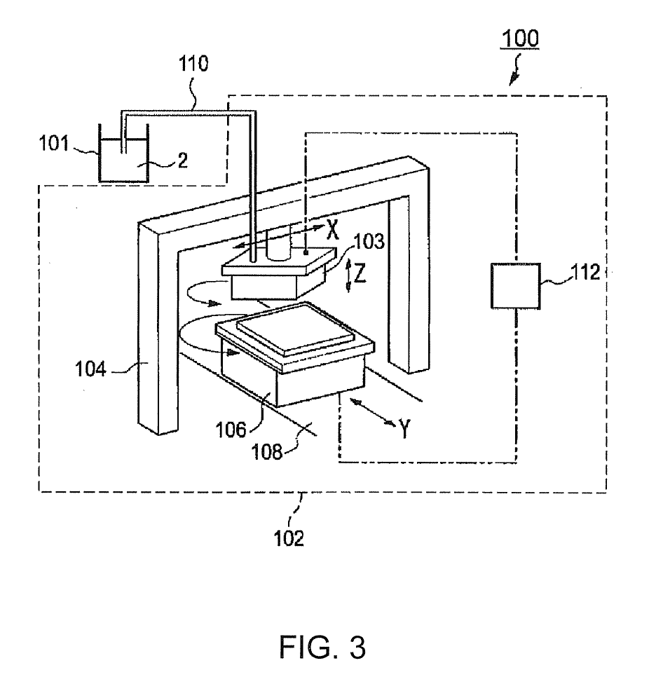

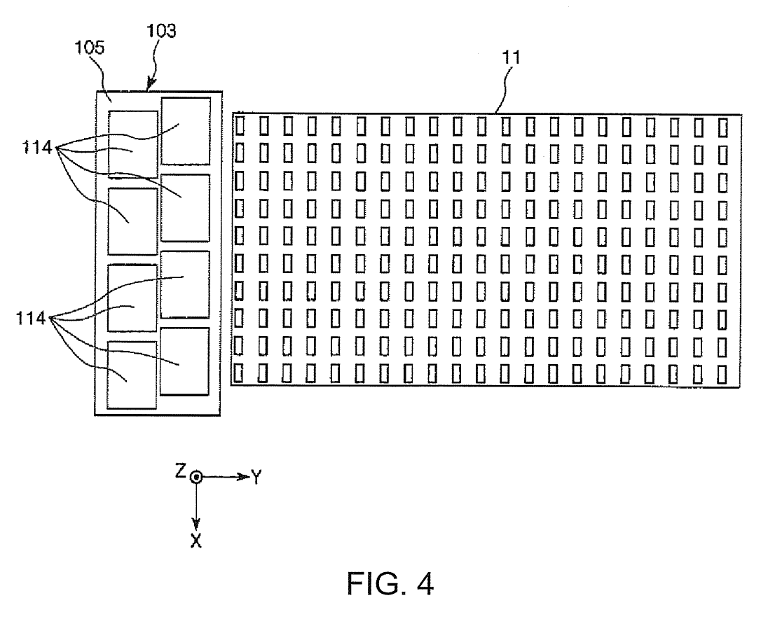

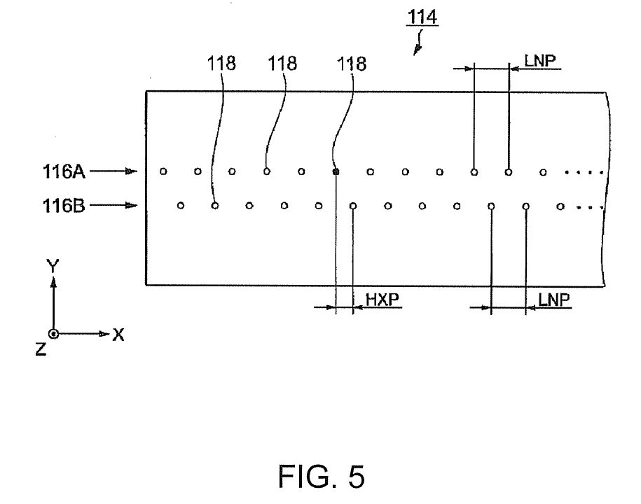

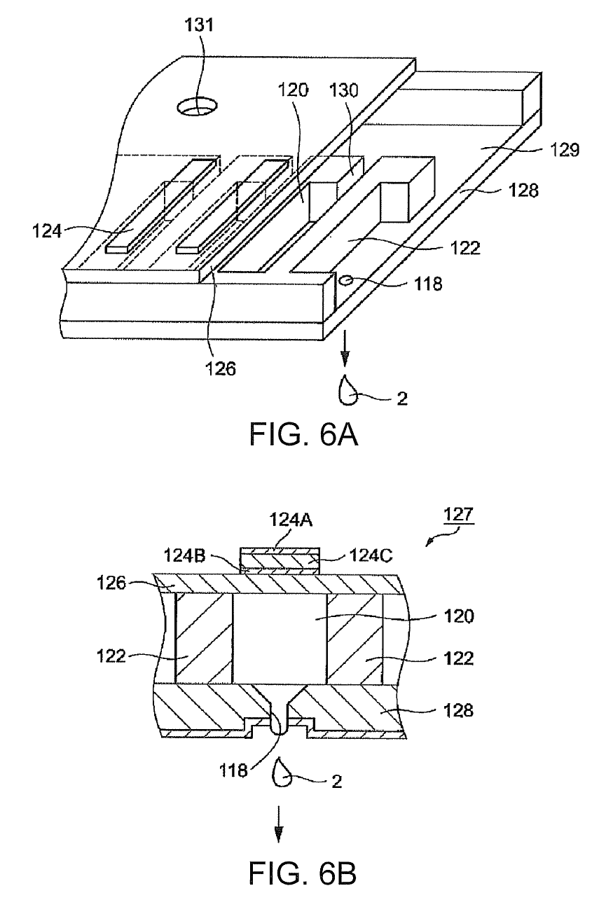

FIG. 2 is sectional views showing a method for producing the color filter shown in FIG. 1. FIG. 3 is a perspective view showing a liquid droplet discharging apparatus used to produce the color filter shown in FIG. 1. FIG. 4 is a plan view of a liquid droplet discharging unit as it appears when viewed from a stage in the liquid droplet discharging apparatus of FIG. 3. FIG. 5 is a plan view showing a bottom surface of a liquid droplet discharging head in the liquid droplet discharging apparatus of FIG. 3. FIG. 6A is a sectional perspective view of the liquid droplet discharging head in the liquid droplet discharging apparatus of FIG. 3, and FIG. 6B is a sectional view of the liquid droplet discharging head.

As shown in FIG. 2, the production method according to the present embodiment includes preparing the substrate 11 (a substrate preparing step 1a); forming the partition wall 13 on the substrate 11 (partition-wall forming steps 1b and 1c); applying a color filter ink 2 in the region surrounded by the partition wall 13 by using the inkjet method (an ink applying step 1d); and forming the colored portions 12 having a solid shape after removing a solvent (a liquid medium) from the color filter ink 2 and then curing the curable resin material (a colored-portion forming step 1e).

Substrate Preparing Step

First, the substrate 11 is prepared (1a). The substrate 11 prepared in the step is preferably a substrate that has been subjected to washing treatment. In addition, the prepared substrate 11 may be a substrate subjected appropriately to a pre-treatment such as a chemical treatment using a silane coupling agent or the like, a plasma treatment, ion plating, sputtering, vapor-phase reaction, or vacuum deposition.

Partition-Wall Forming Step

Next, on an approximately entire area of one of opposing main surfaces of the substrate 11 is applied a radiation-sensitive composite for forming the partition wall of the substrate 11 to form a coating film 3 (1b). In this case, after applying the radiation-sensitive composite on the substrate 11, a pre-baking treatment may be performed if necessary. For example, the pre-baking treatment may be performed by heating at a temperature of 50 to 150° C. for a time of 30 to 600 seconds.

After that, radiation is applied to the substrate via a photo mask to perform a post-exposure baking (PEB) treatment, followed by a developing treatment using an alkali developer to form the partition wall 13 (1c). For example, the post-exposure baking (PEB) treatment can be provided at a heating temperature of 50 to 150° C. for a heating time of 30 to 600 seconds, at a radiation intensity of 1 to 500 mJ/cm². In addition, the developing treatment can be performed, for example, by liquid coating, dipping, oscillation/immersion, or the like. A development time is from 10 to 300 seconds, for example. After the development, a post-baking treatment may be performed if necessary. For example, the post-baking treatment may be performed at a heating temperature of 150 to 280° C. for a heating time of 3 to 120 minutes.

Ink Applying Step

Next, using the inkjet method, the color filter ink 2 is applied in each cell 14 surrounded by the partition wall 13 (1d).

The ink applying step uses a plurality of color filter inks 2 corresponding to different colors of the colored portions 12 to be formed. In this case, a presence of the partition wall 13 can surely prevent mixing between two or more of the color filter inks 2.

The color filter ink 2 is discharged by the liquid droplet discharging apparatus as shown in FIGS. 3 to 6B.

As shown in FIG. 3, a liquid droplet discharging apparatus 100 used in the ink applying step includes a tank 101 storing the color filter ink 2, a tube 110, and a discharging scan section 102 to which the color filter ink 2 is supplied from the tank 101 via the tube 110. The discharging scan section 102 includes a liquid droplet discharging unit 103 having a carriage 105 with a plurality of liquid droplet discharging heads (inkjet heads) 114, a first position-controlling unit 104 (a moving unit) that controls a position of the liquid droplet discharging unit 103, a stage 106 that retains the substrate 11 having the partition wall 13 formed in the above step (hereinafter also referred to simply as the “substrate 11”), a second position-controlling unit 108 (a moving unit) that controls a position of the stage 106, and a controlling unit 112. The tube 110 connects the tank 101 to the liquid droplet discharging heads 114 of the liquid droplet discharging unit 103, whereby the color filter ink 2 is supplied from the tank 101 to each of the discharging heads 114 through a use of compressed air.

The first position-controlling unit 104 moves the liquid droplet discharging unit 103 in an X-axis direction and a Z-axis direction orthogonal to the X-axis direction in response to a signal from the controlling unit 112. In addition, the first position-controlling unit 104 serves to rotate the liquid droplet discharging unit 103 around an axis parallel to a Z axis. In the present embodiment, the Z-axis direction is a direction parallel to a vertical direction (a gravity acceleration direction). The second position-controlling unit 108 moves the stage 106 in a Y-axis direction orthogonal to both the X-axis direction and the Z-axis direction in response to a signal from the controlling unit 112. Additionally, the second position-controlling unit 108 serves to rotate the stage 106 around the axis parallel to the Z axis.

The stage 106 has a plane parallel to both the X-axis direction and the Y-axis direction, and is configured so as to fix or retain the substrate 11 on the plane, where the substrate 11 has the cells 14 into which the color filter inks 2 are to be applied.

As described above, the liquid droplet discharging unit 103 is moved in the X-axis direction by the first position-controlling unit 104, whereas the stage 106 is moved in the Y-axis direction by the second position-controlling unit 108. That is, the first and the second position-controlling units 104 and 108 change a positional relationship between the liquid droplet discharging heads 114 and the stage 106 (namely, the substrate 11 retained on the stage 106 is relatively moved with respect to the liquid droplet discharging unit 103).

The controlling unit 112 is configured to receive discharging data that indicates a relative position for discharging the color filter ink 2 from an external information processor.

As shown in FIG. 4, the liquid droplet discharging unit 103 includes the liquid droplet discharging heads 114 having an approximately equal structure, and the carriage 105 retaining the discharging heads 114. In the present embodiment, the liquid droplet discharging unit 103 includes eight liquid droplet discharging heads 114. Each of the discharging heads 114 has a bottom surface with a plurality of nozzles 118 described below. The bottom surface of the discharging head 114 has a polygonal shape having two long sides and two short sides. In addition, the bottom surface of the each discharging head 114 retained by the liquid droplet discharging unit 103 faces the stage 106, as well as a direction of the long sides and a direction of the short sides, respectively, of the discharging head 114 are parallel to the X-axis direction and the Y-axis direction, respectively.

As shown in FIG. 5, the liquid droplet discharging head 114 has the nozzles 118 arranged in the X-axis direction. The nozzles 118 are located such that a nozzle pitch HXP in the X-axis direction of the liquid droplet discharging head 114 is set to a predetermined value. A specific value of the nozzle pitch HXP is not particularly restricted, but may be set in a range of 50 to 90 μm, for example. In this case, “the nozzle pitch HXP in the X-axis direction of the discharging head 114” is equivalent to a pitch between a plurality of nozzle images obtained by reflecting all images of the nozzles 118 of the discharging head 114 on the X axis along the Y-axis direction.

In the embodiment, the nozzles 118 of the liquid droplet discharging head 114 form a nozzle array 116A and a nozzle array 116B, both of which are extended in the X-axis direction. The nozzle array 116A and the nozzle array 116B are located in parallel to each other and spaced apart from each other. Additionally, in the embodiment, each of the nozzle lines 116A and 116B includes 90 nozzles 118 that are arranged in a single line in the X-axis direction at regular intervals LNP. A specific value of the LNP is not particularly restricted, but may be set in a range of 100 to 180 μm, for example.

A position of the nozzle array 116B is deviated with respect to a position of the nozzle array 116A in a positive direction (a right direction in FIG. 5) of the X-axis direction by a half length of the nozzle pitch LNP. Accordingly, the nozzle pitch HXP in the X-axis direction of the liquid droplet discharging head 114 is equal to the half length of the nozzle pitch LNP in the nozzle array 116A (or the nozzle array 116B).

Thus, a linear density of nozzles in the X-axis direction of the liquid droplet discharging head 114 is twice a linear density of nozzles in the nozzle array 116A (or the nozzle array 116B). In the present specification, the “linear density of nozzles in the X-axis direction” is equivalent to a number per unit length of the nozzle images-obtained by reflecting the nozzle images on the X axis along the Y-axis direction. A number of nozzle arrays included in the liquid droplet discharging head 114 is not restricted to only two, although it is needless to say. The discharging head 114 may include M pieces of nozzle arrays. In this case, M is a natural number of 1 or more. In each of the M pieces of nozzle arrays, the nozzles 118 are arranged at a pitch M times longer than the nozzle pitch HXP. When M is a natural number of 2 or more, with respect to one of the M pieces of nozzle arrays, the other (M−1) pieces of nozzle arrays are deviated in the X-axis direction by a length i times longer than the nozzle pitch HXP, without overlapping with each other. In this case, i is a natural number of 1 to (M−1).

In the present embodiment, each of the nozzle arrays 116A and 116B includes the 90 nozzles 118, so that each of the liquid droplet discharging heads 114 has 180 nozzles 118. In this case, respective five nozzles located on opposite end sides of the nozzle array 116A are set as “resting nozzles”. Similarly, on opposite end sides of the nozzle array 116B are provided respective five resting nozzles. The 20 resting nozzles do not discharge the color filter ink 2. Consequently, among the 180 nozzles 118 of the liquid droplet discharging heads 114, 160 nozzles 118 serve to discharge the color filter ink 2.

As shown in FIG. 4, in the liquid droplet discharging unit 103, the liquid droplet discharging heads 114 are arranged in two arrays in the X-axis direction. The discharging heads 114 included in one of the two arrays are arranged so as to partially overlap with the discharging heads 114 included in the other one of the arrays when viewed from the Y-axis direction, in consideration of a presence of the resting nozzles. Thereby, in the liquid droplet discharging unit 103, the nozzles 118 discharging the color filter ink 2 are arranged at the nozzle pitch HXP continuously in the X-axis direction over a length of the substrate 11 in the X-axis direction.

In the liquid droplet discharging unit 103 of the embodiment, the discharging heads 114 are positioned so as to cover an entire length of the substrate 11 in the X-axis direction, but, alternatively, may cover a part of the length of the substrate in the X-axis direction.

As shown in FIGS. 6A and 6B, each liquid droplet discharging head 114 is an inkjet head. More specifically, the discharging head 114 includes an oscillation plate 126 and a nozzle plate 128. Between the oscillation plate 126 and the nozzle plate 128 is disposed a liquid reservoir 129 constantly filled with the color filter ink 2 supplied from the tank 101 through a hole 131.

Between the oscillation plate 126 and the nozzle plate 128 are disposed a plurality of partition walls 122. A region surrounded by the oscillation plate 126, the nozzle plate 128, and a single pair of the partition walls 122 is a cavity 120. The cavity 120 is provided to correspond to each nozzle 118, so that a number of the cavities 120 is equal to that of the nozzles 118. The cavity 120 receives the color filter ink 2 supplied from the liquid reservoir 129 through a supplying hole 130 disposed between the single pair of the partition walls 122.

On the oscillation plate 126 is disposed an oscillator 124 in accordance with each of the cavities 120. The oscillator 124 includes a piezo element 124C and a pair of electrodes 124A and 124B sandwiching the piezo element 124C therebetween. Applying a driving voltage between the pair of the electrodes 124A and 124B allows the color filter ink 2 to be discharged from the nozzles 118 corresponding to the cavities. The shape of each nozzle 118 is adjusted such that the color filter ink 2 is discharged from the each nozzle 118 in the Z-axis direction.

A surface region in a vicinity of the nozzles 118 on the nozzle plate 128 is covered with a silica film having a fluoroalkyl group, thus allowing the nozzles 118 to be highly lyophobic so as to much suitably reject the ink 2. In particular, using the nozzle plate 128 having the silica film as above can prevent the generation of undesired aggregates in the C.I. Pigment Yellow 150 and the sulfonated pigment derivative in the vicinity of the nozzles 118. This can surely prevent flight deviation of ink droplets discharged, fluctuation of amounts of droplets, and clogging in the nozzles 118, whereby dischargeability of droplets of the color filter ink 2 can be maintained especially excellent over a significantly long period of time.

The controlling unit 112 (See FIG. 3) may be configured so as to send a signal independently to each of the oscillators 124. That is, a volume of the color filter ink 2 discharged from each of the nozzles 118 may be controlled for each nozzle 118 in response to the signal from the controlling unit 112. Additionally, the controlling unit 112 may also be able to designate which of the nozzles 118 discharge the ink 2 or not during an ink-applying scanning operation.

In the present specification, a section including a single one of the nozzles 118, a cavity 120 corresponding to the single nozzle 118, and an oscillator 124 corresponding to the above cavity 120 is referred to as a “discharging section 127”. Accordingly, a single liquid droplet discharging head 114 includes a number of discharging sections 127 equivalent to the number of the nozzles 118.

Using the liquid droplet discharging apparatus 100 configured as above, the color filter inks 2 corresponding to the colored portions 12 of the multiple colors in the color filter 1 are applied in the respective cells 14. Using the apparatus 100 enables the respective color filter inks 2 to be efficiently and selectively applied in the respective cells 14. Additionally, as described above, the color filter inks 2 can exhibit excellent discharging stability. Thus, even in a case of discharging droplets over a long period of time, there hardly occur problems such as flight deviation of the droplets and instability in the discharging amounts of the droplets. Consequently, there can be surely prevented problems such as mixing between the plurality of colors of the inks used to form the different colors of the colored portions (color mixing) and variations in coloring density among the colored portions required to basically have an equal coloring density. In a structure of the liquid droplet discharging apparatus 100 shown in the drawings, the apparatus 100 includes the tank 101 storing the color filter ink 2, the tube 110, and other constituent elements used for discharging only a single color of the ink, but alternatively may include a number of constituent elements equivalent to the number of the multiple colors of inks corresponding to the multiple colors of the colored portions 12 included in the color filter 1. Furthermore, the color filter 1 may be produced by using a plurality of liquid droplet discharging apparatuses 100 corresponding to the multiple colors of the color filter inks 2.

In the present embodiment, the liquid droplet discharging head 114 may use an electrostatic actuator as a driving element, instead of the piezo element. Alternatively, the discharging head 114 may use an electro-thermal transducing element as the driving element, whereby thermal expansion of a material due to the electro-thermal transducing element can be utilized to discharge the color filter ink.

Colored-Portion Forming Step (Curing Step)

Next, a solvent (a liquid medium) is removed from the color filter ink 2 in each cell 14, and then the curable resin material is cured to form the colored portions 12 as solid portions (1e) so as to obtain the color filter 1 of the present embodiment.

The colored-portion forming step is usually performed by heating. However, in the present step, for example, an active energy ray may be irradiated, or the substrate 11 with the color filter ink 2 applied thereon may be placed under a pressure-reduced environment. Irradiation of the active energy ray can efficiently progress curing reaction of the curable resin material, and also can ensure progress in the curing reaction of the material at a relatively low heating temperature. Thus, there can be obtained advantageous effects such as that negative effects on the substrate 11 or the like can be more surely prevented. Examples of the active energy ray include light rays having various wavelengths, such as a UV ray, an X-ray, a gamma ray, an ion ray, and an excimer laser. In addition, when the substrate 11 with the color filter ink 2 is under the pressure-reduced environment, removal of the solvent (the liquid medium) can be more efficiently performed, and the colored portions in each pixel cell can be surely formed so as to have a desirable shape. Furthermore, even if the heating temperature is relatively low, the solvent (the liquid medium) can be unfailingly removed. Thus, for example, negative effects on the substrate 11 or the like can be more surely prevented.

The heating temperature in the present process is not specifically restricted, but is preferably from 50 to 260° C. and more preferably from 80 to 240° C.

In the above description, both the red ink and the green ink have been described as the color filter ink of the embodiment. However, one of the red and the green inks may not be the color filter ink of the embodiment.

### Second Embodiment

Next will be described a color filter according to a second embodiment of the invention.

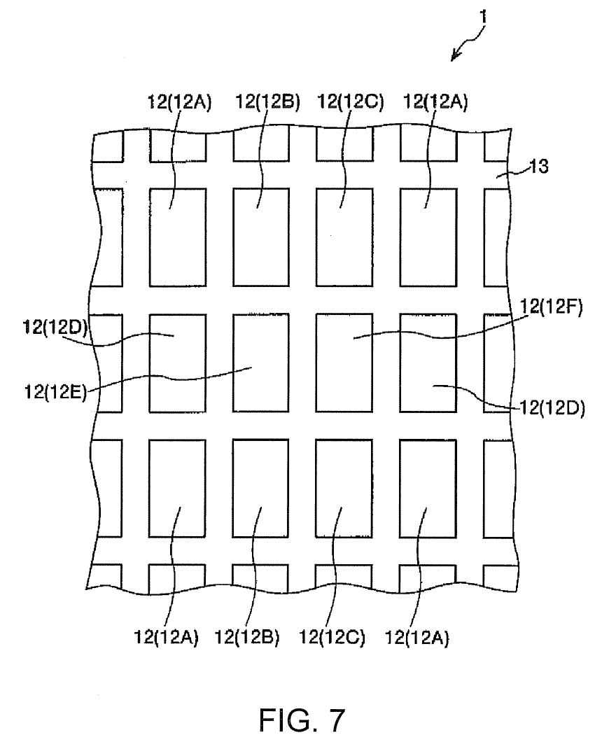

FIG. 7 is a plan view showing the color filter of the second embodiment.

Hereinafter, the color filter of the second embodiment will be described focusing mainly on differences between the first and the second embodiments, and descriptions of common elements will be omitted.

The color filter of the second embodiment is the same as that of the first embodiment, excepting that the colored portions 12 is structured differently from those included in the color filter of the first embodiment.

As shown in FIG. 7, the colored portions 12 of the present embodiment include the red colored portion (the first colored portion) 12A formed with a red ink containing at least a red pigment, the green colored portion (the second colored portion) 12B formed with a green ink containing at least a green pigment, the blue colored portion (the third colored portion) 12C formed with a blue ink containing at least a blue pigment, a yellow colored portion (a fourth colored portion) 12D formed with a yellow ink containing at least the C.I. Pigment Yellow 150 and the above-described sulfonated pigment derivative, a cyan colored portion (a fifth colored portion) 12E formed with a cyan ink containing at least a cyan pigment, and a magenta colored portion (a sixth colored portion) 12F formed with a magenta ink containing at least a magenta pigment.

As described above, the first to the sixth colored portions 12A to 12F each exhibit color tones different from one another. A single pixel includes a single group of the colored portions 12A through 12F having the different color tones. The color filter 1 has a predetermined number of the colored portions 12 arranged thereon laterally and vertically. The color filter 1 thus structured realizes high-contrast display images with a significantly wide color reproduction range, as compared to a color filter in which each single pixel has three colors of R, G, and B. Particularly, an extremely wide-range of color reproduction can be provided, and subtle changes in color tones or the like can be suitably shown by adjusting an amount of light transmitted through the colored portions 12 (the first to the sixth colored portions 12A to 12F).

Additionally, the first colored portion A (the red colored portion) and/or the second colored portion 12B (the green colored portion) included in the color filter 1 structured as above may be formed with the color filter ink of the embodiment described above.

Furthermore, in the color filter 1 of the present embodiment, each single pixel includes the six colors of the colored portions having the different color tones. However, the structure of the single pixel is not specifically restricted to that, and, for example, may include four, five, seven or more colors of colored portions having different color tones from one another.

Image Display

Next, a description will be given of an image display (an electro-optical device) including the color filter 1, according to a preferable embodiment of the invention.

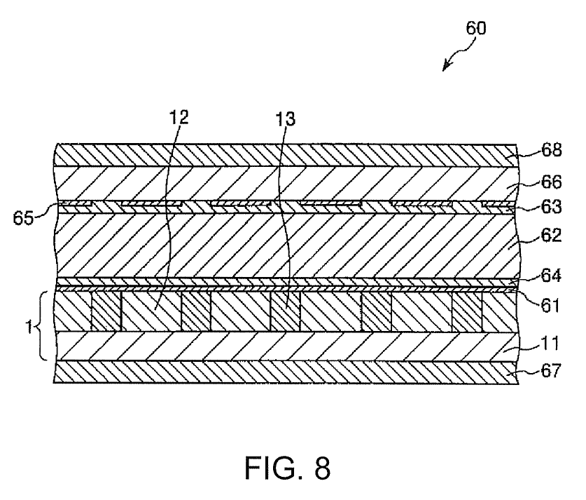

FIG. 8 is a sectional view of a liquid crystal display according to the preferable embodiment. As shown in FIG. 8, a liquid crystal display 60 includes the color filter 1; a substrate (an opposing substrate) 66 disposed so as to be opposed to a surface of the color filter 1 where the colored portions 12 are provided; a liquid crystal layer 62 made of a liquid crystal material and enclosed in a space between the color filter 1 and the substrate 66; a polarizing plate 67 disposed on a first surface of the substrate 11 at a side opposite to a second surface thereof adjacent to the liquid crystal layer 62 (on a bottom side of the liquid crystal display in FIG. 8) in the color filter 1, and a polarizing plate 68 disposed on a first surface of the opposing substrate 66 at a side opposite to a second surface thereof adjacent to the liquid crystal layer 62 (on a top side of the display in FIG. 8). A common electrode 61 is disposed on the surface of the color filter 1 having the colored portions 12 and the partition wall 13 provided thereon (surfaces of the colored portions 12 and the partition wall 13 at a side opposite to surfaces thereof facing the substrate 11). On the second surface of the opposing substrate 66 opposing the liquid crystal layer 62 and the color filter 1, a plurality of pixel electrodes 65 are arranged in a matrix at positions corresponding to the colored portions 12 of the color filter 1. Additionally, between the common electrode 61 and the liquid crystal layer 62 is disposed an alignment film 64, whereas between the substrate 66 (the pixel electrodes 65) and the liquid crystal layer 62 is disposed an alignment film 63.

The opposing substrate 66 is a substrate having visible-light transmission characteristics, and may be a glass substrate, for example.

The common electrode 61 and the pixel electrode 65 are made of a material having visible-light transmission characteristics, and may be made of indium tin oxide (ITO) or the like.

Although not shown in the drawing, a plurality of switching elements (such as thin film transistors: TFTs) are provided so as to correspond to the pixel electrodes 65. Controlling a voltage applied between the pixel electrodes 65 corresponding to the colored portions 12 and the common electrode 61 enables control of light transmission characteristics in a region corresponding to the colored portions 12 (the pixel electrodes 65).

In the liquid crystal display 60, light emitted from a not-shown back light is input from the polarizing plate 68 (the top side of the display in FIG. 8). Then, the light transmitted through the liquid crystal layer 62 and then input to the colored portions 12 (12A to 12C or 12A to 12F) is output from the polarizing plate 67 (the bottom side of the display in FIG. 8) as light of colors corresponding to the colored portions 12 (12A to 12C or 12A to 12F).

As described above, the colored portions 12 are formed with the color filter ink 2 (the ink set) of the embodiment, whereby characteristic variations among the pixels are suppressed. As a result, the liquid crystal display 60 can stably display images in which the unevennesses of color and density, and the like are suppressed at respective portions. Furthermore, the colored portions 12 formed with the color filter ink of the embodiment realize image display with a fully wide color reproduction range, thereby sufficiently increasing contrast and coloring density.

Electronic Apparatus

An image display (an electro-optical device) 1000 such as the liquid crystal display having the color filter 1 described above can be used in a display section of various electronic apparatuses.

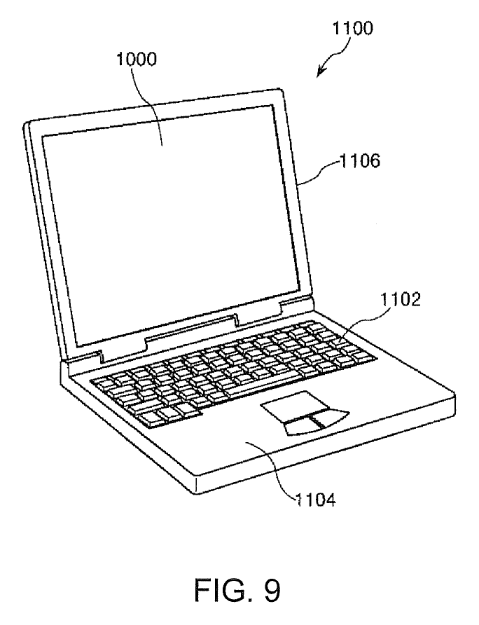

FIG. 9 is a perspective view showing a structure of a mobile (or a notebook) personal computer applied as an example of an electronic apparatus according to an embodiment of the invention.

In the drawing, a personal computer 1100 includes a main body 1104 having a keyboard 1102 and a display unit 1106. The display unit 1106 is supported rotatably with respect to the main body 1104 via a hinged portion.

In the personal computer 1100, the display unit 1106 includes the image display 1000.

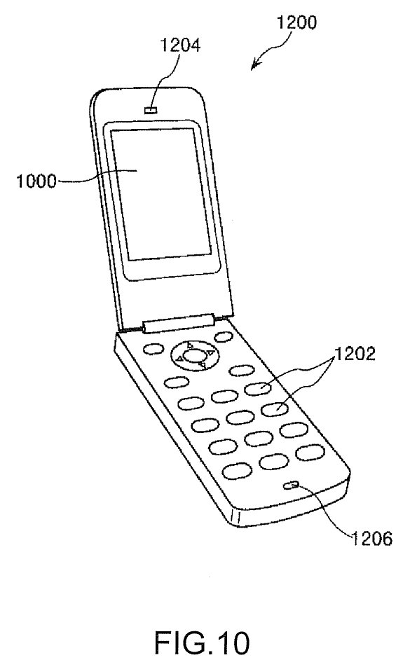

FIG. 10 is a perspective view showing a structure of a mobile phone (such as a PHS) applied as another example of the electronic apparatus according to the embodiment.

In the drawing, a mobile phone 1200 includes a plurality of touch buttons 1202, a speaker aperture 1204, a microphone aperture 1206, and the image display 1000 in a display section.

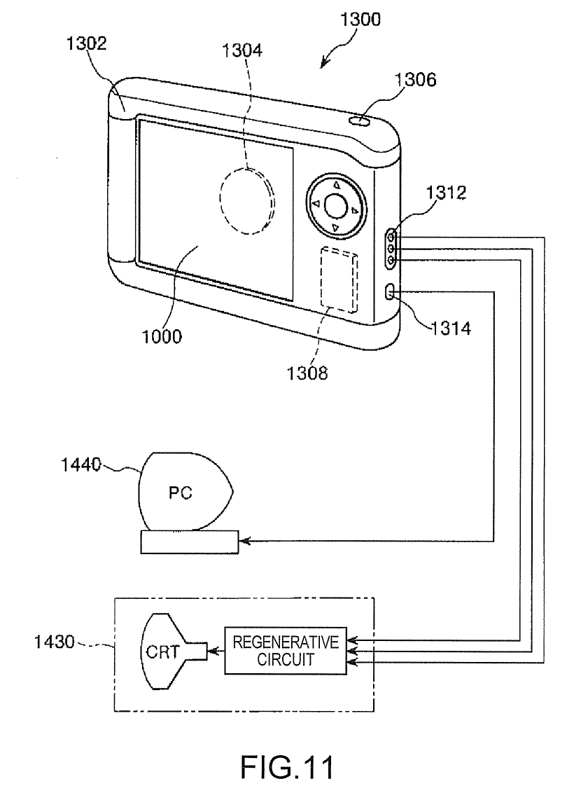

FIG. 11 is a perspective view showing a structure of a digital still camera applied as another example of the electronic apparatus according to the embodiment of the invention. The drawing also shows connections with external apparatuses in a simple manner.

In an ordinary camera, a silver halide film is exposed to light by using an optical image of a subject. However, a digital still camera 1300 generates an image-pickup signal (an image signal) by performing a photoelectric conversion of the optical image of a subject by using an image-pickup element such as a charge-coupled device (CCD).

On a rear surface of a casing (a body) 1302 in the digital still camera 1300, the image display 1000 is disposed in the display section to show images on a display screen based on image-pickup signals from the CCD, whereby the image display 1000 serves as a finder displaying an electronic image of the subject.

Inside the casing 1302 is provided a circuit board 1308. On the circuit board 1308 is provided a memory unit capable of storing (memorizing) image-pickup signals.

On a front surface of the casing 1302 (a back surface of the structure shown in the drawing) is provided a light-receiving unit 1304 including an optical lens (an image-pickup optical system) and the CCD.

A photo-taker checks the image of a subject displayed in the display section and then pushes down a shutter button 1306. Then, an image signal of the CCD at the point in time is transferred to and stored in the memory of the circuit board 1308.

In the digital still camera 1300, a video signal output terminal 1312 and an input-output terminal 1314 used for data communications are disposed on a side surface of the casing 1302. Then, as shown in the drawing, the video signal output terminal 1312 is connected to a television monitor 1430, and the input-output terminal 1314 for data communications is connected to a personal computer 1440, respectively, if needed. Furthermore, with a predetermined operation, the image-pickup signal stored in the memory of the circuit board 1308 is output to the television monitor 1430 or the personal computer 1440.

Furthermore, other than the personal computer (the mobile personal computer), the mobile phone, and the digital still camera described above, other various kinds of electronic apparatuses can be applied as the electronic apparatus according to the embodiment of the invention. Examples of the apparatuses include TV sets (e.g. LCD TVs), video cameras, view-finder type or monitor direct-view-type video tape recorders, laptop personal computers, car navigation devices, pagers, electronic organizers (with communication functions), electronic dictionaries, electronic calculators, electronic game devices, word processors, work stations, video phones, security television monitors, electronic binoculars, POS terminals, devices equipped with a touch panel (e.g. cash dispensers in banking facilities and automatic ticket vending machines), medical apparatuses (e.g. an electronic thermometer, an electronic manometer, a glucosemeter, an electrocardiographic apparatus, an ultrasonic diagnostic apparatus, and an endoscopic display), fish detectors, measuring equipments, gauging instruments (e.g. instruments of cars, airplanes, and ships), flight simulators, other kinds of monitors, and projection-type displays such as a projector. Particularly, recent TV display panels have become increasingly larger. When an electronic apparatus with a large display section (e.g. a display section having a diagonal-line length equal to or longer than 80 cm) employs a color filter formed with a conventional color filter ink, the unevennesses of color and density or the like particularly tend to occur. However, employing the color filter 1 of the embodiments can surely prevent such a problem. In short, using the color filter 1 of the embodiments in an electronic apparatus with a large display section as described above enables the advantageous effects of the embodiments to be more remarkably exhibited.

Hereinabove, the description has been given based on the preferable embodiments, but the invention is not restricted to the embodiments above.

For example, in the description of the above embodiment, after applying the color filter inks corresponding to the respective colors of the colored portions in the cells, the solvent (the liquid medium) is collectively removed from the respective colors of the color filter inks to cure the curable resin material. That is, it is described that the colored-portion forming step (the curing step) is performed only once. However, the ink-applying step and the colored-portion forming step may be repeatedly performed in accordance with the respective colors.

Additionally, respective sections included in the color filter, the image display, and the electronic apparatus may be replaced by arbitrary ones having the same functions, or may further include other structures. For example, in the color filter according to the embodiments of the invention, a protective film covering the colored portions may be provided on the surfaces of the colored portions at the side opposite to the surfaces of the portions facing the substrate. This can more effectively prevent problems such as damage to the colored portions and deterioration in the colored portions.

Additionally, the color filter ink according to the embodiments can be produced by any other method than the method described above. For example, although the method of the above embodiment includes the preliminary dispersion process and the multiple-stage micro-dispersion process, the color filter ink of the embodiment may be produced by a method excluding the preliminary dispersion process or a method including a single-stage micro-dispersion process. Furthermore, in the above embodiments, the thermoplastic resin is used in the preliminary dispersion process, but instead, for example, a curable resin material such as the above-described polymers A or B may be used in the preliminary dispersion process. Thereby, the color filter can contain a much more amount of the curable resin material, and thus can obtain especially improved durability.

### EXAMPLES

Next will be described examples of the embodiments.

1. Polymer Synthesis (Preparation of Polymer Solutions)

### Synthesis Example 1

A solvent (a solution): 37.6 pts.wt. of 1,3-butylene glycol diacetate was placed in a 1-L reaction container equipped with a stirrer, a reflux condenser, a dropping funnel, a nitrogen-gas-introducing tube, and a thermometer, and was heated at 90° C. Next, 2 pts.wt. of 2,2′-azobis(isobutylo-nitrile) (AIBN) and 3 pts.wt. of 1,3-butylene glycol diacetate (the solvent) were added into the flask. After that, a mixture solution including 27 pts.wt. of 3,4-epoxycyclohexyl)methyl methacrylate (trade name: Cyclomer M100 manufactured by Daicel Chemical Industries, Co., Ltd.), 1.5 pts.wt. of 2-(0-[1′methylpropylideneamino]carboxyamino)ethyl methacrylate (trade name: MOI-BM manufactured by Showa Denko Co., Ltd.), and 1.5 pts.wt of 2-hydroxyethyl methacrylate (HEMA) was dropped over approximately four hours using a dropping pump. Meanwhile, a polymerization initiator: 5 pts.wt of 2,2′-azobis(isobutylate)dimethyl (trade name: V-601 manufactured by Wako Pure Chemical Industries, Co., Ltd.) was dissolved into 20 pts.wt. of 1,3-butylene glycol diacetate (the solvent) to prepare a solution (a polymerization initiator solution). The polymerization initiator solution was dropped over approximately four hours using another dropping pump. After completion of the dropping of the polymerization initiator solution, 0.2 pts.wt of AIBN and 1 pts.wt of 1,3-butylene glycole diacetate (the solvent) were added and the mixture was maintained at approximately a same temperature for approximately two hours. Then, the mixture was cooled down to approximately a room temperature to obtain a polymer-A-containing polymer solution A1 with a solid component of 30 wt %.

### Synthesis Examples 2 to 10

The same operation as that in the synthesis example 1 was performed, excepting that kinds and amounts of monomer components used for polymer synthesis (preparation of polymer solutions) and kinds of solvents (solvent media) were made different as shown in Table 1. As a result, there were obtained nine kinds of polymer-A-containing polymer solutions (polymer solutions A2 to A10) each having a solid component of 30 wt %.

### Synthesis Example 11

The same operation as that in the synthesis example 1 was performed excepting that, instead of (3,4-epoxycyclohexyl)methyl(meth)acrylate (Cyclomer M100), 2-(0-[1′methylpropylideneamino]carboxyamino)ethyl methacrylate (MOI-BM), and 2-hydroxyethyl methacrylate (HEMA), 30 pts.wt. of γ-methacryloxypropyltrimethoxysilane (trade name: SZ6030 manufactured by Dow Corning Toray Co., Ltd.) was used. As a result, there was obtained a polymer-B-containing polymer solution B1 (a single polymer solution) having a solid component of 30 wt %.

### Synthesis Examples 12 to 16

The same operation as that in the synthesis example 11 was performed excepting that kinds and amounts of monomer components used for polymer synthesis (preparation of polymer solutions) and kinds of solvents (solvent medis) were made different as shown in Table 1. As a result, there were obtained five kinds of polymer-B-containing polymer solutions (polymer solutions B2 to B6).

### Synthesis Example 17

The same operation as that in the synthesis example 1 was performed excepting that, instead of (3,4-epoxycyclohexyl)methyl(meth)acrylate (Cyclomer M100), 2-(0-[1′methylpropylideneamino]carboxyamino)ethyl methacrylate (MOI-BM), and 2-hydroxyethyl methacrylate (HEMA), 30 pts.wt. of 1H, 1H, 5H-octafluoropentyl methacrylate (trade name: Viscoat 8FM manufactured by Osaka Organic Chemical Industry, Co., Ltd.) was used. As a result, there was obtained a polymer-C-containing polymer solution C1 (a single polymer solution).

### Synthesis Examples 18 and 19

The same operation as that in the synthesis example 17 was performed excepting that kinds and amounts of monomer components used for polymer synthesis (preparation of polymer solutions) and kinds of solvents (solvent media) were made different as shown in Table 1. As a result, there were obtained two kinds of polymer-C-containing polymer solutions (polymer solutions C2 and C3).

### Synthesis Example 20

The same operation as that in the synthesis example 1 was performed excepting that 13.5 pts.wt. of (3,4-epoxycyclohexyl)methyl (meth)acrylate (Cyclomer M100), 0.75 pts.wt. of 2-(0-[1′methylpropylideneamino]carboxyamino)ethyl methacrylate (MOI-BM), 0.75 pts.wt. of 2-hydroxyethyl methacrylate (HEMA), and 15 pts.wt. of γ-methacryloxypropyltrimethoxysilane (SZ6030) were used as monomer components. As a result, there was obtained a polymer-X-containing polymer solution X1 having a solid component of 30 wt %.

Table 1 collectively shows kinds and amounts of materials used for polymer synthesis (preparation of the polymer solutions) in the synthesis examples 1 to 20 (compositions of the polymers synthesized in the synthesis examples 1 to 20). In Table 1, “S” represents a solvent (a solvent medium). Particularly, “S1” represents 1,3-butylene glycol diacetate; “S2” represents bis(2-butoxyethyl)ether; “S3” represents diethylene glycol monobutyl ether acetate; “S4” represents triethylene glycol diacetate; “V-601” represents 2,2′-azobis(isobutylate)dimethyl; “AIBN” represents 2,2′-azobis(isobutylo-nitrile); “a1-1” represents (3,4-epoxycyclohexyl)methyl(meth)acrylate (Cyclomer M100); “a1-2” represents (3,4-epoxycyclohexyl)methyl acrylate; “a2-1” represents 2-(0-[1′methylpropylideneamino]carboxyamino)ethyl methacrylate (MOI-BM); “a2-2” represents 2-acryloyloxyethylisocyanate (Karenz MOI manufactured by Showa Denko Co., Ltd.); “a3-1” represents 2-hydroxyethyl methacrylate (HEMA); “a3-2” represents 4-hydroxybutyl acrylate; “a-4-1” represents 1H, 1H, 5H-octafluoropentyl methacrylate (Viscoat 8FM); “a4-2” represents 2-ethylhexyl methacrylate; “b1-1” represents γ-methacryloxypropyltrimethoxysilane (SZ6030); “b1-2” represents γ-methacryloxypropyltriethoxysilane; “b2-1” represents ethylmethacrylate; “c1-1” represents 1H, 1H, 5H-octafluoropentyl methacrylate (Viscoat 8FM); “c1-2” represents 1,2,3,4,5-pentafluorostylene; “c2-1” represents 2,3-dihydroxybutyl methacrylate; and “c2-2” represents cyclohexyl methacrylate. In addition, Table 1 also shows a weighted-average molecular weight (Mw) of each polymer included in the polymer solutions.

TABLE 1

| Polymer solution | | | A1 | A2 | A3 | A4 | A5 | A6 | A7 | A8 | A9 | A10 |
|---|---|---|---|---|---|---|---|---|---|---|---|---|
| Component (pts. | Monomer component | a1-1 | 27 | 27 | 27 | 24 | 19 | 20.5 | 25 | — | 26 | 26.5 |
| wt.) | | a1-2 | — | — | — | — | — | — | — | 27.5 | — | — |
| | | a2-1 | 1.5 | 3 | — | — | 5 | 3 | 1 | — | — | 2 |
| | | a2-2 | — | — | — | — | — | — | — | 1.5 | 1 | — |
| | | a3-1 | 1.5 | — | 3 | — | 4.5 | 5.5 | 2 | — | — | 1.5 |
| | | a3-2 | — | — | — | — | — | — | — | 1 | 1.5 | — |
| | | a4-1 | — | — | — | 6 | 1.5 | 1 | 2 | — | — | — |
| | | a4-2 | — | — | — | — | — | — | — | — | 1.5 | — |
| | | b1-1 | — | — | — | — | — | — | — | — | — | — |
| | | b1-2 | — | — | — | — | — | — | — | — | — | — |
| | | b2-1 | — | — | — | — | — | — | — | — | — | — |
| | | c1-1 | — | — | — | — | — | — | — | — | — | — |
| | | c1-2 | — | — | — | — | — | — | — | — | — | — |
| | | c2-1 | — | — | — | — | — | — | — | — | — | — |
| | | c2-2 | — | — | — | — | — | — | — | — | — | — |
| | S | | 62.6 | 62.6 | 62.6 | 62.6 | 62.6 | 62.6 | 62.6 | 62.6 | 62.6 | 62.6 |
| | V-601 | | 5 | 5 | 5 | 5 | 5 | 5 | 5 | 5 | 5 | 5 |
| | AIBN | | 2.4 | 2.4 | 2.4 | 2.4 | 2.4 | 2.4 | 2.4 | 2.4 | 2.4 | 2.4 |
| Composition of solvent | | | S1 | S1 | S3 | S1 | S2 | S3 | S2 | S4 | S2 | S4 |
| (S) | | | | | | | | | | | | |
| Mw of polymer | | | 2700 | 2800 | 2800 | 2800 | 2700 | 2700 | 2800 | 2800 | 2800 | 2800 |
| Polymer solution | | | B1 | B2 | B3 | B4 | B5 | B6 | C1 | C2 | C3 | X1 |
| Component (pts. | Monomer component | a1-1 | — | — | — | — | — | — | — | — | — | 13.5 |
| wt.) | | a1-2 | — | — | — | — | — | — | — | — | — | — |
| | | a2-1 | — | — | — | — | — | — | — | — | — | 0.75 |
| | | a2-2 | — | — | — | — | — | — | — | — | — | — |
| | | a3-1 | 1.5 | — | 3 | — | 4.5 | 5.5 | 2 | — | — | 0.75 |
| | | a3-2 | — | — | — | — | — | — | — | — | — | — |
| | | a4-1 | — | — | — | 6 | 1.5 | 1 | 2 | — | — | — |
| | | a4-2 | — | — | — | — | — | — | — | — | 1.5 | — |
| | | b1-1 | 30 | 26 | 23 | — | — | 30 | — | — | — | 15 |
| | | b1-2 | — | — | — | 30 | 28 | — | — | — | — | — |
| | | b2-1 | — | 4 | 7 | — | 2 | — | — | — | — | — |
| | | c1-1 | — | — | — | — | — | — | 30 | 4 | — | — |
| | | c1-2 | — | — | — | — | — | — | — | — | 28 | — |
| | | c2-1 | — | — | — | — | — | — | — | 26 | — | — |
| | | c2-2 | — | — | — | — | — | — | — | — | 2 | — |

| | | | | | | | | | | |
|---|---|---|---|---|---|---|---|---|---|---|
| S | 62.6 | 62.6 | 62.6 | 62.6 | 62.6 | 62.6 | 62.6 | 62.6 | 62.6 | 62.6 |
| V-601 | 5 | 5 | 5 | 5 | 5 | 5 | 5 | 5 | 5 | 5 |
| AIBN | 2.4 | 2.4 | 2.4 | 2.4 | 2.4 | 2.4 | 2.4 | 2.4 | 2.4 | 2.4 |

| | | | | | | | | | | |
|---|---|---|---|---|---|---|---|---|---|---|
| Composition of solvent | S1 | S3 | S4 | S1 | S3 | S4 | S1 | S3 | S2 | S1 |
| (S) | | | | | | | | | | |
| Mw of polymer | 2800 | 2700 | 2700 | 2800 | 2800 | 2800 | 2800 | 2800 | 2800 | 2700 |

2. Preparation of Color Filter Inks (Ink Set)

### Example 1

A dispersant: 12.96 g (36 pts.wt.) of Disperbyk 162, a dispersant: 4.32 g (12 pts.wt.) of Disperbyk 111, a thermoplastic resin: 28.43 g (79 pts.wt.) of SPCN-17X (manufactured by Showa High Polymer Co., Ltd.), and a solvent: 61.90 g (172 pts.wt.) of 1,3-butylene glycol diacetate were placed in a stirrer (a single-shaft mixer) of 400 cc capacity and stirred for 10 minutes by Disper Mill to perform preliminary dispersion. As a result, there was obtained a dispersant dispersion liquid (the preliminary dispersion process). In the process, the rotation rate of a stirring wing in the stirrer was set at 2000 rpm.

Next, the micro-dispersion process was performed in a manner as below, in which pigments were added to the dispersant dispersion liquid obtained in the preliminary dispersion process, and then, inorganic beads were added at multiple stages to perform micro-dispersion.

First, the pigments of 35.99 g (100 pts.wt.) were added to the obtained dispersant dispersion liquid and the mixture of the pigments and the liquid was stirred for 10 minutes at a rotation speed of 2000 rpm. As the pigments, there was used a mixture of 25.34 g of C.I. Pigment Green 58 (PG 58), 9.59 g of C.I. Pigment Yellow 150 (PG 150), and 1.07 g of power of the sulfonated pigment derivative having the chemical structure represented by above chemical formula 5. Additionally, the mixture of the dispersant dispersion liquid and the pigments was diluted with 1,3-butylene glycol diacetate as the solvent such that a content of the pigments in the mixture was 16 wt %.

Then, 720 g of inorganic beads (first inorganic beads made of zircona: Toray Ceram) having an average particle diameter of 0.8 mm were added to the mixture, and the mixture solution obtained was stirred at room temperature for 30 minutes to perform a first-stage dispersion processing (the first processing). In this case, the rotation rate of the stirring wing in the stirrer was 2000 rpm.

Next, the mixture solution was filtered by a filter (PAll HDCII Membrane Filter manufactured by PALL Co., Ltd.) to remove the inorganic beads (the first inorganic beads). After the removal of the first inorganic beads, 720 g of inorganic beads (second inorganic beads made of zirconia: Toray Ceram) having an average particle diameter 0.1 mm were added to the solution, and the mixture solution obtained was stirred for further 30 minutes to perform a second-stage dispersion processing (the second processing). The rotation rate of the stirring wing in the stirrer was set at 2000 rpm. Additionally, the solution was diluted with 1,3-butylene glycol diacetate as the dispersion medium such that a content of the pigments in a pigment dispersion to be obtained was 13 wt %.

After that, the inorganic beads (the second inorganic beads) were removed by filtration using the filter (PAll HDCII Membrane Filter) to obtain the pigment dispersion.

Next, the pigment dispersion obtained as above and the polymer solutions A1, B1, and C1 were mixed together. In the present process, the pigment dispersion and the polymer solutions A1, B1, and C1 were placed in a stirrer (a single-shaft mixer: Disper Mill) of 400 cc capacity to stir for 10 minutes using the stirrer. The rotation rate of the stirring wing in the stirrer was set at 2000 rpm. Thereby, there was obtained an intended green color filter ink (a G ink).

Then, there were prepared a red color filter ink (an R ink) and a blue color filter ink (a B ink) in the same manner as in the preparation of the green color filter ink, excepting that kinds of the pigments, amounts of the respective components used, and stirring conditions were different. Consequently, there was obtained an ink set including the three colors R, G, and B of the inks. An average particle diameter of the pigments in each of the R, G, and B inks was 70 nm.

### Examples 2 to 6

There were prepared color filter inks (an ink set) in the same manner as in Example 1, excepting that kinds and amounts of materials used for preparation of the color filter inks, and conditions for the micro-dispersion process (the first and the second processings) and the curable-resin mixing process were different as shown in Tables 2 and 5 below.

### Example 7

Color filter inks (an ink set) were prepared in the same manner as in Example 1, excepting following points: the kinds and the amounts of materials used for preparation of the color filter inks, and processing conditions for the micro-dispersion process (the first and the second processings) and the curable-resin mixing process were changed as shown in Tables 3 and 5 below; and, in the second processing of the micro-dispersion process, dilution was performed using 1,3-butylene glycol diacetate and triethylene glycol diacetate as diluting dispersion media. In the dilution, a content of the pigments of each ink to be produced in the dispersion medium of triethylene glycol diacetate was set to 12 wt %.

### Example 8

Color filter inks (an ink set) were prepared in the same manner as in Example 1, excepting following points: the kinds and the amounts of materials used for preparation of the color filter inks, and processing conditions for the micro-dispersion process (the first and the second processings) and the curable-resin mixing process were changed as shown in Tables 3 and 5 below; and, in the second processing of the micro-dispersion process, dilution was performed using 1,3-butylene glycol diacetate and 4-methyl-1,3-dioxolane-2-one as diluting dispersion media. In the dilution, a content of the pigments of each ink to be produced in the dispersion medium of 4-methyl-1,3-dioxolane-2-one was set to 12 wt %.

### Example 9

A dispersant: 12.96 g (36 pts.wt.) of Disperbyk 162, a dispersant: 4.32 g (12 pts.wt.) of Disperbyk 111, a thermoplastic resin: 28.43 g (79 pts.wt.) of SPCN-17X, and a solvent: 61.90 g (172 pts.wt.) of 1,3-butylene glycol diacetate were placed in a stirrer (a single-shaft mixer) of 400 cc capacity and stirred for 10 minutes by Disper Mill to perform preliminary dispersion so as to obtain a dispersant dispersion liquid (the preliminary dispersion process). In the process, the rotation rate of a stirring wing in the stirrer was set at 2000 rpm.

Next, in the manner described below, the micro-dispersion process was performed, where pigments were added to the dispersant dispersion liquid obtained in the preliminary dispersion process and inorganic beads were added at multiple stages to perform micro-dispersion.

First, 35.99 g (100 pts.wt.) of the pigments was added to the obtained dispersant dispersion liquid and the mixture was stirred for 10 minutes at the rotation rate of 2000 rpm by the stirrer. The pigments used were a mixture of 9.59 g of C.I. Pigment Yellow 150 (PG 150) and 1.07 g of the sulfonated pigment derivative powder having the chemical structure represented by chemical formula 5. Additionally, the mixture of the dispersant dispersion liquid and the pigments was diluted with 1,3-butylene glycol diacetate as a solvent such that a content of the pigments in the mixture of the dispersant dispersion liquid and the pigments was 16 wt %.

Next, 720 g of inorganic beads (first inorganic beads made of zirconia: Toray Ceram) having the average particle diameter of 0.8 mm were added and the mixture solution obtained was stirred at room temperature for 30 minutes to perform a first-stage dispersion processing (the first processing). The rotation rate of the stirring wing in the stirrer was 2000 rpm.

Then, the mixture solution was filtered by the filter (PAll HDCII Membrane Filter) to remove the inorganic beads (the first inorganic beads). Thereafter, 720 g of inorganic beads (second inorganic beads made of zirconia: Toray Ceram) having the average particle diameter of 0.1 mm were added to the solution, and the mixture solution obtained was stirred for further 30 minutes to perform a second-stage dispersion processing (the second processing). The rotation rate of the stirring wing in the stirrer was 2000 rpm. Additionally, the solution was diluted with 1,3-butylene glycol diacetate as the dispersion medium such that a content of the pigments in a pigment dispersion to be obtained was 13 wt %.

After that, the diluted solution was filtered by the filter (PAll HDCII Membrane Filter) to remove the inorganic beads (the second inorganic beads) so as to obtain the pigment dispersion.

Next, the pigment dispersion obtained as above and the polymer solutions A1, B1, and C1 were mixed together. In the present process, the pigment dispersion and the polymer solutions A1, B1, and C1 were placed in a stirrer (a single-shaft mixer: Disper Mill) of 400 cc capacity to stir the mixture solution for 10 minutes using the stirrer. The rotation rate of the stirring wing in the stirrer was 2000 rpm. Thereby, an intended yellow color filter ink (a Y ink) was obtained.

Additionally, there were prepared a red color filter ink (an R ink), a green color filter ink (a G ink), a blue color filter ink (a B ink), a cyan color filter ink (a C ink), and a magenta color filter ink (an M ink) in the same manner as in the preparation of the yellow color filter ink, excepting that the kinds of pigments, the amounts of components used, and stirring conditions were changed. As a result, there was obtained an ink set including six colors R, G, B, Y, C, and M of inks. An average pigment particle diameter of each of the R, G, Y, C, and M inks was 70 nm.

### Example 10

Color filter inks (an ink set) were prepared in the same manner as in Example 9 excepting that the kinds and the amounts of materials used for preparation of the color filter inks, and processing conditions for the micro-dispersion process (the first and the second processings) and the curable-resin mixing process were changed as shown in Tables 3 and 6.

### Comparative Examples 1 to 4

Color filter inks (an ink set) were prepared in the same manner as in Example 1 excepting that the kinds and the amounts of materials used for preparation of the color filter inks, and processing conditions for the micro-dispersion process (the first and the second processings) and the curable-resin mixing process were changed as shown in Tables 4 and 6.

Tables 2, 3, and 4 collectively show the compositions of dispersant dispersion liquids in Examples (Ex.) and Comparative examples (Cmp-Ex.), the kinds and the using amounts of pigments added in the dispersant dispersion liquids in the micro-dispersion process, the kinds of curable resin materials used in the curable-resin mixing process, and the amounts of the materials used as solid components. In those tables, “PG 36” represents C.I. Pigment Green 36; “PG 58” represents C.I. Pigment Green 58; “PR 177” represents C.I. Pigment Red 177; “PR 254” represents C.I. Pigment Red 254; “PB 15:6” represents C.I. Pigment Blue 15:6; “PV 23” represents C.I. Pigment Violet 23; “PB 15:3” represents C.I. Pigment Blue 15:3; “PR 122” represents C.I. Pigment Red 122; “PR 177D” represents a mixture of a powder that mainly contains C.I. Pigment Red 177 and a powder that contains the pigment derivative represented by chemical formula 8; “PR 254D” represents a mixture of a powder that mainly contains C.I. Pigment Red 254 and a powder that contains the pigment derivative represented by chemical formula 9; “SPD 1” represents a powder that contains the pigment derivative represented by above chemical formula 5; “SPD 2” represents a powder that contains a pigment derivative represented by below chemical formula 10; “DA 1” represents Disperbyk 162; “DA 2” represents Disperbyk 163; “DA 3” represents EFKA 4300; “DA 4” represents Disperbyk 111; and “DR 1” represents SPCN-17X. An amine value of Disperbyk 162 (DA 1) was 34 KOH mg/g; an amine value of Disperbyk 163 (DA 2) was 22 KOH mg/g; an amine value of EFKA 4300 (DA 3) was 70 KOH mg/g; and an acid value of Disperbyk 111 (DA 4) was 129 KOH mg/g. The acid values were obtained by a method in accordance with DIN EN ISO-2114, and the amine values were obtained by a method in accordance with DIN-16945. Additionally, in the tables, “AAR” represents a value expressed by an equation: AAR=(AV×X_{A})/(BV×X_{B}), where the acid value of an acid-value dispersant is AV [KOH mg/g;], the amine value of an amine-value dispersant is BV [KOH mg/g;], the content of the acid-value dispersant is X_{A} [wt %], and the content of the amine-value dispersant is X_{B} [wt %]. Furthermore, regarding the kinds of solvents (dispersion media) in the tables, there are shown various solvents (dispersion media) as in Table 1. Additionally, in the columns of the curable resin material in Tables 2, 3 and 4, A1 represents a polymer included in a polymer solution A1. Similarly, A2 to A9, B1 to B5, C1 to C3, and X1, respectively, represent polymers included in polymer solutions A2 to A9, B1 to B5, C1 to C3, and X1, respectively. Furthermore, Tables 5 and 6 collectively show conditions for producing the color filter inks in Examples and Comparative Examples, along with the contents of pigments upon completions of the respective first and the second processings and upon completion of the curable-resin mixing process (upon completion of production of the color filter inks as final products). Viscosities were measured using E-type viscometer (RE-01 manufactured by Toki Sangyo Co., Ltd.) based on JIS Z8809.

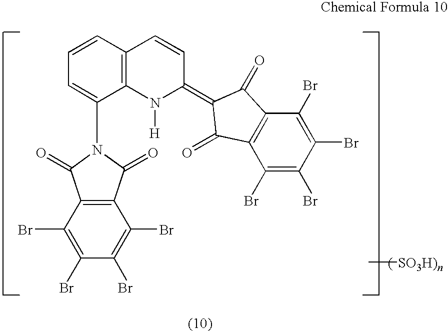

where n represents an integer of 1 to 5.

TABLE 2

| | | | | Ex1 | | | Ex2 | | | Ex3 | | |
|---|---|---|---|---|---|---|---|---|---|---|---|---|
| | | | | R | G | B | R | G | B | R | G | B |
| Composition of | Dispersant | Amine- | Kind | DA1 | DA1 | DA1 | DA1 | DA1 | DA1 | DA1 | DA1 | DA1 |
| dispersant | | value | Amount of | 69 | 36 | 42 | 54 | 68 | 42 | 54 | 68 | 42 |
| dispersion | | dispersant | use | | | | | | | | | |
| liquid | | | [pts. wt] | | | | | | | | | |
| | | | Amine value | 34 | 34 | 34 | 34 | 34 | 34 | 34 | 34 | 34 |
| | | | Bv | | | | | | | | | |
| | | | KOH mg/g | | | | | | | | | |
| | | Acid- | Kind | DA4 | DA4 | DA4 | DA4 | DA4 | DA4 | DA4 | DA4 | DA4 |
| | | value | Amount of | 23 | 12 | 14 | 18 | 22 | 14 | 19 | 23 | 15 |
| | | dispersant | use | | | | | | | | | |
| | | | [pts. wt] | | | | | | | | | |
| | | | Acid value | 129 | 129 | 129 | 129 | 129 | 129 | 129 | 129 | 129 |
| | | | Av | | | | | | | | | |
| | | | KOH mg/g | | | | | | | | | |
| | | AAR | | 1.26 | 1.26 | 1.26 | 1.26 | 1.23 | 1.26 | 1.33 | 1.28 | 1.36 |
| | Thermo- | Kind | | DR1 | DR1 | DR1 | DR1 | DR1 | DR1 | DR1 | DR1 | DR1 |
| | plastic resin | Amount of use | | 54 | 79 | 88 | 40 | 30 | 88 | 41 | 31 | 89 |
| | | [pts · wt] | | | | | | | | | | |
| | Solvent | Kind | | S1 | S1 | S1 | S2 | S2 | S2 | S3 | S3 | S3 |
| | | Amount of use | | 253 | 172 | 312 | 287 | 179 | 312 | 288 | 180 | 31/3 |
| | | [pts. wt] | | | | | | | | | | |
| Component added | Pigment | Kind | | PR177 | PG58 | PB15:6 | PR177D | PG58 | PB15:6 | PR177 | PG58 | PB15:6 |
| in | | | | PY150 | PY150 | PV23 | | PY150 | PV23 | PR254 | PY150 | PV23 |
| micro-dispersion | | | | SPD1 | SPD1 | | | SPD1 | | PY150 | SPD1 | |
| process | | | | | | | | | | SPD1 | | |
| | | Amount of use | | 72 | 70 | 98 | 100 | 70 | 98 | 36 | 70 | 98 |
| | | [pts. wt] | | 25 | 27 | 2 | | 26 | 2 | 36 | 23 | 2 |
| | | | | 3 | 3 | | | 4 | | 21 | 7 | |
| | | | | | | | | | | 7 | | |
| Component | Curable | Kind | | A1 | A1 | A1 | A7 | A7 | A7 | A6 | A6 | A6 |
| added in | resin | | | B1 | B1 | B1 | B6 | B6 | B6 | B2 | B2 | B2 |
| curable-resin | | | | C1 | C1 | C1 | C3 | C3 | C3 | C2 | C2 | C2 |
| mixing process | | Amount of use | | 13 | 9 | 18 | 23 | 22 | 22 | 22 | 21 | 21 |
| | | [pts. wt] | | 11 | 7 | 16 | 11 | 11 | 11 | 10 | 10 | 10 |
| | | | | 6 | 4 | 8 | 4 | 4 | 3 | 3 | 3 | 2 |
| Viscosity of ink | | | | 9.1 | 10.1 | 8.7 | 7.4 | 9.8 | 9.1 | 10.7 | 9.4 | 9.3 |
| [mP · s] | | | | | | | | | | | | |
| | | | | Ex4 | | | Ex5 | | | Ex6 | | |
| | | | | R | G | B | R | G | B | R | G | B |
| Composition of | Dispersant | Amine- | Kind | DA1 | DA2 | DA1 | DA1 | DA1 | DA1 | DA1 | — | DA1 |
| dispersant | | value | Amount | 70 | 50 | 41 | 53 | 27 | 45 | 51 | — | 43 |
| dispersion | | dispersant | of use | | | | | | | | | |
| liquid | | | [pts. wt] | | | | | | | | | |
| | | | Amine | 34 | 22 | 34 | 34 | 34 | 34 | 34 | — | 34 |
| | | | value Bv | | | | | | | | | |
| | | | KOH | | | | | | | | | |
| | | | mg/g | | | | | | | | | |
| | | Acid- | Kind | DA4 | — | DA4 | DA4 | DA4 | DA4 | DA4 | DA4 | DA4 |
| | | value | Amount | 22 | — | 15 | 19 | — | 17 | 21 | 42 | 13 |
| | | dispersant | of use | | | | | | | | | |
| | | | [pts. wt] | | | | | | | | | |
| | | | Acid | 129 | — | 129 | 129 | — | 129 | 129 | 129 | 129 |
| | | | value Av | | | | | | | | | |
| | | | KOH | | | | | | | | | |
| | | | mg/g | | | | | | | | | |

| | | | | | | | | | | | |
|---|---|---|---|---|---|---|---|---|---|---|---|
| | | AAR | 1.19 | — | 1.39 | 1.36 | — | 1.43 | 1.56 | — | 1.15 |
| | Thermo- | Kind | DR1 | DR1 | DR1 | DR1 | DR1 | DR1 | DR1 | DR1 | DR1 |
| | plastic resin | Amount of use | 55 | 21 | 87 | 39 | 41 | 89 | 42 | 84 | 88 |
| | | [pts. wt] | | | | | | | | | |
| | Solvent | Kind | S4 | S4 | S4 | S1 | S1 | S1 | S3 | S3 | S3 |
| | | Amount of use | 252 | 228 | 313 | 288 | 231 | 311 | 285 | 173 | 312 |
| | | [pts. wt] | | | | | | | | | |
| Component added | Pigment | Kind | PR177D | PG58 | PB15:6 | PR177D | PG58 | PB15:6 | PR177 | PG36 | PB15:6 |
| in micro- | | | PR254D | PY150 | PV23 | | PY150 | PV23 | | PY150 | PV23 |
| dispersion process | | | | SPD2 | | | SPD1 | | | SPD1 | |
| | | Amount of use | 50 | 90 | 98 | 100 | 70 | 96 | 100 | 70 | 97.5 |
| | | [pts. wt] | 50 | 10 | 2 | | 26 | 4 | | 29 | 2.5 |
| | | | | | | | 4 | | | 1 | |
| Component | Curable | Kind | A8 | A8 | A8 | A2 | A2 | A2 | A3 | A3 | A3 |
| add | resin | | A10 | A10 | A10 | B4 | B4 | B4 | B5 | B5 | B5 |
| | | | B3 | B3 | B3 | C1 | C1 | C1 | C2 | C2 | C2 |
| | | Amount of use | 10 | 16 | 13 | 20 | 17 | 21 | 16 | 6 | 14 |
| | | [pts. wt] | 10 | 16 | 12 | 8 | 7 | 8 | 12 | 4 | 11 |
| | | | 12 | 20 | 15 | 11 | 11 | 13 | 12 | 4 | 11 |

| | | | | | | | | | |
|---|---|---|---|---|---|---|---|---|---|
| Viscosity of ink | 10.1 | 10.4 | 9.5 | 7.5 | 10.4 | 9.1 | 7.4 | 10.1 | 9.9 |
| [mP · s] | | | | | | | | | |

TABLE 3

| | | | | Ex7 | | | Ex8 | | | Ex9 | | |
|---|---|---|---|---|---|---|---|---|---|---|---|---|
| | | | | R | G | B | R | G | B | R | G | B |
| Composition of | Dispersant | Amine- | Kind | DA1 | DA1 | DA1 | DA1 | DA1 | DA1 | DA1 | DA1 | DA1 |
| dispersant | | value | Amount of | 69 | 36 | 42 | 54 | 68 | 42 | 69 | 36 | 42 |
| dispersion | | dispersant | use | | | | | | | | | |
| liquid | | | [pts. wt] | | | | | | | | | |
| | | | Amine | 34 | 34 | 34 | 34 | 34 | 34 | 34 | 34 | 34 |
| | | | value Bv | | | | | | | | | |
| | | | KOH mg/g | | | | | | | | | |
| | | Acid- | Kind | DA4 | DA4 | DA4 | DA4 | DA4 | DA4 | DA4 | DA4 | DA4 |
| | | value | Amount of | 23 | 12 | 14 | 18 | 22 | 14 | 23 | 12 | 14 |
| | | dispersant | use | | | | | | | | | |
| | | | [pts. wt] | | | | | | | | | |
| | | | Acid value | 129 | 129 | 129 | 129 | 129 | 129 | 129 | 129 | 129 |
| | | | Av | | | | | | | | | |
| | | | KOH mg/g | | | | | | | | | |
| | | AAR | | 1.26 | 1.26 | 1.26 | 1.26 | 1.23 | 1.26 | 1.26 | 1.26 | 1.26 |
| | Thermo- | Kind | | DR1 | DR1 | DR1 | DR1 | DR1 | DR1 | DR1 | DR1 | DR1 |
| | plastic resin | Amount of use | | 54 | 79 | 88 | 40 | 30 | 88 | 54 | 79 | 88 |
| | | [pts. wt] | | | | | | | | | | |
| | Solvent | Kind | | S1 | S1 | S1 | S2 | S2 | 52 | S1 | S1 | S1 |
| | | Amount of use | | 253 | 172 | 312 | 287 | 179 | 312 | 253 | 172 | 312 |
| | | [pts. wt] | | | | | | | | | | |
| Component added | Pigment | Kind | | PR177 | PG58 | PB15:6 | PR177D | PG58 | PB15:6 | PR177D | PG58 | PB15:6 |
| in micro- | | | | PY150 | PY150 | PV23 | | PY150 | PV23 | PR254D | SPD1 | PV23 |
| dispersion process | | | | SPD1 | SPD1 | | | SPD1 | | | | |
| | | Amount of use | | 72 | 70 | 98 | 100 | 70 | 97 | 50 | 90 | 97 |
| | | [pts. wt] | | 25 | 27 | 2 | | 26 | 3 | 50 | 10 | 3 |
| | | | | 3 | 3 | | | 4 | | | | |
| Component | Curable | Kind | | A1 | A1 | A1 | A7 | A7 | A7 | A1 | A1 | A1 |
| added in | resin | | | B1 | B1 | B1 | B6 | B6 | B6 | B1 | B1 | B1 |
| curable-resin | | | | C1 | C1 | C1 | C3 | C3 | C3 | C1 | C1 | C1 |
| mixing process | | Amount of use | | 13 | 9 | 18 | 23 | 22 | 23 | 13 | 9 | 18 |
| | | [pts. wt] | | 11 | 7 | 16 | 11 | 11 | 11 | 11 | 7 | 16 |
| | | | | 6 | 4 | 8 | 4 | 4 | 3 | 6 | 4 | 8 |
| Viscosity of ink | | | | 9.4 | 8.9 | 8.4 | 7.5 | 9.9 | 7.4 | 10.1 | 9.1 | 9.6 |
| [mP · s] | | | | | | | | | | | | |
| | | | | Ex9 | | | Ex10 | | | | | |
| | | | | Y | C | M | R | G | B | Y | C | M |
| Composition of | Dispersant | Amine- | Kind | DA1 | DA1 | DA1 | DA1 | DA3 | DA1 | DA1 | DA1 | DA1 |
| dispersant | | value | Amount of | 36 | 42 | 69 | 72 | 42 | 43 | 36 | 43 | 72 |
| dispersion | | dispersant | use | | | | | | | | | |
| liquid | | | [pts · wt] | | | | | | | | | |
| | | | Amine | 34 | 34 | 34 | 34 | 70 | 34 | 34 | 34 | 34 |
| | | | value Bv | | | | | | | | | |
| | | | KOH mg/g | | | | | | | | | |
| | | Acid- | Kind | DA4 | DA4 | DA4 | DA4 | DA4 | DA4 | DA4 | DA4 | DA4 |
| | | value | Amount of | 12 | 14 | 23 | 20 | 36 | 13 | 12 | 13 | 20 |
| | | dispersant | use | | | | | | | | | |
| | | | [pts · wt] | | | | | | | | | |
| | | | Acid value | 129 | 129 | 129 | 129 | 129 | 129 | 129 | 129 | 129 |
| | | | Av | | | | | | | | | |
| | | | KOH mg/g | | | | | | | | | |

| | | | | | | | | | | | |
|---|---|---|---|---|---|---|---|---|---|---|---|
| | | AAR | 1.26 | 1.26 | 1.26 | 1.05 | 1.58 | 1.15 | 1.26 | 1.15 | 1.05 |
| | Thermo- | Kind | DR1 | DR1 | DR1 | DR1 | DR1 | DR1 | DR1 | DR1 | DR1 |
| | plastic resin | Amount of use | 79 | 88 | 54 | 55 | 79 | 90 | 79 | 90 | 55 |
| | | [pts · wt] | | | | | | | | | |
| | Solvent | Kind | S1 | S1 | S1 | S1 | S1 | S1 | S1 | S1 | S1 |
| | | Amount of use | 172 | 312 | 253 | 252 | 172 | 310 | 172 | 310 | 252 |
| | | [pts · wt] | | | | | | | | | |
| Component added | Pigment | Kind | PY150 | PB15:3 | PR122 | PR177D | PG58 | PB15:6 | PY150 | PB15:3 | PB122 |
| in micro- | | | SPD1 | | | PR254D | SPD1 | PV23 | SPD1 | | |
| dispersion process | | Amount of use | 90 | 100 | 100 | 70 | 77 | 96 | 90 | 100 | 100 |
| | | [pts · wt] | 10 | | | 30 | 23 | 4 | 10 | | |
| Component added | Curable | Kind | A1 | A1 | A1 | A4 | A5 | A9 | A4 | A9 | A4 |
| in curable-resin | resin | | B1 | B1 | B1 | B1 | B6 | B6 | B1 | B6 | B1 |
| mixing process | | | C1 | C1 | C1 | | | | | | |
| | | Amount of use | 13 | 18 | 13 | 6 | 4 | 9 | 6 | 9 | 6 |
| | | [pts · wt] | 11 | 16 | 11 | 254 | 17 | 36 | 24 | 36 | 24 |
| | | | 6 | 8 | 6 | | | | | | |

| | | | | | | | | | |
|---|---|---|---|---|---|---|---|---|---|
| Viscosity of ink | 8.8 | 7.9 | 8.1 | 10.1 | 8.9 | 7.5 | 7.1 | 9.1 | 8.7 |
| [mP · s] | | | | | | | | | |

TABLE 4

| | | | | Cmp. Ex1 | | | Cmp. Ex2 | | | Cmp. Ex3 | | |
|---|---|---|---|---|---|---|---|---|---|---|---|---|
| | | | | R | G | B | R | G | B | R | G | B |
| Composition of | Dispersant | Amine- | Kind | DA1 | DA1 | DA1 | DA1 | DA1 | DA1 | DA1 | DA1 | DA1 |
| dispersant | | value | Amount of | 69 | 36 | 42 | 69 | 36 | 42 | 69 | 39 | 72 |
| dispersion liquid | | dispersant | use | | | | | | | | | |
| | | | [pts. wt] | | | | | | | | | |
| | | | Amine | 34 | 34 | 34 | 34 | 34 | 34 | 34 | 34 | 34 |
| | | | value Bv | | | | | | | | | |
| | | | KOH mg/g | | | | | | | | | |
| | | Acid-value | Kind | DA4 | DA4 | DA4 | DA4 | DA4 | DA4 | DA4 | DA4 | DA4 |
| | | dispersant | Amount of | 23 | 12 | 14 | 23 | 12 | 14 | 23 | 12 | 14 |
| | | | use | | | | | | | | | |
| | | | [pts. wt] | | | | | | | | | |
| | | | Acid value | 129 | 129 | 129 | 129 | 129 | 129 | 129 | 129 | 129 |
| | | | Av | | | | | | | | | |
| | | | KOH mg/g | | | | | | | | | |

| | | | | | | | | | | | |
|---|---|---|---|---|---|---|---|---|---|---|---|
| | | AAR | 1.26 | 1.26 | 1.26 | 1.26 | 1.26 | 1.26 | 1.26 | 1.26 | 0.74 |
| | Thermo- | Kind | DR1 | DR1 | DR1 | DR1 | DR1 | DR1 | DR1 | DR1 | DR1 |
| | plastic | Amount of use | 54 | 79 | 88 | 54 | 79 | 88 | 54 | 79 | 88 |
| | resin | [pts. wt] | | | | | | | | | |
| | Solvent | Kind | S1 | S1 | S1 | S1 | S1 | S1 | S1 | S1 | S1 |
| | | Amount of use | 253 | 172 | 312 | 253 | 172 | 312 | 253 | 172 | 312 |
| | | [pts. wt] | | | | | | | | | |
| Component added | Pigment | Kind | PR177D | PG58 | PB15:6 | PR177D | PG38 | PB15:6 | PR177D | PG36 | PB15:6 |
| in micro-dispersion | | | PR254D | PY150 | PV23 | PR254D | SPD1 | PV23 | PR254D | | PV23 |
| process | | Amount of use | 50 | 90 | 98 | 50 | 90 | 99 | 50 | 100 | 97 |
| | | [pts. wt] | 50 | 10 | 2 | 50 | 10 | 1 | 50 | | 3 |
| Component | Curable | Kind | A1 | A1 | A1 | A1 | A1 | A1 | A1 | A1 | A1 |
| added in | resin | | B1 | B1 | B1 | B1 | B1 | B1 | B1 | B1 | B1 |
| curable-resin | | | C1 | C1 | C1 | C1 | C1 | C1 | C1 | C1 | C1 |
| mixing process | | Amount of use | 13 | 9 | 18 | 13 | 9 | 18 | 13 | 9 | 18 |
| | | [pts. wt] | 11 | 7 | 16 | 11 | 7 | 16 | 11 | 7 | 16 |
| | | | 6 | 4 | 8 | 6 | 4 | 8 | 6 | 4 | 8 |

| | | | | | | | | | |
|---|---|---|---|---|---|---|---|---|---|
| Viscosity of ink | 10.1 | 10.7 | 10.5 | 9.9 | 11.1 | 9.8 | 8.5 | 9.6 | 9.5 |
| [mP · s] | | | | | | | | | |

TABLE 5

| | | | | Ex 1 | | | Ex 2 | | | Ex 3 | | |
|---|---|---|---|---|---|---|---|---|---|---|---|---|
| | | | | R | G | B | R | G | B | R | G | B |
| Preliminary | Processing time [min] | | | 10 | 10 | 7 | 15 | 5 | 6 | 13 | 7 | 7 |
| dispersion | Rotation rate [rpm] | | | 2000 | 2000 | 1800 | 1200 | 2000 | 1900 | 1500 | 2000 | 1800 |
| process | | | | | | | | | | | | |
| Micro-dispersion process | First | First | Average | 0.8 | 0.8 | 0.8 | 0.6 | 0.7 | 0.8 | 0.6 | 0.7 | 0.8 |
| | processing | inorganic | particle | | | | | | | | | |
| | | beads | diameter | | | | | | | | | |
| | | | [mm] | | | | | | | | | |
| | | | Amounts | 500 | 500 | 500 | 300 | 450 | 55-0 | 400 | 450 | 500 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |
| | | Processing time | | 30 | 30 | 30 | 20 | 25 | 25 | 20 | 30 | 25 |
| | | [min] | | | | | | | | | | |
| | | Rotation rate | | 2000 | 2000 | 2000 | 2500 | 1900 | 2300 | 2500 | 2000 | 2300 |
| | | [rpm] | | | | | | | | | | |
| | | Pigment content | | 16 | 16 | 2 | 17 | 17 | 14 | 17 | 17 | 14 |
| | | [wt %] | | | | | | | | | | |
| | Second | Second | Average | 0.1 | 0.1 | 0.1 | 0.07 | 0.2 | 0.1 | 0.07 | 0.2 | 0.1 |
| | processing | inorganic | particle | | | | | | | | | |
| | | beads | diameter | | | | | | | | | |
| | | | [mm] | | | | | | | | | |
| | | | Amounts | 500 | 500 | 500 | 350 | 500 | 550 | 350 | 550 | 550 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |
| | | Processing time | | 30 | 30 | 30 | 20 | 25 | 30 | 20 | 25 | 30 |
| | | [min] | | | | | | | | | | |
| | | Rotation rate | | 2000 | 2000 | 2000 | 3000 | 2200 | 1900 | 2700 | 2200 | 2400 |
| | | [rpm] | | | | | | | | | | |
| | | Pigment content | | 13 | 13 | 8 | 13 | 13 | 12 | 13 | 13 | 12 |
| | | [wt %] | | | | | | | | | | |
| Curable-resin | Processing time | | | 20 | 20 | 30 | 40 | 45 | 35 | 40 | 45 | 35 |
| mixing process | [min] | | | | | | | | | | | |
| | Rotation rate | | | 1500 | 1500 | 1800 | 3000 | 3500 | 2800 | 3000 | 3500 | 2800 |
| | [rpm] | | | | | | | | | | | |
| | Pigment content | | | 7.3 | 10.1 | 4.9 | 7.1 | 9.8 | 4.8 | 7.1 | 9.8 | 4.8 |
| | [wt %] | | | | | | | | | | | |
| | | | | Ex 4 | | | Ex 5 | | | Ex 6 | | |
| | | | | R | G | B | R | G | B | R | G | B |
| Preliminary | Processing time [min] | | | 3 | 2 | 3 | 25 | 30 | 25 | 7 | 10 | 5 |
| dispersion | Rotation rate [rpm] | | | 4000 | 4100 | 3800 | 2200 | 2400 | 2400 | 2700 | 2500 | 2800 |
| process | | | | | | | | | | | | |
| Micro-dispersion process | First | First | Average | 1.3 | 1.4 | 1.2 | 1.1 | 1.1 | 1.1 | 0.5 | 0.4 | 0.5 |
| | processing | inorganic | particle | | | | | | | | | |
| | | beads | diameter | | | | | | | | | |
| | | | [mm] | | | | | | | | | |
| | | | Amounts | 480 | 500 | 460 | 350 | 350 | 300 | 400 | 350 | 400 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |
| | | Processing time | | 60 | 70 | 60 | 15 | 12 | 15 | 35 | 40 | 40 |
| | | [min] | | | | | | | | | | |
| | | Rotation rate | | 4000 | 4200 | 4000 | 1600 | 1700 | 1700 | 1900 | 1700 | 1600 |
| | | [rpm] | | | | | | | | | | |
| | | Pigment content | | 15 | 18 | 12 | 15 | 17 | 13 | 15 | 16 | 14 |
| | | [wt %] | | | | | | | | | | |
| | Second | Second | Average | 0.1 | 0.1 | 0.1 | 0.1 | 0.1 | 0.1 | 0.07 | 0.05 | 0.1 |
| | processing | inorganic | particle | | | | | | | | | |
| | | beads | diameter | | | | | | | | | |
| | | | [mm] | | | | | | | | | |
| | | | Amounts | 220 | 170 | 250 | 450 | 450 | 500 | 500 | 450 | 500 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |

| | | | | | | | | | |
|---|---|---|---|---|---|---|---|---|---|
| Processing time | 35 | 45 | 35 | 40 | 40 | 35 | 30 | 30 | 25 |
| [min] | | | | | | | | | |
| Rotation rate | 3500 | 4000 | 3300 | 2500 | 2700 | 2600 | 2400 | 2500 | 2700 |
| [rpm] | | | | | | | | | |
| Pigment content | 13 | 16 | 10 | 14 | 15 | 12 | 14 | 15 | 10 |
| [wt %] | | | | | | | | | |

| | | | | | | | | | | |
|---|---|---|---|---|---|---|---|---|---|---|
| Curable-resin | Processing time | 20 | 20 | 25 | 25 | 25 | 25 | 25 | 25 | 20 |
| mixing process | [min] | | | | | | | | | |
| | Rotation rate | 1800 | 2100 | 1600 | 1800 | 1800 | 1800 | 2800 | 3000 | 2800 |
| | [rpm] | | | | | | | | | |
| | Pigment content | 7.3 | 10.1 | 4.9 | 7.3 | 10.1 | 4.9 | 7.3 | 10.1 | 4.9 |
| | [wt %] | | | | | | | | | |

| | | | | Ex 7 | | | Ex 8 | | |
|---|---|---|---|---|---|---|---|---|---|
| | | | | R | G | B | R | G | B |
| preliminary | Processing time [min] | | | 10 | 10 | 7 | 15 | 5 | 6 |
| dispersion | Rotation rate [rpm] | | | 2000 | 2000 | 1800 | 1200 | 2000 | 1900 |
| process | | | | | | | | | |
| Micro-dispersion process | First processing | First | Average particle diameter [mm] | 0.8 | 0.8 | 0.8 | 0.6 | 0.7 | 0.8 |
| | | inorganic | Amounts of use per 100 pts. wt. | 500 | 500 | 500 | 300 | 450 | 550 |
| | | beads | of dispersant dispersion liquid | | | | | | |
| | | | [pts. wt.] | | | | | | |
| | | Processing time | | 30 | 30 | 30 | 20 | 25 | 25 |
| | | [min] | | | | | | | |
| | | Rotation rate | | 2000 | 2000 | 2000 | 2500 | 1900 | 2300 |
| | | [rpm] | | | | | | | |
| | | Pigment content | | 16 | 16 | 12 | 17 | 17 | 14 |
| | | [wt %] | | | | | | | |
| | Second processing | Second | Average particle diameter [mm] | 0.1 | 0.1 | 0.1 | 0.07 | 0.2 | 0.1 |
| | | inorganic | Amounts of use per 100 pts. wt. | 500 | 500 | 500 | 350 | 500 | 550 |
| | | beads | of dispersant dispersion liquid | | | | | | |
| | | | [pts. wt.] | | | | | | |

| | | | | | | |
|---|---|---|---|---|---|---|
| Processing time | 30 | 30 | 30 | 20 | 25 | 30 |
| [min] | | | | | | |
| Rotation rate | 2000 | 2000 | 2000 | 3000 | 2200 | 1900 |
| [rpm] | | | | | | |
| Pigment content | 13 | 13 | 8 | 13 | 13 | 12 |
| [wt %] | | | | | | |

| | | | | | | | |
|---|---|---|---|---|---|---|---|
| Curable-resin | Processing time | 20 | 20 | 30 | 40 | 45 | 35 |
| mixing process | [min] | | | | | | |
| | Rotation rate | 1500 | 1500 | 1800 | 3000 | 3500 | 2800 |
| | [rpm] | | | | | | |
| | Pigment content | 7.3 | 10.1 | 4.9 | 7.1 | 9.8 | 4.8 |
| | [wt %] | | | | | | |

TABLE 6

| | | | | Ex 9 | | | | | | Ex 10 | | | | | |
|---|---|---|---|---|---|---|---|---|---|---|---|---|---|---|---|
| | | | | R | G | B | Y | C | M | R | G | B | Y | C | M |
| Pre- | Processing time [min] | | | 10 | 10 | 7 | 10 | 7 | 10 | 18 | 20 | 15 | 10 | 15 | 18 |
| liminary | Rotation rate [rpm] | | | 2000 | 2000 | 1800 | 2000 | 1800 | 2000 | 1400 | 1200 | 1300 | 2000 | 1300 | 1400 |
| disper- | | | | | | | | | | | | | | | |
| sion | | | | | | | | | | | | | | | |
| process | | | | | | | | | | | | | | | |
| Micro- | First | First | Average | 0.8 | 0.8 | 0.8 | 0.8 | 0.8 | 0.8 | 0.5 | 0.4 | 0.5 | 0.8 | 0.5 | 0.5 |
| disper- | proc- | inor- | particle | | | | | | | | | | | | |
| sion | ess- | ganic | diameter | | | | | | | | | | | | |
| process | ing | beads | [mm] | | | | | | | | | | | | |
| | | | Amounts | 500 | 500 | 500 | 500 | 500 | 500 | 250 | 250 | 250 | 500 | 250 | 250 |
| | | | of use per | | | | | | | | | | | | |
| | | | 100 | | | | | | | | | | | | |
| | | | pts. wt. | | | | | | | | | | | | |
| | | | of | | | | | | | | | | | | |
| | | | dispersant | | | | | | | | | | | | |
| | | | dispersion | | | | | | | | | | | | |
| | | | liquid | | | | | | | | | | | | |
| | | | [pts. wt.] | | | | | | | | | | | | |
| | | Processing time | | 30 | 30 | 30 | 30 | 30 | 30 | 50 | 70 | 50 | 30 | 50 | 50 |
| | | [min] | | | | | | | | | | | | | |
| | | Rotation rate | | 2000 | 2000 | 2000 | 2000 | 2000 | 2000 | 1800 | 1100 | 1600 | 2000 | 1600 | 1800 |
| | | [rpm] | | | | | | | | | | | | | |
| | | Pigment content | | 16 | 16 | 12 | 16 | 12 | 16 | 15 | 17 | 13 | 16 | 13 | 15 |
| | | [wt %] | | | | | | | | | | | | | |
| | Sec- | Sec- | Average | 0.1 | 0.1 | 0.1 | 0.1 | 0.1 | 0.1 | 0.1 | 0.1 | 0.1 | 0.1 | 0.1 | 0.1 |
| | ond | ond | particle | | | | | | | | | | | | |
| | proc- | inor- | diameter | | | | | | | | | | | | |
| | ess- | ganic | [mm] | | | | | | | | | | | | |
| | ing | beads | Amounts | 500 | 500 | 500 | 500 | 500 | 500 | 550 | 600 | 550 | 500 | 550 | 550 |
| | | | of use per | | | | | | | | | | | | |
| | | | 100 | | | | | | | | | | | | |
| | | | pts. wt. | | | | | | | | | | | | |
| | | | of | | | | | | | | | | | | |
| | | | dispersant | | | | | | | | | | | | |
| | | | dispersion | | | | | | | | | | | | |
| | | | liquid | | | | | | | | | | | | |
| | | | [pts. wt.] | | | | | | | | | | | | |

| | | | | | | | | | | | | |
|---|---|---|---|---|---|---|---|---|---|---|---|---|
| Processing time | 30 | 30 | 30 | 30 | 30 | 30 | 35 | 45 | 40 | 30 | 40 | 35 |
| [min] | | | | | | | | | | | | |
| Rotation rate | 2000 | 2000 | 2000 | 2000 | 2000 | 2000 | 2700 | 2500 | 2800 | 2000 | 2800 | 2700 |
| [rpm] | | | | | | | | | | | | |
| Pigment content | 13 | 13 | 8 | 13 | 8 | 13 | 13 | 15 | 10 | 13 | 10 | 13 |
| [wt %] | | | | | | | | | | | | |

| | | | | | | | | | | | | | |
|---|---|---|---|---|---|---|---|---|---|---|---|---|---|
| Cura- | Processing time | 20 | 20 | 30 | 20 | 30 | 20 | 20 | 20 | 25 | 20 | 25 | 20 |
| ble- | [min] | | | | | | | | | | | | |
| resin | Rotation rate | 1500 | 1500 | 1800 | 1500 | 1800 | 1500 | 2000 | 2300 | 2000 | 1500 | 2000 | 2000 |
| mixing | [rpm] | | | | | | | | | | | | |
| process | Pigment content | 7.3 | 10.1 | 4.9 | 10.1 | 4.9 | 7.3 | 7.3 | 10.1 | 4.9 | 10.1 | 4.9 | 7.3 |
| | [wt %] | | | | | | | | | | | | |

| | | | | Cmp. Ex 1 | | | Cmp. Ex 2 | | | Cmp. Ex 3 | | |
|---|---|---|---|---|---|---|---|---|---|---|---|---|
| | | | | R | G | B | R | G | B | R | G | B |
| Preliminary | Processing time [min] | | | 10 | 10 | 7 | 10 | 10 | 7 | 10 | 10 | 7 |
| dispersion | Rotation rate [rpm] | | | 2000 | 2000 | 1800 | 2000 | 2000 | 1800 | 2000 | 2000 | 1800 |
| process | | | | | | | | | | | | |
| Micro-dispersion | First processing | First | Average | 0.8 | 0.8 | 0.8 | 0.8 | 0.8 | 0.8 | 0.8 | 0.8 | 0.8 |
| process | | inorganic | particle | | | | | | | | | |
| | | beads | diameter | | | | | | | | | |
| | | | [mm] | | | | | | | | | |
| | | | Amounts | 500 | 500 | 500 | 500 | 500 | 500 | 500 | 500 | 500 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |
| | | Processing time | | 30 | 30 | 30 | 30 | 30 | 30 | 30 | 30 | 30 |
| | | [min] | | | | | | | | | | |
| | | Rotation rate | | 2000 | 2000 | 1800 | 2000 | 2000 | 2000 | 1800 | 2000 | 2000 |
| | | [rpm] | | | | | | | | | | |
| | | Pigment content | | 16 | 16 | 12 | 16 | 16 | 12 | 16 | 16 | 12 |
| | | [wt %] | | | | | | | | | | |
| | Second | Second | Average | 0.1 | 0.1 | 0.1 | 0.1 | 0.1 | 0.1 | 0.1 | 0.1 | 0.1 |
| | processing | inorganic | particle | | | | | | | | | |
| | | beads | diameter | | | | | | | | | |
| | | | [mm] | | | | | | | | | |
| | | | Amounts | 500 | 500 | 500 | 500 | 500 | 500 | 500 | 500 | 500 |
| | | | of use per | | | | | | | | | |
| | | | 100 pts. wt. | | | | | | | | | |
| | | | of | | | | | | | | | |
| | | | dispersant | | | | | | | | | |
| | | | dispersion | | | | | | | | | |
| | | | liquid | | | | | | | | | |
| | | | [pts. wt.] | | | | | | | | | |

| | | | | | | | | | |
|---|---|---|---|---|---|---|---|---|---|
| Processing time | 30 | 30 | 30 | 30 | 30 | 30 | 30 | 30 | 30 |
| [min] | | | | | | | | | |
| Rotation rate | 2000 | 2000 | 2000 | 2000 | 2000 | 2000 | 2000 | 2000 | 2000 |
| [rpm] | | | | | | | | | |
| Pigment content | 13 | 13 | 8 | 13 | 13 | 8 | 13 | 13 | 8 |
| [wt %] | | | | | | | | | |

| | | | | | | | | | | |
|---|---|---|---|---|---|---|---|---|---|---|
| Curable-resin | Processing time | 20 | 20 | 30 | 20 | 20 | 30 | 20 | 20 | 30 |
| mixing process | [min] | | | | | | | | | |
| | Rotation rate | 1500 | 1500 | 1800 | 1500 | 1500 | 1800 | 1500 | 1500 | 1800 |
| | [rpm] | | | | | | | | | |
| | Pigment content | 7.3 | 10.1 | 4.9 | 7.3 | 10.1 | 4.9 | 7.3 | 10.1 | 4.9 |
| | [wt %] | | | | | | | | | |

3. Evaluation of Stability of Color Filter Ink (Durability Evaluation)

3-1. External Changes After Heating

Inks including the pigments, Pigment Yellow 150 and the SPD1 (or the SPD2) in Examples (hereinafter referred to as “evaluation ink”) and green (G) inks in Comparative Examples were allowed to stand at 60° C. for 10 days, and then visually observed to evaluate in accordance with following four criteria. Additionally, when a plurality of kinds (colors) of evaluation inks were included in each of Examples, there was used a result of an ink evaluated as the worst among them based on obtained evaluation results.

A: No change after heating is observed.

B: Aggregation and/or sedimentation of pigment particles is slightly observed.

C: Aggregation and/or sedimentation of pigment particles is clearly observed.

D: Aggregation and/or sedimentation of pigment particles is markedly observed.

3-2. Amount of Viscosity Change

The evaluation inks of Examples and the G inks of Comparative Examples were allowed to stand at 60° C. for 10 days, and then viscosities (kinetic viscosities) of the inks were measured to examine differences between viscosities after 10 days and viscosities immediately after produced. Specifically, values were obtained by an expression: ν₁−ν₀, where ν₀ (mPa·s) represented a viscosity immediately after production and ν₁ (mPa·s) represented a viscosity after left at 50° C. for 14 days. The values thus obtained were evaluated based on following five criteria. In a case of Example having a plurality of kinds (colors) of evaluation inks, there were used average values of evaluation results regarding the respective colors of the evaluation inks.

A: The value of ν₁−ν₀ is less than 0.2 mPa·s.

B: The value of ν₁−ν₀ is equal to or more than 0.2 mPa·s and less than 0.3 mPa·s.

C: The value of ν₁−ν₀ is equal to or more than 0.3 mPa·s and less than 0.5 mPa·s.

D: The value of ν₁−ν₀ is equal to or more than 0.5 mPa·s and less than 0.7 mPa·s.

E: The value of ν₁−ν₀ is equal to or more than 0.7 mPa·s.

4. Evaluation of Droplet Discharging Stability (Evaluation of Stable Dischageability)

Evaluation through following examinations was performed using the evaluation inks of Examples and the G inks of Comparative Examples, (which are color filter inks immediately after produced), as well as those inks after left at 60° C. for 10 days (color filter inks left under the heating environment).

4-1. Evaluation of Landing Position Precision

There were prepared a liquid droplet discharging apparatus, as shown in FIGS. 3 to 6, installed in a chamber (a thermal chamber) and the G inks of Examples and Comparative Examples. Then, in a condition in which driving waveforms of the piezo elements were optimized, at 25° C. and 55% RH, 100,000 shots (100,000 drops) of droplets of the respective inks were continuously discharged from each nozzle of a liquid droplet discharging head. Regarding 100,000 shots of droplets discharged from designated nozzles positioned near a center part of the discharging head, there were obtained average values of deviation amounts “d” in which center positions of respective droplets landed are deviated from targeted center positions. The obtained values were evaluated based on following four criteria. Additionally, when there were a plurality of kinds (colors) of evaluation inks in each Example, there were used average values of evaluation results obtained regarding respective colors of the evaluation inks.

A: The average value of the deviation amounts d is less than 0.05 μm.

B: The average value of the deviation amounts d is equal to or more than 0.05 μm and less than 0.10 μm.

C: The average value of the deviation amounts d is equal to or more than 0.10 μm and less than 0.15 μm.

D: The average value of the deviation amounts d is equal to or more than 0.15 μm.

4-2. Evaluation of Stability of Droplet Discharging Amount

There were prepared liquid droplet discharging apparatus, as shown in FIGS. 3 to 6, installed in the chamber (the thermal chamber) and the G inks in Examples and Comparative Examples. After optimizing the driving waveforms of the piezo elements, at 25° C. and 55% RH, 100,000 shots (100,000 drops) of droplets of the respective inks were continuously discharged from each nozzle of the liquid droplet discharging head. There was obtained a total weight of droplets discharged from two designated nozzles at right and left ends of the droplet discharging head. Additionally, there was obtained an absolute value ΔW (ng) as a difference between average amounts of the droplets discharged from the two nozzles. Next, a ratio of the absolute value ΔW with respect to a targeted droplet-discharging amount W_{T}[ng] (ΔW/W_{T}) was calculated to evaluate based on following four criteria. It is shown that as the value of ΔW/W_{T} is smaller, the amount of droplet discharging is more stable. Additionally, when there were a plurality of kinds (colors) of evaluation inks in each Example, there were used average values of evaluation results obtained regarding respective colors of the evaluation inks.

A: The value of ΔW/W_{T} is less than 0.023.

B: The value of Δ_{W}/W_{T} is equal to or more than 0.023 and less than 0.430.

C: The value of ΔW/W_{T} is equal to or more than 0.430 and less than 0.770.

D: The value of ΔW/W_{T} is equal to or more than 0.770.

4-3. Evaluation of Intermittent Printability

There were prepared the liquid droplet discharging apparatus, as shown in FIGS. 3 to 6, installed in the chamber (the thermal chamber) and the G inks in Examples and Comparative Examples: In the condition in which driving waveforms of the piezo elements were optimized, at 25° C. and 55% RH, 100,000 shots (100,000 drops) of droplets of the respective inks were continuously discharged from each nozzle of the liquid droplet discharging head. Thereafter, discharging of droplets was suspended for 30 seconds (a first sequence). Then, similarly, an operational sequence of continuous discharging and then suspension of discharging was repeated. Regarding droplets discharged from designated nozzles near the center part of the discharging head, there were calculated an average weight W₁ (ng) of droplets discharged during the first sequence and an average weight W₂₀ (ng) of droplets discharged during a 20th sequence. Thereby, a ratio of an absolute value of a difference between W₁ and W₂₀ with respect to a targeted droplet-discharging amount W_{T} (ng), namely, (|W₁-W₂₀|/W_{T}) was calculated to evaluate based on following four criteria. It was found that as the value of |W₁-W₂₀|/W_{T} is smaller, intermittent printability (stability in the droplet-discharging amount) is more excellent. Additionally, when there were a plurality of kinds (colors) of evaluation inks in each of Examples, there were used average values of evaluation results obtained regarding the respective colors of the evaluation inks.

A: The value of |W₁-W₂₀|/W_{T} is less than 0.027.

B: The value of |W₁-W₂₀|/W_{T} is equal to or more than 0.027 and less than 0.300.

C: The value of |W₁-W₂₀|/W_{T} is equal to or more than 0.027 and less than 0.300.

D: The value of |W₁-W₂₀|/W_{T} is equal to or more than 0.650.

4-4. Continuous Discharging Test

There were used the liquid droplet discharging apparatus, as shown in FIGS. 3 to 6, installed in the chamber (the thermal chamber) and the G inks in Examples and Comparative Examples. At 25° C. and 55% RH, the discharging apparatus was continuously operated for 36 hours to discharge the respective inks.

Then, an incidence rate of clogging in nozzles of the discharging head after the continuous operation was obtained by an expression: [(a number of clogging nozzles/(a number of all nozzles)]×100). Thereby, regarding nozzles causing clogging, it was examined whether the clogging could be eliminated by a cleaning member made of a plastic material. Examination results were evaluated based on following four criteria. Additionally, when a plurality of kinds (colors) of evaluation inks were included in each Example, there were used average values of evaluation results obtained regarding the respective colors of the evaluation inks.

A: No nozzle clogging is found.

B: The incidence rate of nozzle clogging is less than 0.6 (excluding 0), and clogging can be eliminated by cleaning.

C: The incidence rate of nozzle clogging is equal to or more than 0.6 and less than 1.2%, and clogging can be eliminated by cleaning.

D: The incidence rate of nozzle clogging is equal to or more than 1.2, or clogging cannot be eliminated by cleaning.

The above evaluation was performed regarding Examples and Comparative Examples under the same conditions.

5. Production of Color Filter

There were used the ink sets obtained in Examples and Comparative Examples (the color filter ink sets immediately after produced) and the ink sets after left at 60° C. for 10 days (the color filter ink sets left under the heating environment) to produce color filters in a manner as below.

First, a soda glass substrate (G5 size: 1100×1300 mm) was prepared. The substrate had a film of silica (SiO₂) formed on both main surfaces thereof to prevent elution of sodium ion. The substrate was subjected to washing treatment.

Next, a carbon-black-containing radiation-sensitive composite for forming a partition wall was applied entirely on one of the main surfaces of the washed substrate to form a coating film.

Then, a pre-baking treatment was performed at a heating temperature of 110° C. for a heating time of 120 seconds.

After that, a post-exposure baking (PEB) treatment was performed by irradiating radiation via a photo mask, followed by a developing treatment using an alkali developer. Furthermore, a post-baking treatment was performed to form the partition wall. In the PEB treatment, a heating temperature was 110° C., a heating time was 120 seconds, and a radiation intensity was 150 mJ/cm². The developing treatment was, for example, oscillation/immersion, and a developing time was 60 seconds. The post-baking treatment was performed at a heating temperature of 150° C. for a heating time of five minutes. The partition wall formed has a thickness of 2.1 μm. On each of substrates using color filter ink sets of Examples 7 and 8 including the six colors, a partition-wall pattern was formed differently from partition-wall patterns on substrates using color filter ink sets of the other Examples and Comparative Examples. A size of a cell as a region surrounded by the partition wall on the substrate in Examples 7 and 8 (a cell size in a two-dimensional view of the substrate) was made twice a cell size on the substrate using the color filter ink sets of the other Examples and Comparative Examples.

Next, using the liquid droplet discharging apparatus shown in FIGS. 3 to 6, the color filter inks were discharged in each cell as the region surrounded by the partition wall. In this case, three colors (or six colors) of color filter inks were used such that the respective colors of the color filter inks were not mixed with each other. A nozzle plate of each liquid droplet discharging head was bonded with an epoxy adhesive (AE-40 manufactured by Ajinomoto Finetechno Co., Ltd).

Thereafter, a 10-minute heating treatment was performed on a hot plate at 100° C., followed by a one-hour heating treatment in an oven at 200° C. to form the three or the six colors of colored portions on the substrate. Thereby, there were produced color filters as shown in FIG. 1 by using the color filter ink sets of Examples 1 to 6 and Comparative Examples. Additionally, color filters as shown in FIG. 7 were produced using the color filter ink sets of Examples 7 and 8.

In this manner, 8000 pieces of color filters were produced, respectively, using the color filter inks (the respective ink sets) of Examples and Comparative Examples.

6. Evaluation of Color Filters

Evaluation was made as follows using the color filters produced as above.

6-1. Unevennesses of Color and Density

Among the color filters produced using the color filter inks (the respective ink sets) of Examples and Comparative Examples, color filters as 8000th pieces were used to produce liquid crystal displays as shown in FIG. 8 under same conditions.

Using the liquid crystal displays, a red monochrome display and a white monochrome display were visually checked in a dark room to evaluate the unevennesses of color and density at respective portions based on following five criteria.

A: Neither color unevenness nor density unevenness is observed.

B: Almost neither color unevenness nor density unevenness is observed.

C: Color unevenness and/or density unevenness is slightly observed.

D: Color unevenness and/or density unevenness is clearly observed.

E: Color unevenness and/or density unevenness is markedly observed.

Characteristic Differences Among Individual Color Filters

Among the color filters produced by using the color filter inks (the respective ink sets) in Examples and Comparative Examples, respectively, there were prepared first to tenth color filters and 5980th to 5989th color filters. In each of those color filters prepared, 100 pixels were randomly extracted. With the extracted 100 pixels, a red monochrome display and a white monochrome display were presented in a dark room to measure chromaticity using a spectro-photometer (MCPD 3000 manufactured by Otsuka Electronics Co., Ltd.). An average value of chromaticities of the respective 100 pixels in each color filter was determined as a chromaticity of the each color filter. Based on the results, regarding each of Examples and Comparative Examples, there was obtained a maximum color difference (a color difference ΔE in a Lab calorimetric system) among the color filters as the first to the tenth products and the 5980th to 5989th products (namely 20 pieces of the color filters) to evaluate in accordance with following five criteria.

A: The color difference (ΔE) is less than 0.6.

B: The color difference (ΔE) is equal to or more than 0.6 and less than 1.3.

C: The color difference (ΔE) is equal to or more than 1.3 and less than 1.8.

D: The color difference (ΔE) is equal to or more than 1.8 and less than 2.3.

E: The color difference (ΔE) is equal to or more than 2.3.

6-3. Durability

Among the color filters produced by using the color filter inks (the respective ink sets) of Examples and Comparative Examples, color filters as 1991st to 2000th products were used to produce liquid crystal displays as shown in FIG. 8 under same conditions.

Using the liquid crystal displays, a red monochrome display and a white monochrome display were visually checked in a dark room to confirm that there was no light leakage (any white spot or bright spot).

Next, the color filters were detached from the liquid crystal displays.

The detached color filters were allowed to stand at 20° C. for 1.5 hours, at 60° C. for 2 hours, at 20° C. for 1.5 hours, and at −10° C. for 3 hours, then again, temperature was returned to 20° C. The sequence of steps was set as a single cycle (8 hours), which was repeated 20 times in total (160 hours in total).

Thereafter, using the color filters, again, the liquid crystal displays as shown in FIG. 8 were constituted.

Next, regarding the liquid crystal displays, a red monochrome display and a white monochrome display were visually checked in a dark room to evaluate an occurrence of light leakage (any white spot or bright spot) based on following five criteria.

A: There is no color filter causing light leakage (formation of any white spot and bright spot).

B: One or two color filters have light leakage (formation of any white spot and bright spot).

C: Three to five color filters have light leakage (formation of any white spot and bright spot).

D: Six to nine color filters have light leakage (formation of any white spot and bright spot).

E: 10 color filters have light leakage (formation of any white spot and bright spot).

7. Evaluation of Contrast

Evaluation through following examinations was performed using the evaluation inks of Examples and the G inks of Comparative Examples (color filter inks immediately after produced) and the evaluated inks and the G inks after left at 60° C. for 10 days (color filter inks left under the heating environment).

With the evaluated inks of Examples and the G inks of Comparative Examples, respective colors of color films were formed on glass plates each having a diameter of 10 cm by the inkjet method.

The color films were formed through a process in which after ink droplets were discharged on the glass plates, the plates were heated on a hot plate at 120° C. for 10 minutes, and furthermore heated in an oven at 260° C. for 0.5 hours. Amounts of the color filter inks discharged were adjusted such that a thickness of the color films to be formed was 1.5 μm.

Regarding the glass plates having the color films formed as above, contrast ratios (CR) were measured by a contrast tester (CT-1 manufactured by Tsubosaka Electric Co., Ltd.) to evaluate based on following five criteria. For Examples having a plurality of kinds (colors) of evaluation inks, there were used average values of evaluation results obtained regarding the respective colors of the evaluation inks.

A: CR is equal to or more than 11000.

B: CR is equal to or more than 9000 and less than 11000.

C: CR is equal to or more than 7500 and less than 9000.

D: CR is equal to or more than 5500 and less than 7500.

E: CR is less than 5500.

8. Evaluation of Color Reproduction Range

Using the color filter ink sets of the Examples and Comparative Examples, respectively, colored plates corresponding to respective color filter ink sets were produced in a manner as follows.

First, using an inkjet coating method, each color ink included in the color filter ink sets was applied on a glass plate with a thickness of 7 mm having a partition wall with a thickness of 2.1 μm having a size of 30×30 mm formed thereon. An amount of the ink applied was adjusted such that a post-baking thickness of the plate was 1.60 μm.

Next, the glass plate was heated on a hot plate at 100° C. for 10 minutes and then heated in an oven at 200° C. for an hour to obtain a colored plate having a color film with the thickness of 1.60 μm formed thereon.

Transmission spectra of the colored plates with the three or the six colors corresponding to the respective ink sets obtained as above were measured by the spectrophotometer (MCPD 3000) using a standard C light source. Thereby, chromaticities: R(x, y), G(x, y), and B(x, y) in an x-y chromaticity coordinate system were obtained to calculate NTSC ratios. The NTSC ratios were evaluated based on following five criteria. It is shown that as the NTSC ratio is higher, the color reproduction range is wider.

A: The NTSC ratio is equal to or more than 80%.

B: The NTSC ratio is equal to or more than 75% and less than 80%.

C: The NTSC ratio is equal to or more than 70% and less than 75%.

D: The NTSC ratio is less than 70%.

E: Due to light leakage or the like, there is a large variation among pixels, so that measurement is impossible.

In the above evaluations, regarding the respective color filters and the respective glass plates, observations and measurements were performed under same conditions.

Table 7 shows evaluation results. In the table, “pre-heat” and “post-heat”, respectively, indicate the color filter inks immediately after production and the color filter inks left at 60° C. for 10 days (the color filter inks left under the heating environment), respectively.

TABLE 7

| | | | Ex 1 | Ex 2 | Ex 3 | Ex 4 | Ex 5 | Ex 6 | Ex 7 | Ex 8 |
|---|---|---|---|---|---|---|---|---|---|---|
| External change after heating | | | A | A | A | A | A | A | A | A |
| Amounts of viscosity change | | | A | A | A | A | B | A | A | A |
| Evaluation of | Precision of | Pre-heat | A | A | A | A | B | A | A | A |
| stable | landing | Post- | A | A | A | A | B | A | A | A |
| dischargeability | position | heat | | | | | | | | |
| | Stability of | Pre-heat | A | A | A | A | A | A | A | A |
| | discharging | Post- | A | A | A | B | A | B | A | A |
| | amounts of | heat | | | | | | | | |
| | droplets | | | | | | | | | |
| | Intermittent | Pre-heat | A | A | A | A | A | A | A | A |
| | printability | Post- | A | A | A | B | A | A | A | A |
| | | heat | | | | | | | | |
| | Continuous | Pre-heat | A | A | A | A | B | A | A | A |
| | discharging | Post- | A | B | A | A | C | A | A | B |
| | test | heat | | | | | | | | |

| | | | | | | | | | |
|---|---|---|---|---|---|---|---|---|---|
| Unevenness of color and | Pre-heat | A | A | A | A | A | A | A | A |
| density | Post- | A | A | A | B | B | B | A | A |
| | heat | | | | | | | | |
| Characteristic difference | Pre-heat | A | A | A | A | A | A | A | A |
| between individual filters | Post- | A | A | A | A | A | A | A | A |
| | heat | | | | | | | | |
| Durability | Pre-heat | A | A | B | A | A | A | A | A |
| | Post- | A | B | B | A | A | A | A | B |
| | heat | | | | | | | | |
| Contrast | Pre-heat | A | A | A | A | B | A | A | A |
| | Post- | A | A | A | A | C | B | A | A |
| | heat | | | | | | | | |
| Color reproduction range | Pre-heat | A | A | B | A | A | B | A | A |
| | Post- | A | A | B | A | B | B | A | A |
| | heat | | | | | | | | |

| | | | Ex 9 | Ex 10 | Cmp. Ex 1 | Cmp. Ex 2 | Com. Ex 3 |
|---|---|---|---|---|---|---|---|
| External change after heating | | | A | A | D | A | B |
| Amounts of viscosity change | | | A | B | E | C | B |
| Evaluation of | Precision of | Pre-heat | A | A | D | B | B |
| stable | landing | Post-heat | A | B | D | C | B |
| dischargeability | position | | | | | | |
| | Stability of | Pre-heat | A | A | C | B | B |
| | discharging | Post-heat | A | A | C | B | B |
| | amounts of | | | | | | |
| | droplets | | | | | | |
| | Intermittent | Pre-heat | A | A | C | B | B |
| | printability | Post-heat | A | B | C | B | B |
| | Continuous | Pre-heat | A | A | C | B | B |
| | discharging | Post-heat | A | A | D | B | B |
| | test | | | | | | |

| | | | | | | |
|---|---|---|---|---|---|---|
| Unevenness of color and | Pre-heat | A | A | D | C | B |
| density | Post-heat | A | B | E | D | B |
| Characteristic difference | Pre-heat | A | A | E | C | B |
| between individual filters | Post-heat | A | A | E | D | B |
| Durability | Pre-heat | A | A | C | B | B |
| | Post-heat | A | A | E | D | B |
| Contrast | Pre-heat | A | A | D | A | B |
| | Post-heat | A | A | E | C | B |
| Color reproduction range | Pre-heat | A | A | B | E | D |
| | Post-heat | A | A | C | E | D |

As shown in Table 7, in the embodiment, an excellent droplet discharging stability is exhibited; the produced color filters suppress color mixing, unevennesses of color and density, and light leakage; and characteristic variations among individual filters are small. Additionally, in the embodiment, the color filters provide excellent durability, high contrast, and a wide color reproduction range. Furthermore, the color filter inks of the embodiment have stability over time, so that droplets of the inks can be suitably discharged even after the inks are allowed to stand under heating conditions, thus enabling an excellent-quality color filter to be stably produced. Meanwhile, results of Comparative Examples were unsatisfactory.

Furthermore, in the color filters produced by using the color filter inks of Examples 7 and 8, colored portions had an especially uniform thickness and smoothness as compared to those produced in the other Examples. As a result, among all the color filters of Examples, the color filters produced with the inks of Examples 7 and 8 enabled the unevennesses of color and density in the colored portions to be greatly suppressed.

In addition, a commercially-available LCD television set was disassembled to replace a LCD thereof by an LCD produced as above, and the same evaluation was performed in the same manner. Then, there was obtained the same results as above.

1. A color filter ink used to produce a color filter by using an inkjet method, the color filter ink comprising:
C.I. pigment yellow 150; and
a sulfonated pigment derivative represented by following chemical formula 1: 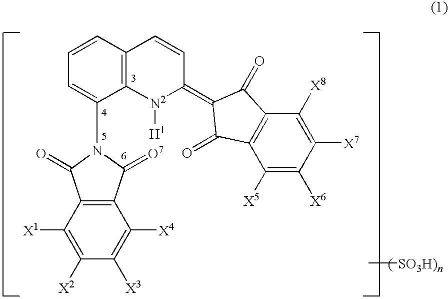
wherein n represents an integer of 1 to 5, and X¹ to X⁸ each independently represent a hydrogen atom or a halogen atom.

2. The color filter ink according to claim 1, wherein an inequality expressed by 0.005≦X_{PD}/X_{PY150}≦0.32 is satisfied, where X_{PD} (wt %) represents a content of the pigment derivative in the color filter ink and X_{PY150} (wt %) represents a content of the C. I. pigment yellow 150 in the color filter ink.

3. The color filter ink according to claim 1, further including an acid-value dispersant having a predetermined acid value and an amine-value dispersant having a predetermined amine value.

4. The color filter ink according to claim 3, wherein an inequality expressed by 0.01≦(AV×X_{A})/(BV×X_{B})≦1.9 is satisfied, where AV (KOH mg/g) represents the acid value of the acid-value dispersant; BV (KOH mg/g) represents the amine value of the amine-value dispersant; X_{A} (wt %) represents a content of the acid-value dispersant; and X_{B} (wt %) represents a content of the amine-value dispersant.

5. The color filter ink according to claim 1 further including a curable resin material, the curable resin material including a polymer A that contains at least an epoxy-group-containing vinyl monomer a1 as a monomer component.

6. The color filter ink according to claim 5, wherein the polymer A is a copolymer that includes, in addition to the epoxy-group-containing vinyl monomer a1, a vinyl monomer a2 as another monomer component, the vinyl monomer a2 having an isocyanate group or an isocyanate group blocked with a protective group.

7. The color filter ink according to claim 5, wherein the curable resin material includes a polymer B that includes at least an alkoxyl-group-containing vinyl monomer as a monomer component, the alkoxyl-group-containing vinyl monomer being represented by following chemical formula 2: 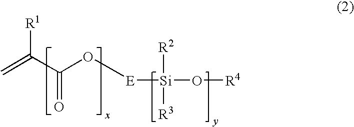
wherein R¹ represents a hydrogen atom or an alkyl group having a carbon number of 1 to 7; E represents a single bond or a divalent hydrocarbon radical; R² and R³ represent alkyl or alkoxyl groups having a same or different carbon number in a range of 1 to 6; R⁴ represents an alkyl group having a carbon number of 1 to 6; x represents 0 or 1; and y represents an integer of 1 to 10.

8. A color filter ink set including a plurality of different colors of color filter inks, at least one of the color filter inks being the color filter ink according to claim 1.

9. The color filter ink set according to claim 8, wherein the different colors of the color filter inks include red, green, and blue inks, at least one of the red ink and the green ink being the at least one of the color filter inks.

10. The color filter ink set according to claim 8, further including a yellow ink that is the at least one of the color filter inks.

11. A color filter produced with the color filter ink according to claim 1.

12. A color filter produced with the color filter ink set according to claim 8.

13. An image display including the color filter according to claim 11.

14. The image display according to claim 13, wherein the image display is a liquid crystal panel.

15. An electronic apparatus including the image display according to claim 13.
